(19) United States
(12) Patent Application Publication
(10) Pub. No.: US 2026/0059545 A1
(43) Pub. Date: Feb. 26, 2026

(54) Skipping Control Channel Monitoring

(71) Applicant: Ofinno, LLC, Reston, VA (US)

(72) Inventors: Mohammad Ghadir Khoshkholgh Dashtaki, Reston, VA (US); Ali Cagatay Cirik, Chantilly, VA (US); Esmael Hejazi Dinan, McLean, VA (US); Hyoungsuk Jeon, Centreville, VA (US); Hua Zhou, Vienna, VA (US); Gautham Prasad, Herndon, VA (US)

(73) Assignee: Ofinno, LLC, Reston, VA (US)

(21) Appl. No.: 19/373,825

(22) Filed: Oct. 30, 2025

Related U.S. Application Data
(63) Continuation of application No. PCT/US2024/028895, filed on May 10, 2024.
(60) Provisional application No. 63/465,686, filed on May 11, 2023.

(51) Int. Cl. H04W 72/232; H04W 74/0836; H04W 84/06

(52) U.S. Cl. CPC H04W 72/232; H04W 74/0836; H04W 84/06

(57) ABSTRACT

A method may include receiving, by a wireless device, a first control message indicating to skip control channel monitoring. The method may also include skipping, after the receiving first control message, the control channel monitoring. The method may further include resuming, when a contention-free random access procedure is completed or a two-step random access procedure is completed, the control channel monitoring.

### CROSS-REFERENCE TO RELATED APPLICATIONS

This application is a continuation of International Application No. PCT/US2024/028895, filed May 10, 2024, which claims the benefit of U.S. Provisional Application No. 63/465,686, filed May 11, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 shows an example of BWP switching on a cell (e.g., PCell or SCell).

FIG. 18 shows examples of DCI formats which may be used by a base station transmit control information to a wireless device or used by the wireless device for PDCCH monitoring.

FIG. 19A shows an example of configuration parameters of a master information block (MIB) of a cell (e.g., PCell).

FIG. 19B shows an example of a configuration of CORESET #0.

FIG. 19C shows an example of a configuration of SS #0.

FIG. 20 shows an example of configuration parameters of system information block (SIB).

FIG. 21 shows an example of configuration parameters (e.g., BWP-DownlinkCommon IE) in a downlink BWP of a serving cell.

FIG. 22 shows an example of configuration of a search space (e.g., SearchSpace IE).

FIG. 23 shows an example embodiment of transitioning between a dormant state and a non-dormant state on a SCell.

FIG. 24 shows an example of the embodiment of a DRX operation in wireless communication systems.

FIG. 25A shows example of DRX operation.

FIG. 25B shows an example of a power saving mechanism based on wake-up indication.

FIG. 26A shows an example of DCI format 2_0 comprising one or more search space set group (or SSSG) switching indications (or Search space set group switching flags).

FIG. 26B shows an example of SSS group switching based on a DCI.

FIG. 27 shows an example of PDCCH skipping based power saving operation.

FIG. 28A and FIG. 28B show examples of PDCCH skipping per an aspect of the present disclosure.

FIG. 29A and FIG. 29B illustrate examples of PDCCH monitoring as per an aspect of an embodiment of the present disclosure.

FIG. 30 illustrates an example of PDCCH monitoring as per an aspect of an embodiment of the present disclosure.

FIG. 31A shows an example of a non-terrestrial network (NTN).

FIG. 31B shows an example of an NTN with a transparent payload.

FIG. 31C shows an example of assistance information for maintenance of UL synchronization at a wireless device in an NTN.

FIG. 32A shows an example embodiment of common configuration parameters of a serving cell.

FIG. 32B and FIG. 32C show examples of random access procedure in a non-terrestrial network per an aspect of the present disclosure.

FIG. 33 and FIG. 34 show examples of PDCCH skipping in a non-terrestrial network per an aspect of the present disclosure.

FIG. 35 and FIG. 36 show examples of PDCCH skipping in a non-terrestrial network per an aspect of the present disclosure.

FIG. 37 illustrates an example flowchart of PDCCH skipping as per an aspect of an embodiment of the present disclosure.

FIG. 38 illustrates an example flowchart of PDCCH skipping as per an aspect of an embodiment of the present disclosure.

FIG. 39A illustrates an example flowchart of PDCCH skipping as per an aspect of an embodiment of the present disclosure.

FIG. 39B illustrates an example flowchart of PDCCH skipping as per an aspect of an embodiment of the present disclosure.

FIG. 39C illustrates an example flowchart of PDCCH skipping as per an aspect of an embodiment of the present disclosure.

FIG. 40A illustrates an example flowchart of PDCCH skipping as per an aspect of an embodiment of the present disclosure.

FIG. 40B illustrates an example flowchart of PDCCH skipping as per an aspect of an embodiment of the present disclosure.

FIG. 41A illustrates an example flowchart of PDCCH skipping as per an aspect of an embodiment of the present disclosure.

FIG. 41B illustrates an example flowchart of PDCCH skipping as per an aspect of an embodiment of the present disclosure.

FIG. 42A illustrates an example flowchart of PDCCH skipping as per an aspect of an embodiment of the present disclosure.

FIG. 42B illustrates an example flowchart of PDCCH skipping as per an aspect of an embodiment of the present disclosure.

FIG. 43A illustrates an example flowchart of PDCCH skipping as per an aspect of an embodiment of the present disclosure.

FIG. 43B illustrates an example flowchart of PDCCH skipping as per an aspect of an embodiment of the present disclosure.

FIG. 44 illustrates an example flowchart of PDCCH skipping as per an aspect of an embodiment of the present disclosure.

FIG. 45 illustrates an example flowchart of PDCCH skipping as per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

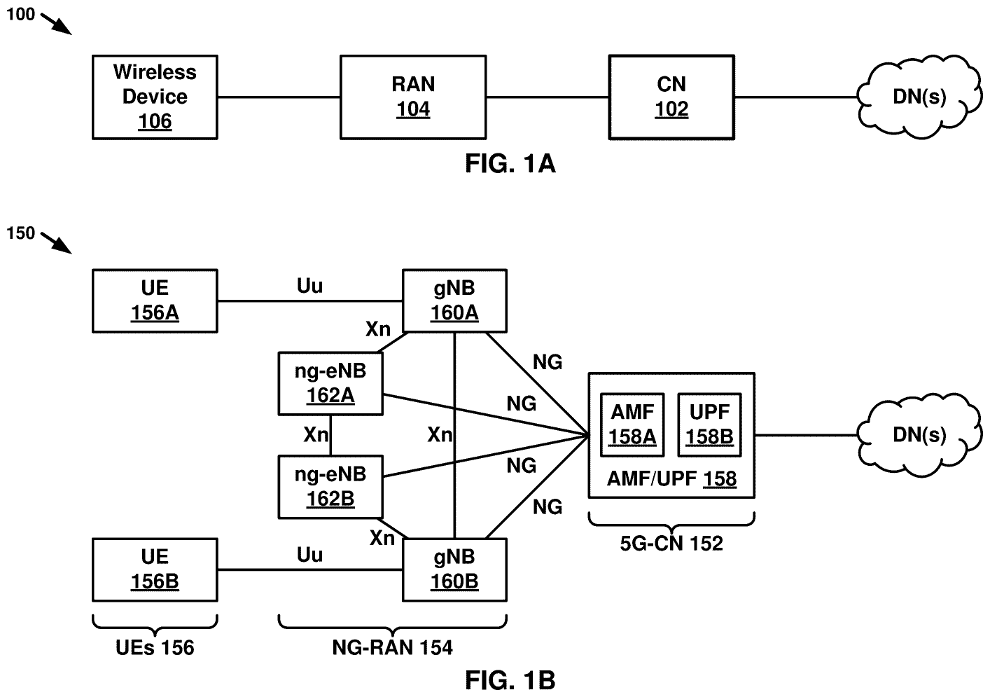

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNS, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

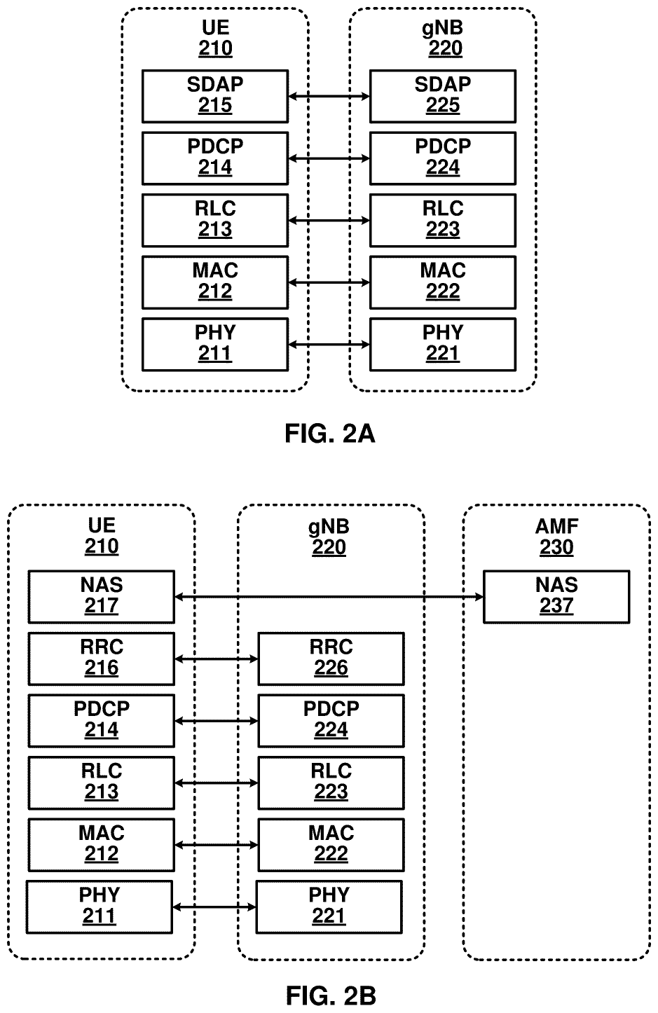

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

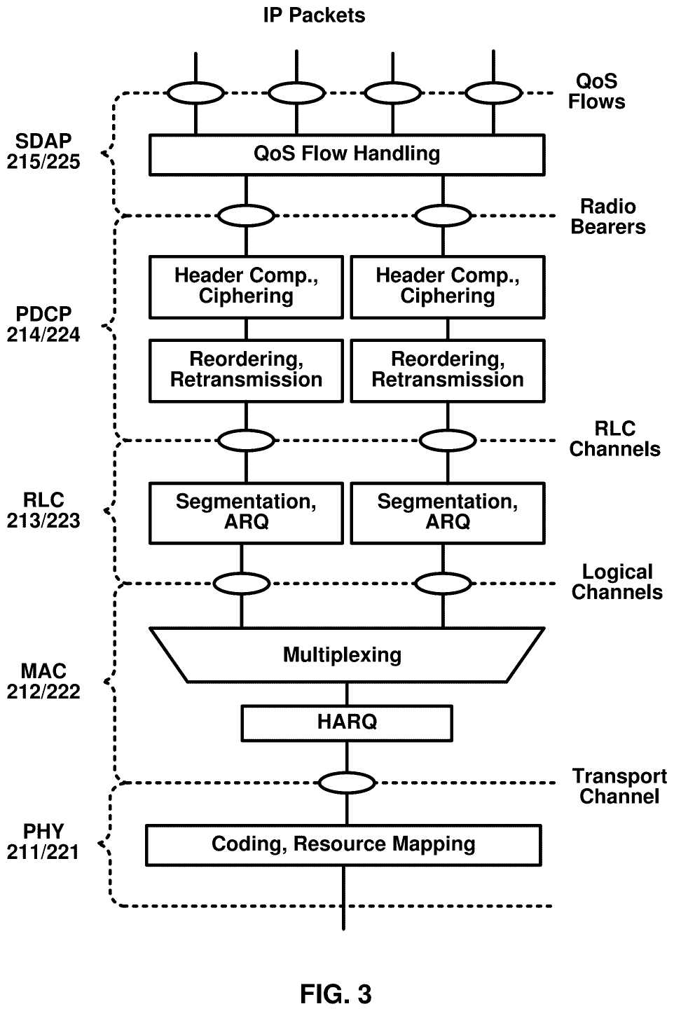

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYS 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

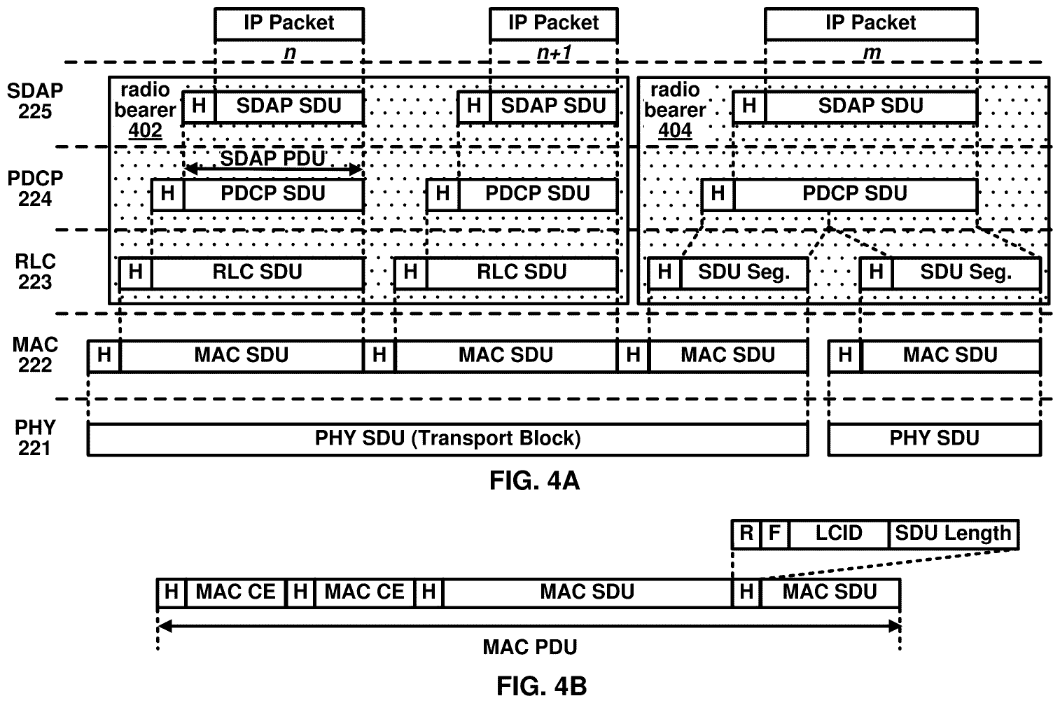

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

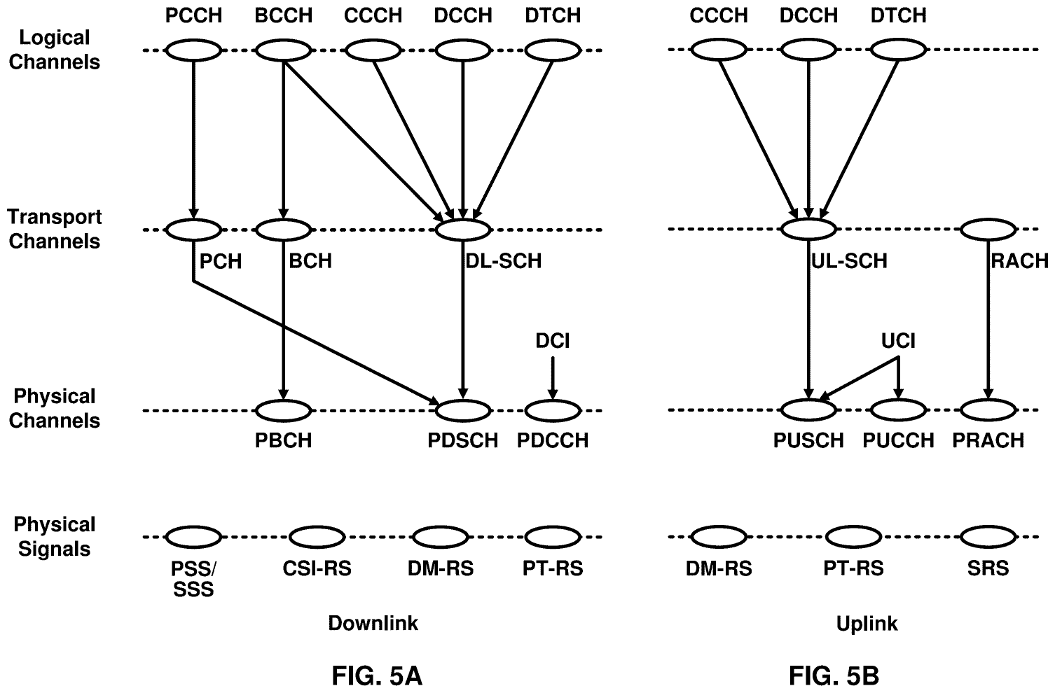

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

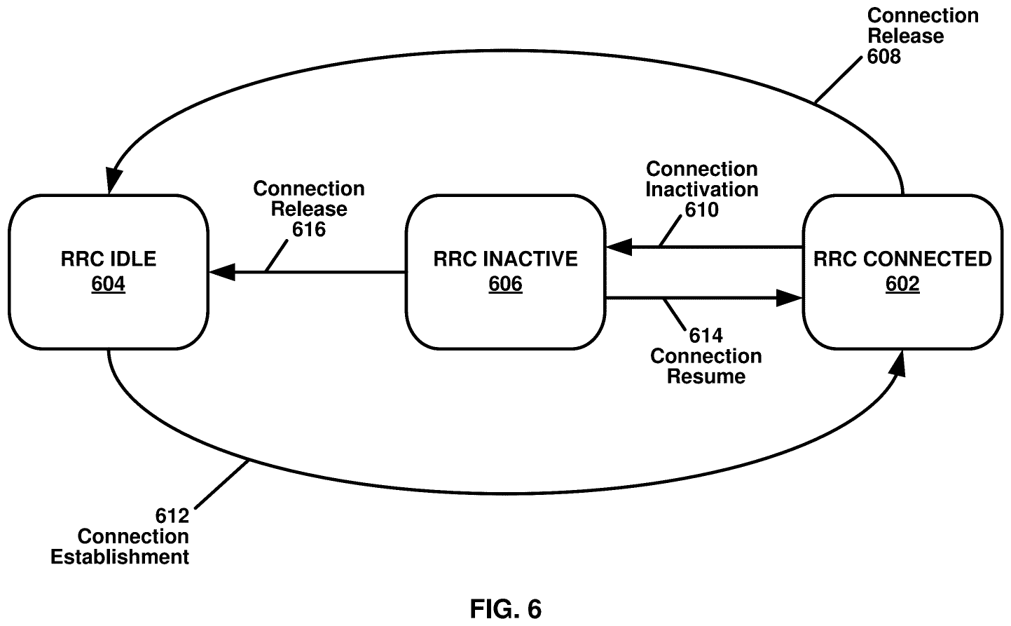

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

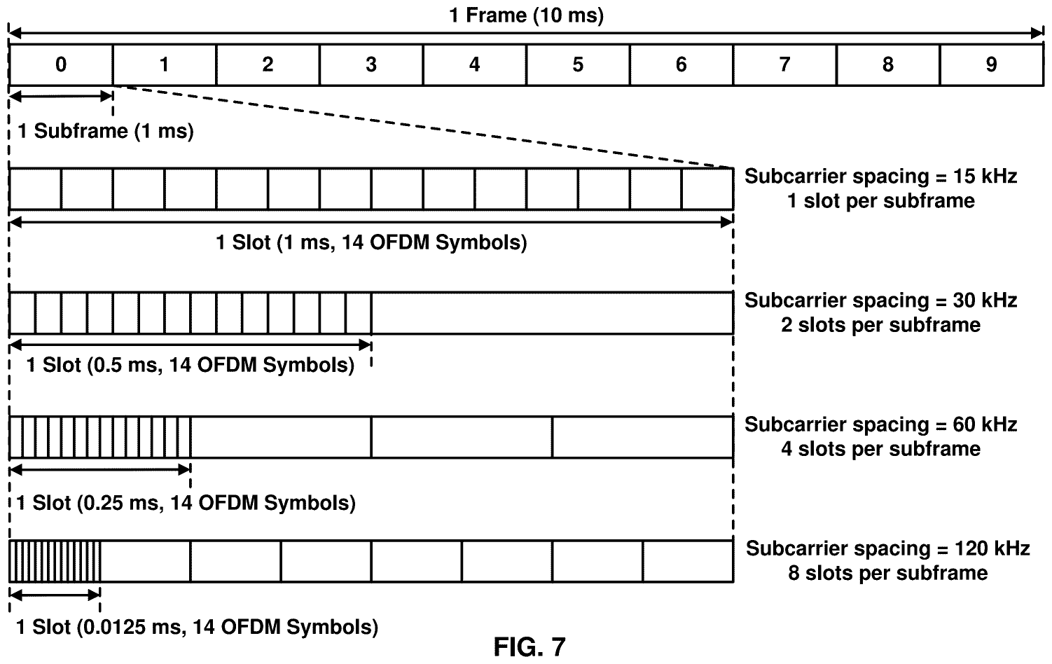

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 KHz/2.3 μs; 60 kHz/1.2 ρs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

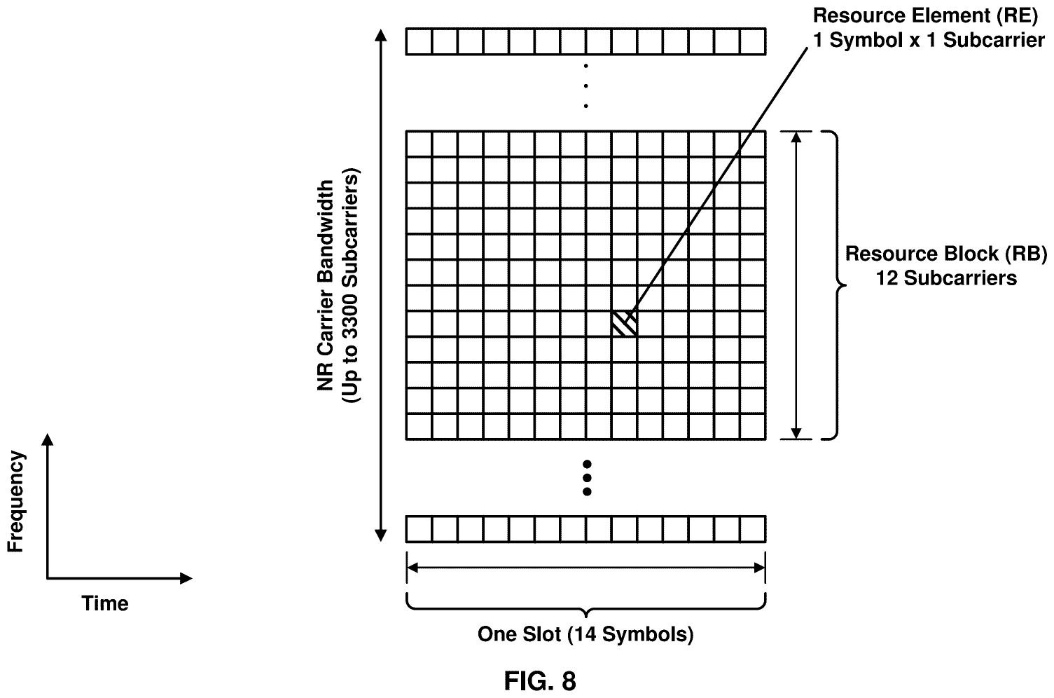

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

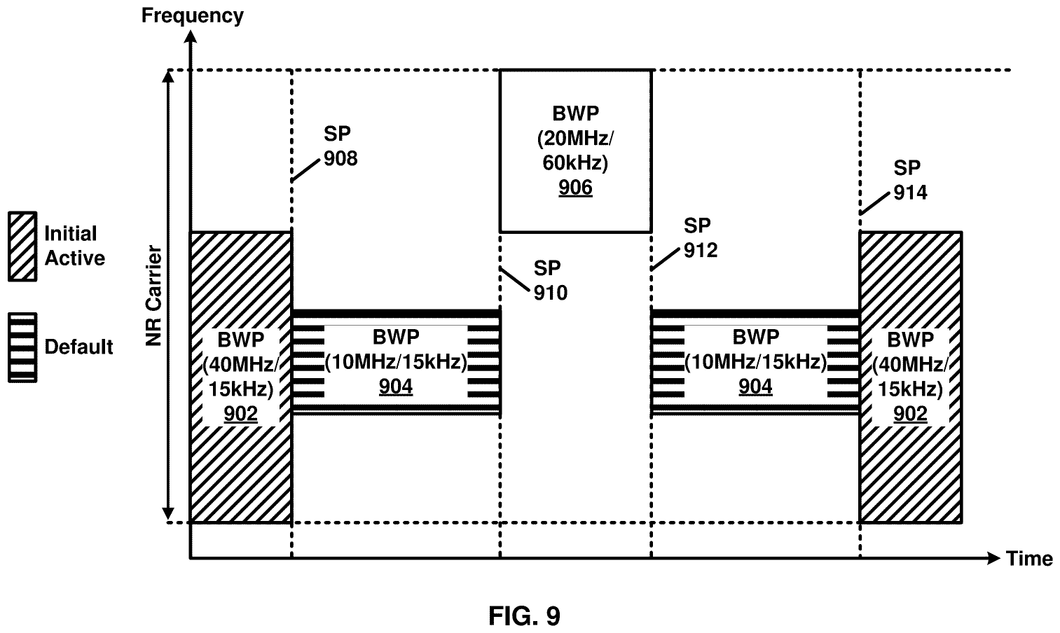

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

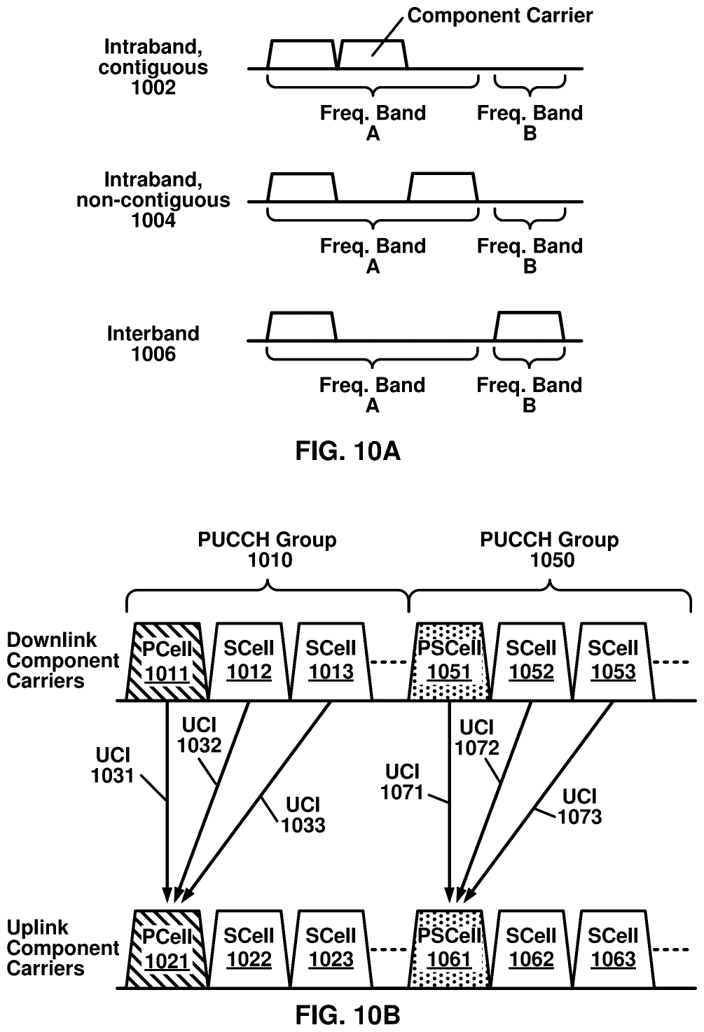

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

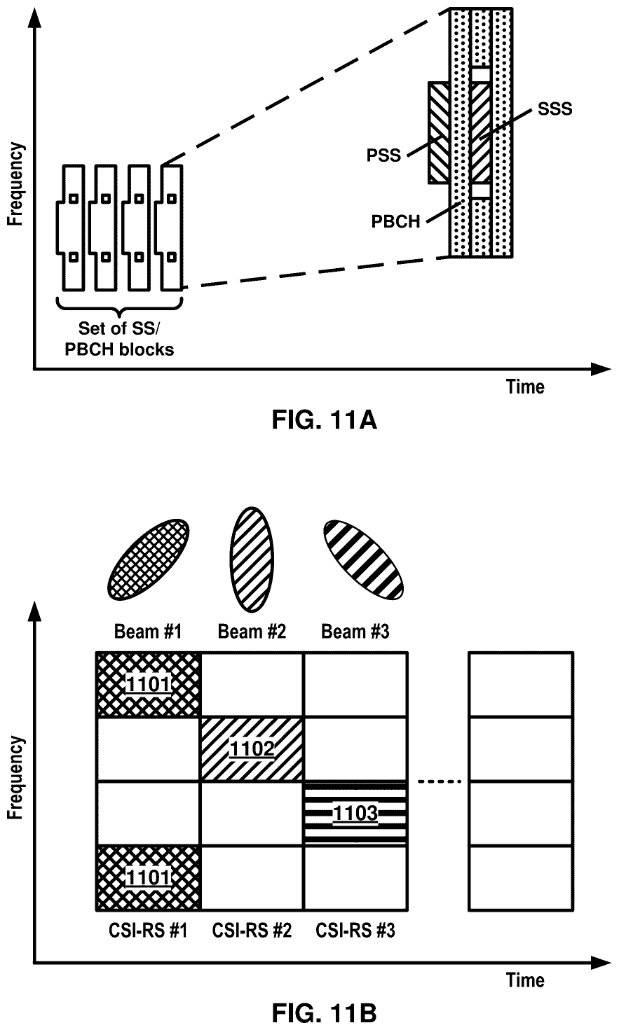

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

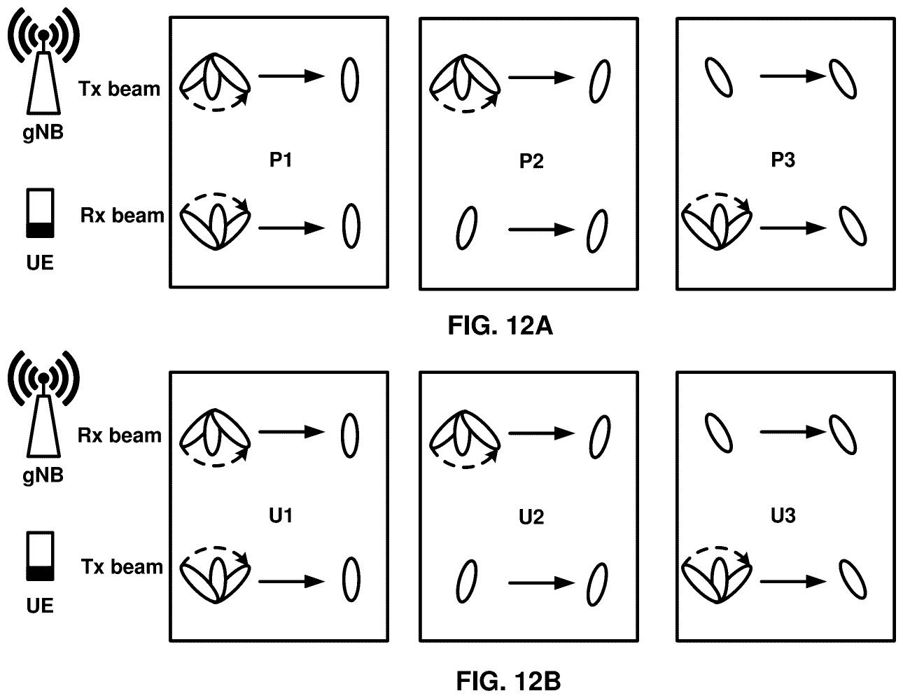

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

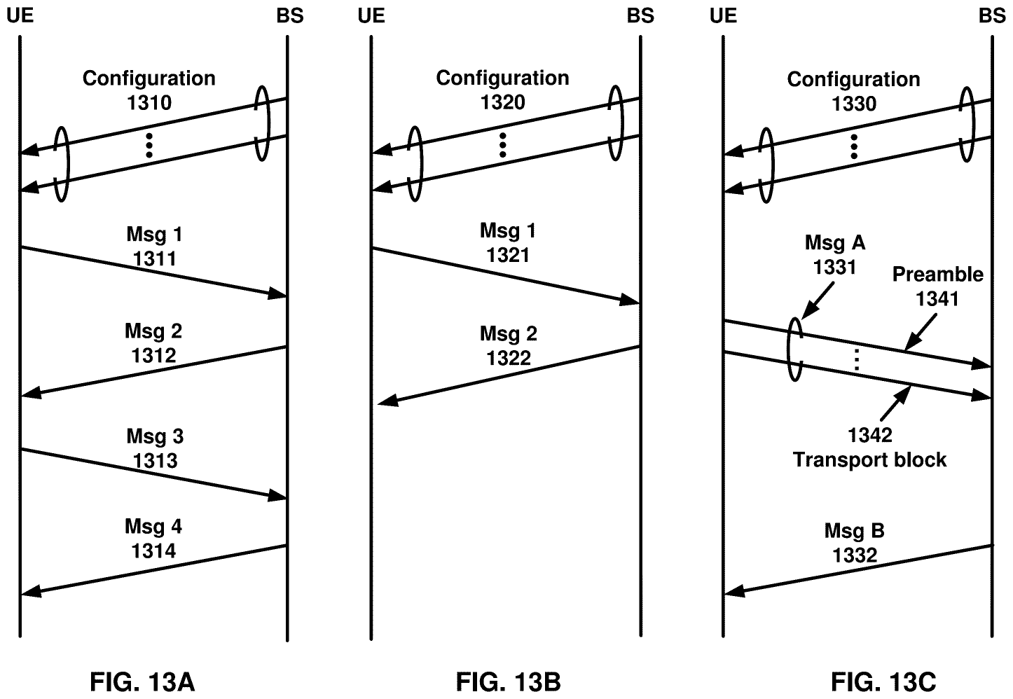

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-Response Window) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

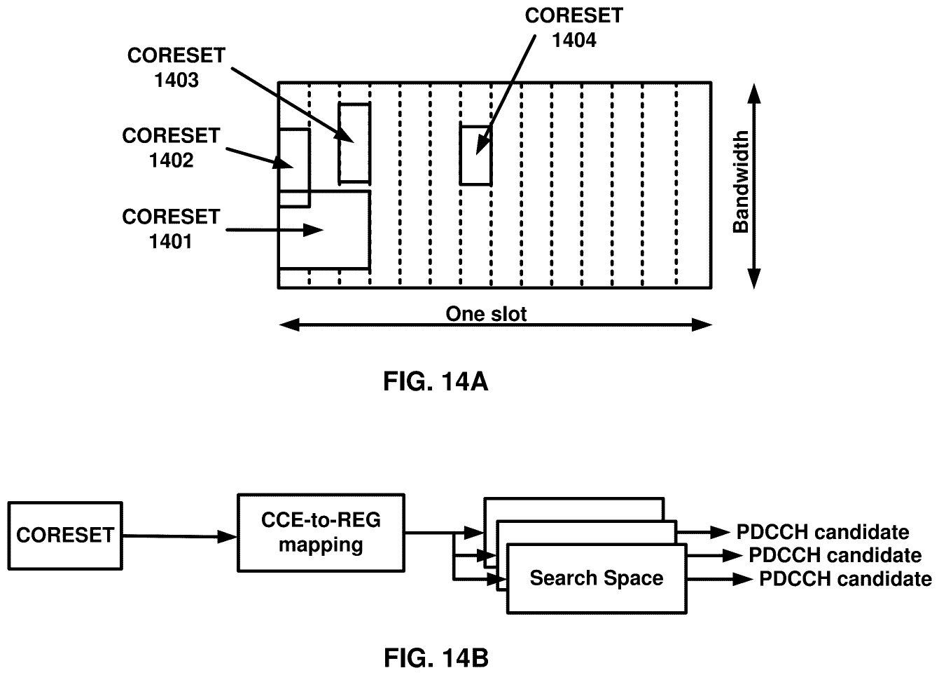

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

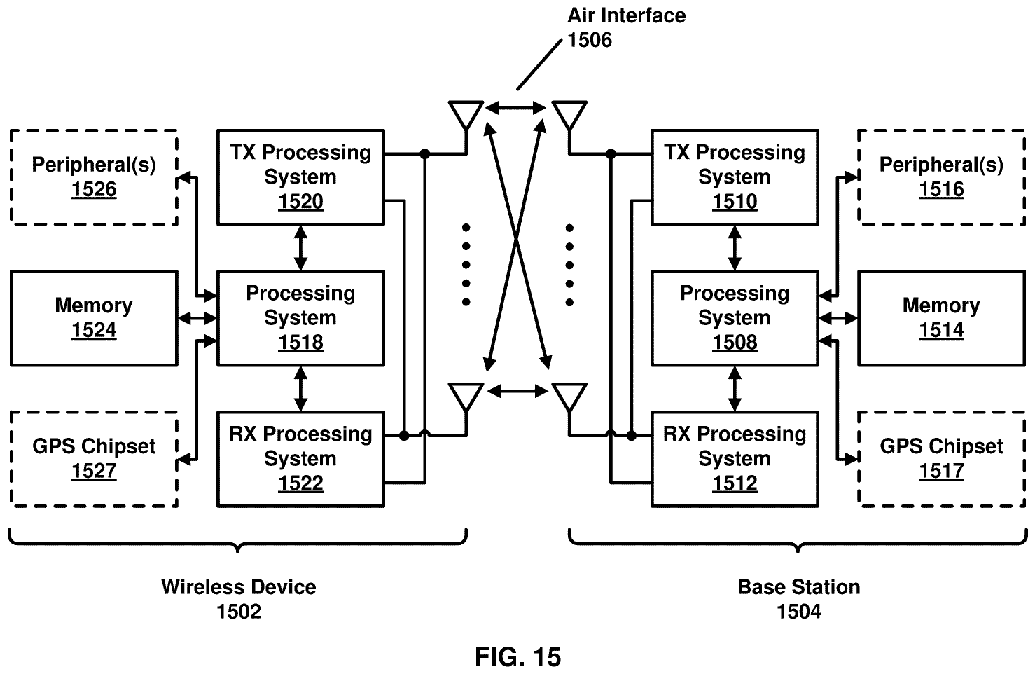

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

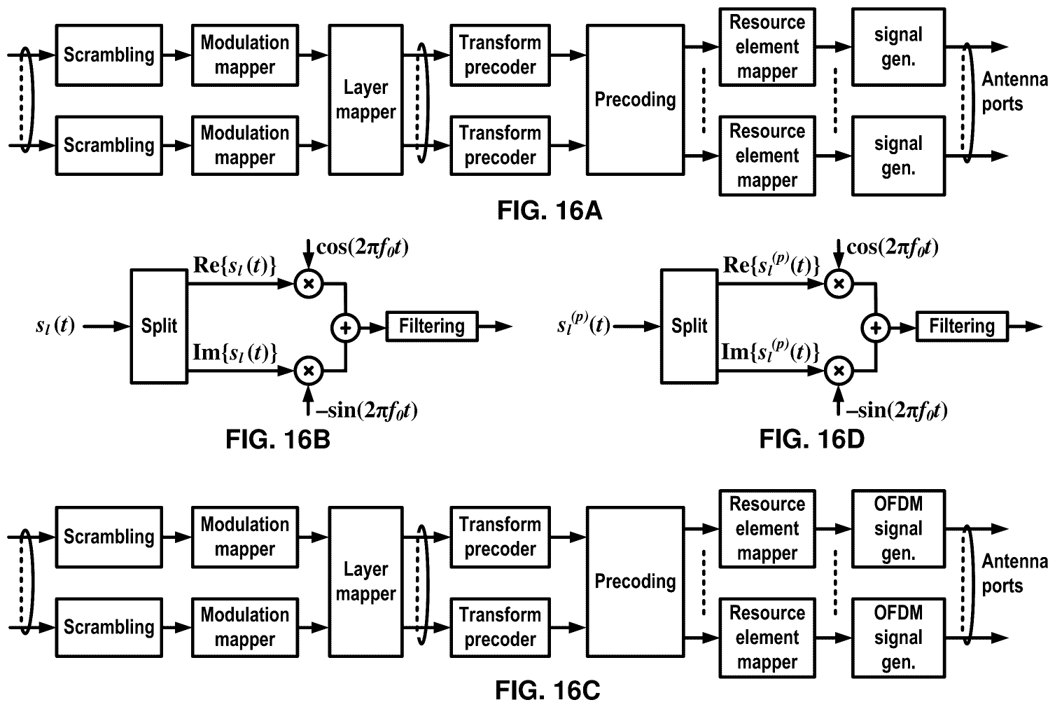

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

A base station may transmit one or more MAC PDUs to a wireless device. In an example, a MAC PDU may be a bit string that is byte aligned (e.g., aligned to a multiple of eight bits) in length. In an example, bit strings may be represented by tables in which the most significant bit is the leftmost bit of the first line of the table, and the least significant bit is the rightmost bit on the last line of the table. More generally, the bit string may be read from left to right and then in the reading order of the lines. In an example, the bit order of a parameter field within a MAC PDU is represented with the first and most significant bit in the leftmost bit and the last and least significant bit in the rightmost bit.

In an example, a MAC SDU may be a bit string that is byte aligned (e.g., aligned to a multiple of eight bits) in length. In an example, a MAC SDU may be included in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. In an example, a MAC subheader may be placed immediately in front of a corresponding MAC SDU, MAC CE, or padding. A MAC entity may ignore a value of reserved bits in a DL MAC PDU.

In an example, a MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, or a combination thereof. The MAC SDU may be of variable size. A MAC subheader may correspond to a MAC SDU, a MAC CE, or padding.

In an example, when a MAC subheader corresponds to a MAC SDU, a variable-sized MAC CE, or padding, the MAC subheader may comprise: a Reserve field (R field) with a one bit length; an Format field (F field) with a one-bit length; a Logical Channel Identifier (LCID) field with a multi-bit length; a Length field (L field) with a multi-bit length, indicating the length of the corresponding MAC SDU or variable-size MAC CE in bytes, or a combination thereof. In an example, F field may indicate the size of the L field.

In an example, a MAC entity of the base station may transmit one or more MAC CEs (e.g., MAC CE commands) to a MAC entity of a wireless device. The one or more MAC CEs may comprise at least one of: a SP ZP CSI-RS Resource Set Activation/Deactivation MAC CE, a PUCCH spatial relation Activation/Deactivation MAC CE, a SP SRS Activation/Deactivation MAC CE, a SP CSI reporting on PUCCH Activation/Deactivation MAC CE, a TCI State Indication for UE-specific PDCCH MAC CE, a TCI State Indication for UE-specific PDSCH MAC CE, an Aperiodic CSI Trigger State Subselection MAC CE, a SP CSI-RS/CSI-IM Resource Set Activation/Deactivation MAC CE, a UE contention resolution identity MAC CE, a timing advance command MAC CE, a DRX command MAC CE, a Long DRX command MAC CE, an SCell activation/deactivation MAC CE (1 Octet), an SCell activation/deactivation MAC CE (4 Octet), and/or a duplication activation/deactivation MAC CE. In an example, a MAC CE, such as a MAC CE transmitted by a MAC entity of the base station to a MAC entity of the wireless device, may have an LCID in the MAC subheader corresponding to the MAC CE. In an example, a first MAC CE may has a first LCID in the MAC subheader that may be different than the second LCID in the MAC subheader of a second MAC CE. For example, an LCID given by 111011 in a MAC subheader may indicate that the MAC CE associated with the MAC subheader is a Long DRX command MAC CE.

In an example, the MAC entity of the wireless device may transmit to the MAC entity of the base station one or more MAC CEs. The one or more MAC CEs may comprise at least one of: a short buffer status report (BSR) MAC CE, a long BSR MAC CE, a C-RNTI MAC CE, a configured grant confirmation MAC CE, a single entry PHR MAC CE, a multiple entry PHR MAC CE, a Short truncated BSR, and/or a Long truncated BSR. In an example, a MAC CE may have an LCID in the MAC subheader corresponding to the MAC CE. In an example, a first MAC CE may has a first LCID in the MAC subheader that may be different than the second LCID in the MAC subheader of a second MAC CE. For example, an LCID given by 111011 in a MAC subheader may indicate that a MAC CE associated with the MAC subheader is a short-truncated command MAC CE.

In an example, the base station may transmit, to the wireless device, one or more messages (e.g., one or more downlink signals). The one or more messages may comprise one or more RRC messages, e.g., one or more RRC configuration/reconfiguration messages. For example, the one or more RRC messages may comprise one or more configuration parameters (e.g., one or more RRC configuration parameters). In some implementations, the one or more messages may comprise one or more MAC CEs and/or one or more DCIs. For example, the one or more RRC messages may correspond to broadcast or multicast or group cast downlink messages (e.g., SIBs). For example, the one or more RRC messages may correspond to unicast downlink messages and/or dedicated downlink messages.

A wireless device may perform a buffer status reporting (BSR) procedure, e.g., to provide a base station (e.g., a serving base station) and/or a network with information about UL data volume in an MAC entity of the wireless device. The one or more configuration parameters may comprise one or more BSR configuration parameters.

The one or more BSR configuration parameters may comprise information element(s) indicating values of following parameters: a periodic BSR timer, a retransmission BSR timer, a logical channel SR delay timer, a logical channel SR-delay timer applied, a logical channel SR mask, and/or a logical channel group.

A logical channel (LC) may be allocated to (e.g., associated with) a logical channel group (LCG) using the logicalChannelGroup.

A wireless device may trigger a BSR, e.g., if at least one of the one or more events occur. For example, the one or more events comprise a first event that UL data, for a logical channel which belongs to an LCG, becomes available to the MAC entity of the wireless device, and/or the UL data may belong to the logical channel with higher priority than the priority of any logical channel containing available UL data which belong to any LCG. For example, the one or more events comprise a second event that UL data, for a logical channel which belongs to an LCG, becomes available to the MAC entity of the wireless device, and/or none of logical channels which belong to an LCG may contain any available UL data, e.g., when the UL data becomes available. The BSR triggered, e.g., based on the first event and/or the second event may be referred below to as Regular BSR. For example, the one or more events comprise the one that UL resource(s) are allocated, and number of padding bits is equal to or larger than the size of the Buffer Status Report MAC CE plus its subheader, in which case the BSR is referred below to as Padding BSR. For example, the one or more events comprise the one that retxBSR-Timer expires, and/or at least one of logical channels which belong to an LCG contains UL data, in which case the BSR is referred below to as Regular BSR. For example, the one or more events comprise the one that periodicBSR-Timer expires, in which case the BSR is referred below to as Periodic BSR. For example, each logical channel may trigger one separate Regular BSR, e.g., when Regular BSR triggering events occur for multiple logical channels simultaneously.

A wireless device may determine, in response to at least one BSR being pending (e.g., having been triggered and/or not cancelled), if UL-SCH resources are available for a new transmission and/or if the UL-SCH resources may accommodate a BSR MAC CE plus its subheader as a result of logical channel prioritization. For example, the BSR MAC CE may comprise and/or indicate the at least one BSR.

A wireless device may perform instruct the multiplexing and assembly procedure to generate the BSR MAC CE(s), e.g., if at least one BSR is pending (e.g., has been triggered and/or not cancelled), if UL-SCH resources are available for a new transmission and/or if the UL-SCH resources may accommodate a BSR MAC CE plus its subheader as a result of logical channel prioritization.

A wireless device may trigger a scheduling request, e.g., if at least one BSR is pending (e.g., has been triggered and/or not cancelled). For example, the wireless device may trigger a scheduling request, e.g., if at least one BSR is pending (e.g., has been triggered and/or not cancelled), if a regular BSR has been triggered.

A wireless device may determine that UL-SCH resources are available, e.g., if a MAC entity of the wireless device has been configured with, receives, and/or determines an uplink grant. UL-SCH resources determined as available may be available for use, e.g., at a point in time that the UL-SCH resources are determined as available. UL-SCH resources determined as available may not be available for use, e.g., at a point in time that the UL-SCH resources are determined as available. UL-SCH resources determined as available may not be available for use at a point in time that the UL-SCH resources are determined as available, e.g., if the UL-SCH resources are overlapped with other resources (e.g., SSB transmission) and/or if the UL-SCH resources are invalid.

A MAC PDU may comprise at least one (e.g., at most one) BSR MAC CE. For example, a MAC PDU may comprise at least one (e.g., at most one) BSR MAC CE, e.g., when multiple events have triggered one or more BSRs. For example, a wireless device may select a BSR among the one or more BSRs and/or may multiplex the MAC PDU comprising the at least one (e.g., at most one) BSR MAC CE corresponding to the selecting BSR. For example, the wireless device may select the BSR among the one or more BSRs based on a priority among the one or more BSRs. For example, the Regular BSR may have precedence over the padding BSR. For example, the Periodic BSR may have precedence over the padding BSR.

The MAC entity of the wireless device may cancel one or more (e.g., all) triggered BSRs, e.g., when the UL grant(s) may accommodate pending data (e.g., all pending data) available for transmission and/or may be not sufficient to additionally accommodate the BSR MAC CE plus its subheader. All BSRs triggered prior to MAC PDU assembly shall be cancelled when a MAC PDU is transmitted and this PDU includes a Long or Short BSR MAC CE which contains buffer status up to (and including) the last event that triggered a BSR prior to the MAC PDU assembly.

A wireless device may perform a MAC PDU assembly, e.g., at any point, in time between uplink grant reception and actual transmission of the corresponding MAC PDU. For example, the wireless device may trigger BSR and SR, e.g., after or in response to the assembly of a MAC PDU which may comprise a BSR MAC CE, and/or before the transmission of this MAC PDU. For example, the wireless device may trigger BSR and SR during MAC PDU assembly.

A wireless device may trigger and/or transmit a scheduling request (SR), e.g., to request UL-SCH resources for a transmission (e.g., new transmission). An MAC entity of the wireless device may be configured with zero, one, or more SR configurations. An SR configuration may comprise a set of PUCCH resource(s) for SR across different BWP(s) and/or cell(s). For a logical channel, for beam failure recovery (e.g., secondary cell beam failure recovery), and/or for consistent LBT failure recovery, the wireless device may receive a message (e.g., RRC message and/or system information) indicating and/or configuring one or more PUCCH resource(s) for SR per BWP. For example, for a logical channel, the wireless device may receive a message (e.g., RRC message and/or system information) indicating and/or configuring at most one PUCCH resource for SR per BWP. For example, for beam failure recovery (e.g., secondary cell beam failure recovery), the wireless device may receive a message (e.g., RRC message and/or system information) indicating and/or configuring at most one PUCCH resource for SR per BWP. For example, for consistent LBT failure recovery, the wireless device may receive a message (e.g., RRC message and/or system information) indicating and/or configuring at most one PUCCH resource for SR per BWP.

Each SR configuration may correspond to one or more logical channels and/or to SCell beam failure recovery and/or to consistent LBT failure recovery (e.g., which may be configured by an RRC message). Each logical channel, SCell beam failure recovery, and/or consistent LBT failure recovery, may be mapped to zero or one SR configuration (e.g., which may be configured by an RRC message). The wireless device may determine the SR configuration of the logical channel that triggered a BSR or the SCell beam failure recovery or the consistent LBT failure recovery (if such a configuration exists) as corresponding SR configuration for the triggered SR. The wireless device may use any SR configuration for an SR triggered by Pre-emptive BSR.

The one or more configuration parameters may comprise configuration parameters associated with eh SR procedure. For example, the configuration parameters for the SR procedure may comprise sr-ProhibitTimer and/or sr-TransMax.

The wireless device may maintain one or more variables used for the scheduling request procedure. For example, the one or more variables comprise a counter, e.g., SR_COUNTER, counting a number of SR triggered and/or a number of transmissions of SR triggered and/or pending. The wireless device may maintain the SR_COUNTER per SR configuration. The wireless device may set the SR_COUNTER of the corresponding SR configuration to 0 (e.g., or any initial value), e.g., if an SR is triggered and there are no other SRs pending corresponding to the same SR configuration. The wireless device may determine an SR as pending until it is cancelled, e.g., when the SR is triggered.

The wireless device may cancel pending SR(s) (e.g., all pending SR(s) for BSR triggered according to the BSR procedure, e.g., prior to the MAC PDU assembly and/or may stop each respective sr-ProhibitTimer, e.g., when the wireless device transmit the MAC PDU and this PDU comprises a Long and/or Short BSR MAC CE which contains buffer status up to (and comprising) the last event that triggered a BSR prior to the MAC PDU assembly. The wireless device may cancel pending SR(s) (e.g., all pending SR(s) for BSR triggered according to the BSR procedure and may stop each respective sr-ProhibitTimer, e.g., when the UL grant(s) accommodate pending data (e.g., all pending data) available for transmission.

An MAC entity of the wireless device may, for each pending SR not triggered according to the BSR procedure for a Serving Cell, cancel the pending SR and stop the corresponding sr-ProhibitTimer (e.g., if running), e.g., if this SR was triggered by Pre-emptive BSR procedure prior to the MAC PDU assembly and/or a MAC PDU comprising the relevant Pre-emptive BSR MAC CE is transmitted. The MAC entity may, for each pending SR not triggered according to the BSR procedure for a Serving Cell, cancel the pending SR and stop the corresponding sr-ProhibitTimer (e.g., if running), e.g., if this SR was triggered by beam failure recovery of an SCell and/or a MAC PDU is transmitted and this PDU comprises a BFR MAC CE or a Truncated BFR MAC CE which contains beam failure recovery information for this SCell. The MAC entity may, for each pending SR not triggered according to the BSR procedure for a Serving Cell, cancel the pending SR and stop the corresponding sr-ProhibitTimer (e.g., if running), e.g., if this SR was triggered by beam failure recovery of an SCell and this SCell is deactivated. The MAC entity may, for each pending SR not triggered according to the BSR procedure for a Serving Cell, cancel the pending SR and stop the corresponding sr-ProhibitTimer (e.g., if running), e.g., if this SR was triggered by consistent LBT failure recovery of a cell (e.g., an SCell) and a MAC PDU is transmitted and the MAC PDU comprises an LBT failure MAC CE that indicates consistent LBT failure for this cell (e.g., SCell). The MAC entity may, for each pending SR not triggered according to the BSR procedure for a Serving Cell, cancel the pending SR and stop the corresponding sr-ProhibitTimer (e.g., if running), e.g., if this SR was triggered by consistent LBT failure recovery of a cell (e.g., SCell) and the triggered consistent LBT failure(s) (e.g., all the triggered consistent LBT failure(s) for this cell (e.g., SCell) are cancelled.

The wireless device may determine that one or more PUCCH resources are valid, e.g., if the one or more PUCCH resources are scheduled on a BWP which is active at the time of SR transmission occasion. The MAC entity may, for each pending SR, initiate a random access procedure on a cell (e.g., SpCell) and cancel the pending SR, e.g., if at least one SR is pending and/or if the MAC entity has no valid PUCCH resource configured for the pending SR.

The MAC entity may, for each pending SR and/or for the SR configuration corresponding to the pending SR, determine whether one or more first conditions, e.g., to signal an SR on one valid PUCCH resource for SR, satisfy, e.g., when (or if) at least one SR is pending, and/or when (or if) the MAC entity has valid PUCCH resource(s) configured for the pending SR, and/or when (or if) the MAC entity has an SR transmission occasion on the valid PUCCH resource for SR configured. For example, the one or more first conditions may comprise sr-ProhibitTimer being not running at the time of the SR transmission occasion and/or the PUCCH resource for the SR transmission occasion being not overlap with a measurement gap.

The wireless device may stop (e.g., if any) ongoing Random Access procedure due to a pending SR for BSR, which was initiated by the MAC entity prior to the MAC PDU assembly and which has no valid PUCCH resources configured, e.g., if a MAC PDU is transmitted using a UL grant other than a UL grant provided by Random Access Response or a UL grant determined for the transmission of the MSGA payload, and this PDU comprises a BSR MAC CE which contains buffer status up to (and comprising) the last event that triggered a BSR prior to the MAC PDU assembly.

The wireless device may stop (e.g., if any) ongoing Random Access procedure due to a pending SR for BSR, which was initiated by the MAC entity prior to the MAC PDU assembly and which has no valid PUCCH resources configured, e.g., if the UL grant(s) can accommodate pending data (e.g., all pending data) available for transmission.

The wireless device may trigger/initiate an RA procedure in response to (or for): an initial access procedure (e.g., to transit from the RRC_IDLE state/mode to the RRC_CONNECTED state/mode), a positioning procedure, an uplink coverage recovery procedure, initiating a beam failure recovery, receiving from the base station an RRC reconfiguration message, e.g., during a handover procedure, receiving from the base station a PDCCH order, re-synchronizing when new data arrives and the wireless device status is out-of-sync for UL communication/transmission, new data arrives at the buffer of the wireless device when there is no scheduling request (SR) resources (e.g., no valid PUCCH resource) for transmitting the SR are configured, and/or pending data exists in the buffer of the wireless device and the wireless device has reached a maximum allowable times for (re) transmitting an SR (e.g., a SR failure). In some cases, the wireless device may perform the RA procedure after performing the initial access, e.g., for beam failure recovery, reporting a TA information (e.g., a UE-specific TA and/or a GNSS-acquired location information) of the wireless device, other SI request, and/or SCell addition.

The RA procedure may, for example, be a four-step RA procedure (e.g., according to above discussions of FIG. 13A), e.g., RA_TYPE is set to 4-stepRA, or a two-step RA procedure (e.g., according to above discussions of FIG. 13B and/or FIG. 13C), e.g., RA_TYPE is set to 2-stepRA.

The one or more configuration parameters may comprise one or more RACH configuration parameters. The one or more configuration parameters may, for example, comprise one or more RA configuration parameters (e.g., RACH-ConfigCommon, and/or RACH-ConfigCommonTwoStepRA, and/or RACH-ConfigDedicated, and/or RACH-ConfigGeneric, and/or RACH-ConfigGenericTwoStepRA). For example, the one or more RACH configuration parameters may comprise a first RACH configuration parameters (e.g., RA-ConfigCommon IE), corresponding to a four-step RA type (e.g., the RA_TYPE is the 4-stepRA), e.g., for performing the four-step RA procedure. The one or more RACH configuration parameters may, for example, comprise a second RACH configuration parameters (e.g., RA-ConfigCommonTwoStepRA-r16 IE and/or MsgA-PUSCH-Config IE), corresponding to a two-step RA type (e.g., the RA_TYPE is the 2-stepRA), e.g., for performing the two-step RA procedure.

In some examples, the RA procedure may be a contention-based RA procedure, e.g., triggered by higher layers of the wireless device (e.g., the RRC sublayer or the MAC layer indicates triggering/initiating the RA procedure). The wireless device may, for example, trigger/initiate the RA procedure based on the higher layers indicating triggering/initiating the RA procedure.

In some cases, triggering/initiating the RA procedure may comprise at least one of: determining a carrier (SUL or NUL) for performing the RA procedure, e.g., based on a measured RSRP, determining the two-step (or 2-step or 2-stage) RA type or the four-step (4-step or 4-stage) RA type (e.g., selecting the RA type) for performing the RA procedure, and/or initializing/setting one or more RA parameters (variables) specific to the selected RA type.

In an example, for performing the RA procedure, the wireless device may select RA resources. The RA resources may comprise a preamble 1311/1341/1321 with a preamble index (e.g., ra-PreambleIndex or PREAMBLE_INDEX), Random Access Preamble (RAP) group (e.g., preamble Group A or preamble Group B), a physical random access channel (PRACH) occasion (RO) comprising (time, frequency, and/or code) resources for transmitting the preamble, and/or one or more MsgA PUSCH occasions (POs) for MsgA payload/transport block 1342 transmission. For example, the wireless device may determine a valid RO (e.g., the next available RO) corresponding to a SSB or a CSI-RS, e.g., randomly with equal probability amongst one or more ROs and/or based on a possible occurrence of measurement gaps. In some cases, the wireless device may randomly select the preamble (from the first RAP group or the second RAP group), set PREAMBLE_INDEX based on the preamble (e.g., the index of the preamble), select the valid RO corresponding to the preamble, and/or calculate an RA-RNTI corresponding to the valid RO (if the type of the RA procedure is the 4-stepRA) or calculate a MSGB-RNTI corresponding to the valid RO (if the type of the RA procedure is the 2-stepRA).

For performing the two-step RA procedure, when the preamble is selected by the MAC entity, of the wireless device, among the contention-based Random Access Preamble(s), the wireless device may select the PUSCH occasion (PO) corresponding to the preamble and the valid RO. For example, the wireless device may determine an UL grant/resource for transmission of the MsgA payload according to the PUSCH configuration associated with the selected RAP group. In some cases, the wireless device may identify HARQ information (e.g., New Data Indicator (NDI), Transport Block size (TBS), Redundancy Version (RV), and a HARQ process ID/number/index) associated (or corresponding to) the MsgA payload. In an example, based on the preamble and the valid RO being mapped to a valid PUSCH occasion (PO), the wireless device may deliver the UL grant and the associated HARQ information to the HARQ entity for transmission of a first message (e.g., MsgA).

The wireless device may, using (or based on) the (selected) RA resources, transmit a first message (e.g., the preamble or the MsgA). Transmitting the first message may comprise a PRACH (or preamble) transmission of the RA procedure and/or a PUSCH transmission (e.g., the MsgA payload) of the (2-step) RA procedure. For example, in response to transmitting the first message (e.g., the preamble), the wireless device may start a RAR window (e.g., ra-ResponseWindow or msgB-ResponseWindow). In response to the PRACH transmission (e.g., for performing a 2-step/4-step RA procedure), the wireless device may attempt to detect a DCI format 1_0 with CRC scrambled by a corresponding RA-RNTI during the RAR window (e.g., ra-ResponseWindow). The RAR window may start at a first/initial/earliest symbol of an earliest CORESET the wireless device is configured to receive PDCCH for Type1-PDCCH CSS set. For example, the earliest CORESET may be at least one symbol, after the last/final/ending symbol of a PRACH occasion corresponding to the PRACH transmission. The symbol duration may correspond to an SCS for Type1-PDCCH CSS set.

In some examples, the RA procedure may be a contention-free RA procedure (e.g., according to above discussions of FIG. 13B). For example, the wireless device may initiate/trigger the RA procedure based on the PDCCH order received from the base station. In an example, the PDCCH order may comprise an indication for the preamble (e.g., ra-PreambleIndex) and/or a SS/PBCH index for determining the RO for transmission of the preamble. For example, the one or more RACH configuration parameters may comprise a dedicated RACH configuration message (e.g., RACH-ConfigDedicated). The dedicated RACH configuration message may comprise, among other parameters, one or more ROs for the contention-free RA procedure, and one or more PRACH mask index for RA resource selection (e.g., ra-ssb-Occasion MaskIndex).

In an example, based on the PDCCH order, the wireless device may select the RA resources. In some cases, the wireless device may set/initialize parameter PREAMBLE_INDEX based on the preamble index indicated by the PDCCH order, e.g., the preamble may not be selected by the higher layers (e.g., the MAC layer) of the wireless device among the contention-based (CB) Random Access Preambles (RAPs). For example, for performing the RA procedure (e.g., the two-step RA procedure or the four-step RA procedure), the wireless device may select an SSB indicated by the PDCCH order or may select the SSB based on a threshold (e.g., rsrp-ThresholdSSB). In some cases, the wireless device may select the SSB randomly.

In response to a transmission of the PRACH and the PUSCH (e.g., the MsgA payload/PUSCH), or to a transmission of only the PRACH if the PRACH preamble is mapped to a valid PUSCH occasion of the (2-step) RA procedure, the wireless device may attempt to detect a DCI format 1_0 with CRC scrambled by a corresponding MsgB-RNTI during the RAR window (e.g., msgB-ResponseWindow). The RAR window may start at a first/initial/earliest symbol of an earliest CORESET the wireless device is configured to receive PDCCH for Type1-PDCCH CSS set. For example, the earliest CORESET may be at least one symbol, after the last/final/ending symbol of a PUSCH occasion corresponding to the PRACH transmission. The symbol duration may correspond to an SCS for Type1-PDCCH CSS set. Once the MsgA preamble is transmitted, regardless of the possible occurrence of a measurement gap, the wireless device may start the msgB-ResponseWindow at a PDCCH occasion (e.g., the earliest CORESET the wireless device is configured to receive PDCCH for Type1-PDCCH CSS set). While the msgB-ResponseWindow is running, the wireless device may monitor the PDCCH of the SpCell for a Random Access Response (RAR) identified by MSGB-RNTI and/or the C-RNTI. For example, if the C-RNTI MAC CE is included in the MsgA, the wireless device may monitor the PDCCH of the SpCell for Random Access Response identified by the C-RNTI while the msgB-ResponseWindow is running.

The wireless device may, while the RAR window is running, monitor PDCCH (e.g., the one or more PDCCH candidates) for a RAR identified by the RA-RNTI (for the four-step RA procedure) or the MSGB-RNTI (for the two-step RA procedure) and/or a C-RNTI. In an example, the wireless device may monitor the one or more PDCCH candidates based on (or using or via) a Type1-PDCCH common search space (CSS) set (e.g., indicated by ra-searchSpace in the one or more configuration parameters, e.g., PDCCH-ConfigCommon), a Type3-PDCCH CSS set (e.g., indicated by SearchSpace in the one or more configuration parameters, e.g., PDCCH-Config with searchSpaceType=common), and/or an USS set (e.g., indicated by SearchSpace in the one or more configuration parameters, e.g., PDCCH-Config with searchSpaceType=ue−Specific). For example, the wireless device may monitor the one or more PDCCH candidates for a second PDCCH transmission (e.g., comprising/indicating a second DCI) on the search space indicated by recoverySearchSpaceId of the SpCell.

While/during the RAR window (e.g., ra-ResponseWindow or msgB-ResponseWindow) is running, the wireless device may monitor the one or more PDCCH candidates for receiving a second DCI (e.g., PDCCH portion of the Msg2/MsgB) indicating/scheduling a downlink assignment (e.g., a PDSCH portion of the Msg2/MsgB) for receiving a transport block (TB). The TB may comprise a MAC PDU. In an example, the MAC PDU may comprise one or more MAC subPDUs (and/or optionally padding). A MAC subPDU, of the one or more MAC subPDUs, may comprise at least one of following: a MAC subheader with Backoff Indicator (BI) only; a MAC subheader with Random Access Preamble identifier (RAPID) only (e.g., acknowledgment for an SI request); a MAC subheader with the RAPID and a MAC RAR (e.g., a RAR or a fallback RAR or a success RAR). In some cases, the MAC PDU may comprise one or more (MAC) RARs. A MAC subPDU may be fallbackRAR MAC subPDU or a successRAR MAC subPDU.

In an example, a RAR (of/from/among the one or more RARs) may be fixed size and may comprise at least one of the following fields: an R field that may indicate a Reserved bit, a Timing Advance Command (TAC) MAC CE field, an UL grant (or an UL grant field), and/or an RNTI field (e.g., the TC-RNTI and/or the C-RNTI) that may indicate an identity that is employed during the RA procedure.

In some examples, the wireless device may receive the RAR from the base station during the RAR window. For example, the wireless device may receive the DCI scheduling the RAR during the RAR window. In some examples, the wireless device may determine (or indicate or identify) a reception of the RAR (e.g., for or in response to the first message or the preamble) being successful. For example, the wireless device may consider the reception of the RAR successful based on the RAR comprising the MAC PDU with the RAPID corresponding (or matching) to the preamble with the preamble index PREAMBLE_INDEX.

In some cases, the RAR may indicate an UL grant for transmission of Msg3. The wireless device may process the UL grant and indicate it to the lower layers (e.g., the physical layer) for transmission of the Msg3 using/based on the UL grant. For example, the wireless device may transmit the Msg3 using the UL grant.

In response to transmitting the Msg3 (e.g., initial transmission or a HARQ retransmission), the wireless device may start or restart a contention resolution timer. For example, the wireless device may start or restart the contention resolution timer (e.g., ra-ContentionResolutionTimer) in the first/starting/earliest/initial symbol after the end/latest/final/ending of all repetitions of the Msg3 transmission. The wireless device may monitor the PDCCH (for a TC-RNTI) while the ra-ContentionResolutionTimer is running regardless of the possible occurrence of a measurement gap. While the contention resolution timer is running, the wireless device may determine whether contention resolution (CR) being successful or not (e.g., based on whether at least one CR condition being satisfied or not).

In carrier aggregation (CA), two or more component carriers (CCs) may be aggregated. The wireless device may, using the technique of CA, simultaneously receive or transmit on one or more CCs, depending on capabilities of the wireless device. In an example, the wireless device may support CA for contiguous CCs and/or for non-contiguous CCs. CCs may be organized into cells. For example, CCs may be organized into one primary cell (PCell) and one or more secondary cells (SCells).

When configured with CA, the wireless device may have one RRC connection with a network. During an RRC connection establishment/re-establishment/handover, a cell providing NAS mobility information may be a serving cell. During an RRC connection re-establishment/handover procedure, a cell providing a security input may be the serving cell. In an example, the serving cell may be a PCell.

In an example, the one or mor configuration parameters may comprise configuration parameters of a plurality of one or more SCells, depending on capabilities of the wireless device. When configured with CA, the base station and/or the wireless device may employ an activation/deactivation mechanism of an SCell to improve battery or power consumption of the wireless device. When the wireless device is configured with one or more SCells, the base station may activate or deactivate at least one of the one or more SCells. Upon configuration of an SCell, the SCell may be deactivated unless the SCell state associated with the SCell is set to “activated” or “dormant.” The wireless device may activate/deactivate the SCell in response to receiving an SCell Activation/Deactivation MAC CE.

For example, the base station may configure (e.g., via the one or more RRC messages/parameters) the wireless device with uplink (UL) bandwidth parts (BWPs) and downlink (DL) BWPs to enable bandwidth adaptation (BA) on a PCell. If carrier aggregation (CA) is configured, the base station may further configure the wireless device with at least one DL BWP (e.g., there may be no UL BWP in the UL) to enable BA on an SCell. For the PCell, an initial active BWP may be a first BWP used for initial access. In paired spectrum (e.g., FDD), the base station and/or the wireless device may independently switch a DL BWP and an UL BWP. In unpaired spectrum (e.g., TDD), the base station and/or the wireless device may simultaneously switch the DL BWP and the UL BWP.

A serving cell may be a cell (e.g., PCell, SCell, PSCell, etc.) on which the wireless device may receive SSB/CSI-RS/PDCCH/PDSCH and/or may transmit PUCCH/PUSCH/SRS etc. The serving cell is identified by a serving cell index (e.g., ServCellIndex or SCellIndex configured/indicated by the one or more configuration parameters). For a wireless device in RRC_CONNECTED not configured with CA/DC, there may only be one serving cell comprising of a primary cell. For a wireless device in RRC_CONNECTED configured with CA/DC the term ‘serving cells’ may be used to denote a set of cells comprising of the Special Cell(s) and one or more (e.g., all) secondary cells. For a wireless device configured with CA, a cell providing additional radio resources on top of Special Cell is referred to as a secondary cell.

A non-serving (or neighbor) cell may be a cell on which the wireless device may not receive MIBs/SIBs/PDCCH/PDSCH and/or may not transmit PUCCH/PUSCH/SRS etc. The non-serving cell has a physical cell identifier (PCI) different from a PCI of a serving cell. The non-serving cell may not be identified by (or associated with) a serving cell index (e.g., ServCellIndex or SCellIndex). The wireless device may rely on an SSB of a non-serving cell for Tx/Rx beam (or spatial domain filter) determination (for PDCCH/PDSCH/PUCCH/PUSCH/CSI-RS/SRS for a serving cell, etc.), e.g., when a TCI state of the serving cell is associated with (e.g., in TCI-state IE of TS 38.331) a SSB of the non-serving cell. The base station may not transmit configuring resources/parameters of PDCCH/PDSCH/PUCCH/PUSCH/SRS of a non-serving cell to the wireless device.

In an example, the wireless device may support a baseline processing time/capability. For example, the wireless device may support additional aggressive/faster processing time/capability. In an example, the wireless device may report to the base station a processing capability, e.g., per sub-carrier spacing. In an example, a PDSCH processing time may be considered to determine, by a wireless device, a first uplink symbol of a PUCCH (e.g., determined at least based on a HARQ-ACK timing K1 and one or more PUCCH resources to be used and including the effect of the timing advance) comprising the HARQ-ACK information of the PDSCH scheduled by a DCI. In an example, the first uplink symbol of the PUCCH may not start earlier than a time gap (e.g., T_{proc,1}) after a last symbol of the PDSCH reception associated with the HARQ-ACK information. In an example, the first uplink symbol of the PUCCH which carries the HARQ-ACK information may start no earlier than at symbol L1, where L1 is defined as the next uplink symbol with its Cyclic Prefix (CP) starting after the time gap T_{proc,1} after the end of the last symbol of the PDSCH.

In an example, a PUSCH preparation/processing time may be considered for determining the transmission time of an UL data. For example, if the first uplink symbol in the PUSCH allocation for a transport block (including DM-RS) is no earlier than at symbol L2, the wireless device may perform transmitting the PUSCH. In an example, the symbol L2 may be determined, by a wireless device, at least based on a slot offset (e.g., K2), SLIV of the PUSCH allocation indicated by time domain resource assignment of a scheduling DCI. In an example, the symbol L2 may be specified as the next uplink symbol with its CP starting after a time gap with length T_{proc,2} after the end of the reception of the last symbol of the PDCCH carrying the DCI scheduling the PUSCH.

In an example, the base station and/or the wireless device may switch a BWP between configured BWPs by means of a DCI or a BWP invalidity timer. When the BWP invalidity timer is configured for the serving cell, the base station and/or the wireless device may switch the active BWP to a default BWP in response to the expiry of the BWP invalidity timer associated with the serving cell. The default BWP may be configured by the network. In an example, for FDD systems, when configured with BA, one UL BWP for each uplink carrier and one DL BWP may be active at a time in the active serving cell. In an example, for TDD systems, one DL/UL BWP pair may be active at a time in the active serving cell. Operating on one UL BWP and one DL BWP (or one DL/UL pair) may improve the wireless device battery consumption. One or more BWPs other than the active UL BWP and the active DL BWP, which the wireless device may work on, may be deactivated. On the deactivated one or more BWPs, the wireless device may: not monitor PDCCH; and/or not transmit on PUCCH, PRACH, and UL-SCH. In an example, the MAC entity of the wireless device may apply normal operations on the active BWP for an activated serving cell configured with a BWP comprising: transmitting on UL-SCH; transmitting on RACH; monitoring a PDCCH; transmitting PUCCH; receiving DL-SCH; and/or (re-)initializing any suspended configured uplink grants of configured grant Type 1 according to a stored configuration, if any. In an example, on the inactive/idle BWP for each activated serving cell configured with a BWP, the MAC entity of the wireless device may: not transmit on UL-SCH; not transmit on RACH; not monitor a PDCCH; not transmit PUCCH; not transmit SRS, not receive DL-SCH; clear any configured downlink assignment and configured uplink grant of configured grant Type 2; and/or suspend any configured uplink grant of configured Type 1.

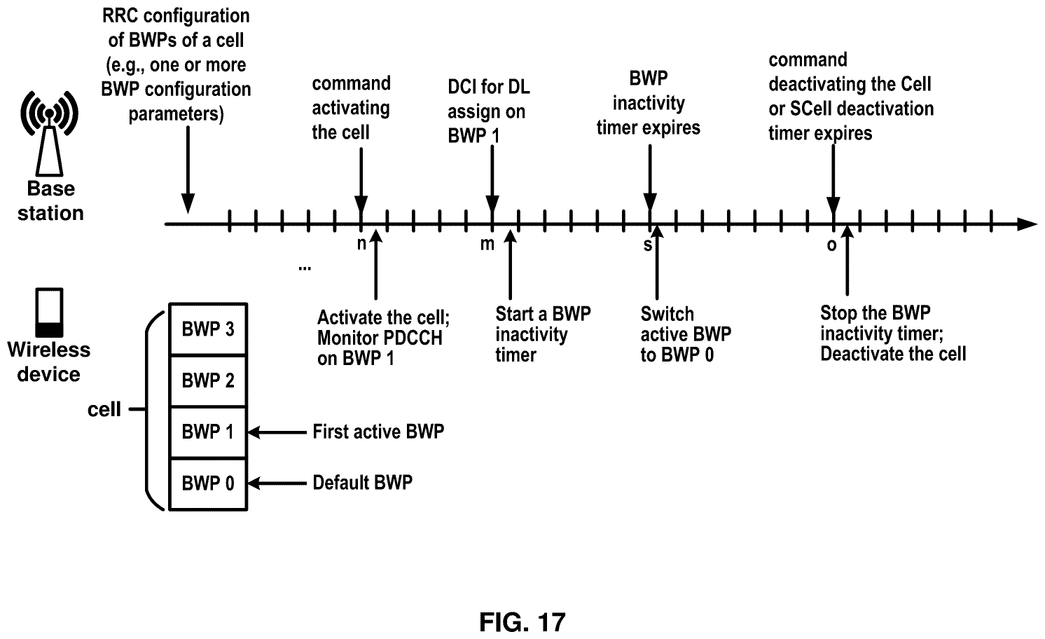

FIG. 17 shows an example of BWP switching on a cell (e.g., PCell or SCell). The one or more configuration parameters may comprise configuration parameters of one or more BWPs (e.g., one or more BWP configuration parameters). The one or more BWP configuration parameters may comprise parameters of a cell and one or more BWPs associated with the cell. Among the one or more BWPs, at least one BWP may be configured as the first active BWP (e.g., BWP 1), one BWP as the default BWP (e.g., BWP 0). The wireless device may receive a command (e.g., RRC message, MAC CE or DCI) to activate the cell at an nth slot. In case the cell is a PCell, the wireless device may not receive the command activating the cell, for example, the wireless device may activate the PCell once the wireless device receives RRC message comprising configuration parameters of the PCell. The wireless device may start monitoring a PDCCH on BWP 1 in response to activating the cell.

In an example, the wireless device may start (or restart) a BWP inactivity timer (e.g., bwp-InactivityTimer) at an m-th slot in response to receiving a DCI indicating DL assignment on BWP 1. The wireless device may switch back to the default BWP (e.g., BWP 0) as an active BWP when the BWP inactivity timer expires, at s-th slot. The wireless device may deactivate the cell and/or stop the BWP inactivity timer when the sCellDeactivation Timer expires (e.g., if the cell is a SCell). In response to the cell being a PCell, the wireless device may not deactivate the cell and may not apply the sCellDeactivation Timer on the PCell.

In an example, a MAC entity may apply normal operations on an active BWP for an activated serving cell configured with a BWP comprising: transmitting on UL-SCH; transmitting on RACH; monitoring a PDCCH; transmitting PUCCH; receiving DL-SCH; and/or (re-)initializing any suspended configured uplink grants of configured grant Type 1 according to a stored configuration, if any.

In an example, on an inactive BWP for each activated serving cell configured with a BWP, a MAC entity may: not transmit on UL-SCH; not transmit on RACH; not monitor a PDCCH; not transmit PUCCH; not transmit SRS, not receive DL-SCH; clear any configured downlink assignment and configured uplink grant of configured grant Type 2; and/or suspend any configured uplink grant of configured Type 1.

In an example, if a MAC entity receives a PDCCH for a BWP switching of a serving cell while a Random Access procedure associated with this serving cell is not ongoing, a wireless device may perform the BWP switching to a BWP indicated by the PDCCH. In an example, if a bandwidth part indicator field is configured in DCI format 1_1, the bandwidth part indicator field value may indicate the active DL BWP, from the configured DL BWP set, for DL receptions. In an example, if a bandwidth part indicator field is configured in DCI format 0_1, the bandwidth part indicator field value may indicate the active UL BWP, from the configured UL BWP set, for UL transmissions.

In an example, for a primary cell, a wireless device may be provided by a higher layer parameter Default-DL-BWP a default DL BWP among the configured DL BWPs. If a wireless device is not provided a default DL BWP by the higher layer parameter Default-DL-BWP, the default DL BWP is the initial active DL BWP. In an example, a wireless device may be provided by higher layer parameter bwp-InactivityTimer, a timer value for the primary cell. If configured, the wireless device may increment the timer, if running, every interval of 1 millisecond for frequency range 1 or every 0.5 milliseconds for frequency range 2 if the wireless device may not detect a DCI format 1_1 for paired spectrum operation or if the wireless device may not detect a DCI format 1_1 or DCI format 0_1 for unpaired spectrum operation during the interval.

In an example, if a wireless device is configured for a secondary cell with higher layer parameter Default-DL-BWP indicating a default DL BWP among the configured DL BWPs and the wireless device is configured with higher layer parameter bwp-Inactivity Timer indicating a timer value, the wireless device procedures on the secondary cell may be same as on the primary cell using the timer value for the secondary cell and the default DL BWP for the secondary cell.

In an example, if a wireless device is configured by higher layer parameter Active-BWP-DL-SCell a first active DL BWP and by higher layer parameter Active-BWP-UL-SCell a first active UL BWP on a secondary cell or carrier, the wireless device may use the indicated DL BWP and the indicated UL BWP on the secondary cell as the respective first active DL BWP and first active UL BWP on the secondary cell or carrier.

In an example, a DCI addressed to an RNTI may comprise a CRC of the DCI being scrambled with the RNTI. The wireless device may monitor PDCCH addressed to (or for) the RNTI for detecting the DCI. For example, the PDCCH may carry (or be with) the DCI. In an example, the PDCCH may not carry the DCI.

In an example, a set of PDCCH candidates for a wireless device to monitor is defined in terms of PDCCH search space sets. A search space set comprises a CSS set or a USS set. A wireless device monitors PDCCH candidates in one or more of the following search spaces sets: a Type0-PDCCH CSS set configured by pdcch-ConfigSIB1 in MIB or by searchSpaceSIB1 in PDCCH-ConfigCommon or by search SpaceZero in PDCCH-ConfigCommon for a DCI format with CRC scrambled by a SI-RNTI on the primary cell of the MCG, a Type0A-PDCCH CSS set configured by searchSpaceOtherSystemInformation in PDCCH-ConfigCommon for a DCI format with CRC scrambled by a SI-RNTI on the primary cell of the MCG, a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or PS-RNTI and, only for the primary cell, C-RNTI, MCS-C-RNTI, or CS-RNTI(s), and a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

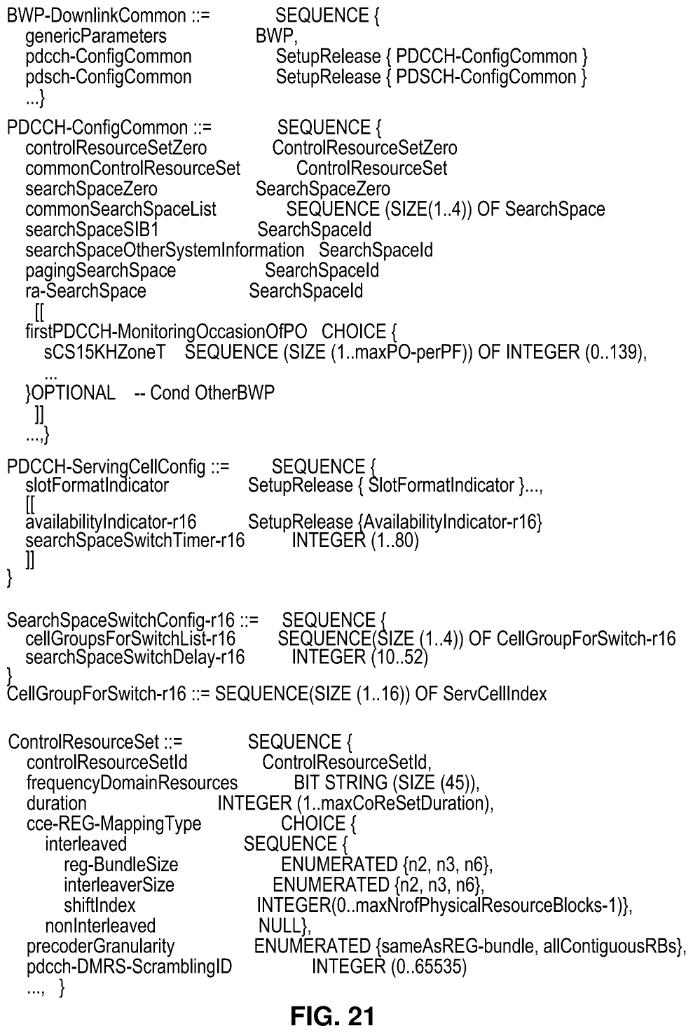

In an example, a wireless device determines a PDCCH monitoring occasion on an active DL BWP based on one or more PDCCH configuration parameters (e.g., PDCCH-Config and/or PDCCH-ConfigCommon and/or PDCCH-ServingCellConfig). The one or more PDCCH configuration parameters (see, e.g., FIG. 21) may comprise a PDCCH monitoring periodicity, a PDCCH monitoring offset, and a PDCCH monitoring pattern within a slot. For a search space set (SSs), the wireless device determines that a PDCCH monitoring occasion(s) exists in a slot with number

$${n}_{s , f}^{μ}$$

in a frame with number n_{f} if

$$( {n}_{f} \cdot {N}_{slot}^{frame , μ} + {n}_{s , f}^{μ} - {o}_{s} ) mod {k}_{s} = 0. {N}_{slot}^{frame , μ}$$

is a number of slots in a frame when numerology μ is configured. oₛ is a slot offset indicated in the one or more PDCCH configuration parameters (see, e.g., FIG. 21). kₛ is a PDCCH monitoring periodicity indicated in the one or more PDCCH configuration parameters (e.g., based on example embodiment of FIG. 21). The wireless device monitors PDCCH candidates for the search space set for Tₛ consecutive slots, starting from slot

$${n}_{s , f}^{μ} ,$$

and does not monitor PDCCH candidates for search space set s for the next kₛ-Tₛ consecutive slots. In an example, a USS at CCE aggregation level L∈{1, 2, 4, 8, 16} is defined by a set of PDCCH candidates for CCE aggregation level L.

In an example, a wireless device decides, for a search space set s associated with CORESET p, CCE indexes for aggregation level L corresponding to PDCCH candidate m_{s,n}_{_{CI}}, of the search space set in slot

$${n}_{s , f}^{μ}$$

for an active DL BWP of a serving cell corresponding to carrier indicator field value n_{CI} as

$$L \cdot \{ ( {Y}_{p , {n}_{s , f}^{μ}} + ⌊ \frac{{m}_{s , {n}_{Cl}} \cdot {N}_{CCE , p}}{L \cdot {M}_{s , max}^{( L )}} ⌋ + {n}_{Cl} ) mod ⌊ {N}_{C C E , p} / L ⌋ \} + i ,$$

where

$${Y}_{p , {n}_{s , f}^{μ}} = 0$$

### for any CSS;

$${Y}_{p , {n}_{s , f}^{μ}} = ( {A}_{p} \cdot {Y}_{p , {n}_{s , f}^{μ} - 1} ) mod D$$

for a USS, Y_{p,-1}=n_{RNTI}≠0, Aₚ=39827 for p mod 3=0, Aₚ=39829 for p mod 3=1, Aₚ=39839 for p mod 3=2, and D=65537; i=0, . . . , L−1; N_{CCE,p} is the number of CCEs, numbered from 0 to N_{CCE,p}−1, in CORESET p; n_{CI} is the carrier indicator field value if the wireless device is configured with a carrier indicator field by CrossCarrierSchedulingConfig for the serving cell on which PDCCH is monitored; otherwise, including for any CSS,

$${n}_{Cl} = 0 ; {m}_{s , {n}_{Cl}} = 0 , … , {M}_{s , {n}_{Cl}}^{( L )} - 1 ,$$

where

$${M}_{s , {n}_{Cl}}^{( L )}$$

is the number of PDCCH candidates the wireless device is configured to monitor for aggregation level L of a search space set s for a serving cell corresponding to n_{CI}; for any CSS,

$${M}_{s , max}^{( L )} = {M}_{s , 0}^{( L )} ;$$

### for a USS,

$${M}_{s , max}^{( L )}$$

is the maximum of

$${M}_{s , {n}_{Cl}}^{( L )}$$

over all configured n_{CI} values for a QUE aggregation level L of search space set s; and the RNTI value used for n_{RNTI} is the C-RNTI.

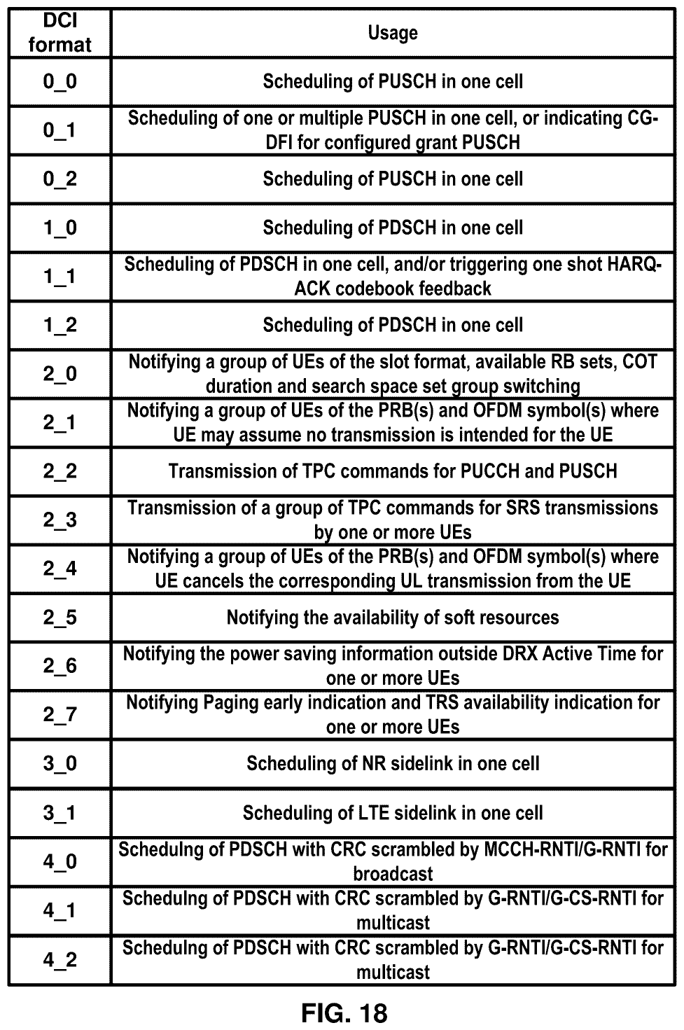

The one or more configuration parameters may comprise one or more search space set (SSS) configuration parameters. For example, a wireless device may monitor a set of PDCCH candidates according to configuration parameters of a search space set (e.g., the one or more SSS configuration parameters) comprising a plurality of search spaces (SSs). The wireless device may monitor a set of PDCCH candidates in one or more CORESETs for detecting one or more DCIs. A CORESET may be configured based on example embodiment of FIG. 21. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common SSs, and/or number of PDCCH candidates in the UE-specific SSs) and possible (or configured) DCI formats. The decoding may be referred to as blind decoding. The possible DCI formats may be based on example embodiments of FIG. 18.

FIG. 18 shows examples of DCI formats which may be used by a base station transmit control information to a wireless device or used by the wireless device for PDCCH monitoring. Different DCI formats may comprise different DCI fields and/or have different DCI payload sizes. Different DCI formats may have different signaling purposes. In an example, DCI format 0_0 may be used to schedule PUSCH in one cell. DCI format 0_1 may be used to schedule one or multiple PUSCH in one cell or indicate CG-DFI (configured grant-Downlink Feedback Information) for configured grant PUSCH, etc. The DCI format(s) which the wireless device may monitor in a SS may be configured.

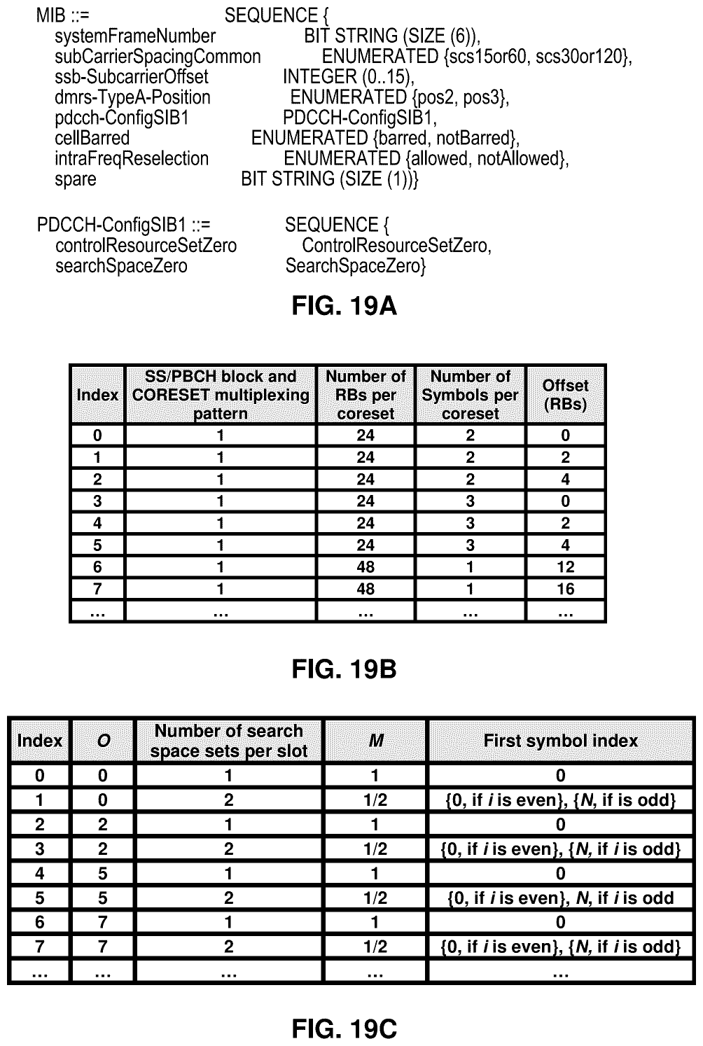

FIG. 19A shows an example of configuration parameters of a master information block (MIB) of a cell (e.g., PCell). The one or more configuration parameters may comprise the configuration parameters of the MIB. In an example, a wireless device, based on receiving primary synchronization signal (PSS) and/or secondary synchronization signal (SSS), may receive a MIB via a PBCH. The configuration parameters of a MIB may comprise six bits (systemFrameNumber) of system frame number (SFN), subcarrier spacing indication (subCarrierSpacingCommon), a frequency domain offset (ssb-SubcarrierOffset) between SSB and overall resource block grid in number of subcarriers, an indication (cellBarred) indicating whether the cell is bared, a DMRS position indication (dmrs-TypeA-Position) indicating position of DMRS, parameters of CORESET and SS of a PDCCH (pdcch-ConfigSIB1) comprising a common CORESET, a common search space and necessary PDCCH parameters, etc.

In an example, a pdcch-ConfigSIB1 may comprise a first parameter (e.g., controlResourceSetZero) indicating a common ControlResourceSet (CORESET) with ID #0 (e.g., CORESET #0) of an initial BWP of the cell. controlResourceSetZero may be an integer between 0 and 15. Each integer between 0 and 15 may identify a configuration of CORESET #0.

FIG. 19B shows an example of a configuration of CORESET #0. As shown in FIG. 19B, based on a value of the integer of controlResourceSetZero, a wireless device may determine a SSB and CORESET #0 multiplexing pattern, a number of RBs for CORESET #0, a number of symbols for CORESET #0, an RB offset for CORESET #0.

In an example, a pdcch-ConfigSIB1 may comprise a second parameter (e.g., searchSpaceZero) indicating a common search space with ID #0 (e.g., SS #0) of the initial BWP of the cell. searchSpaceZero may be an integer between 0 and 15. Each integer between 0 and 15 may identify a configuration of SS #0.

FIG. 19C shows an example of a configuration of SS #0. As shown in FIG. 19C, based on a value of the integer of searchSpaceZero, a wireless device may determine one or more parameters (e.g., O, M) for slot determination of PDCCH monitoring, a first symbol index for PDCCH monitoring and/or a number of search spaces per slot.

In an example, based on receiving a MIB, a wireless device may monitor PDCCH via SS #0 of CORESET #0 for receiving a DCI scheduling a system information block 1 (SIB1). A SIB1 message may be implemented based on example embodiment of FIG. 11A. The wireless device may receive the DCI with CRC scrambled with a system information radio network temporary identifier (SI-RNTI) dedicated for receiving the SIB1.

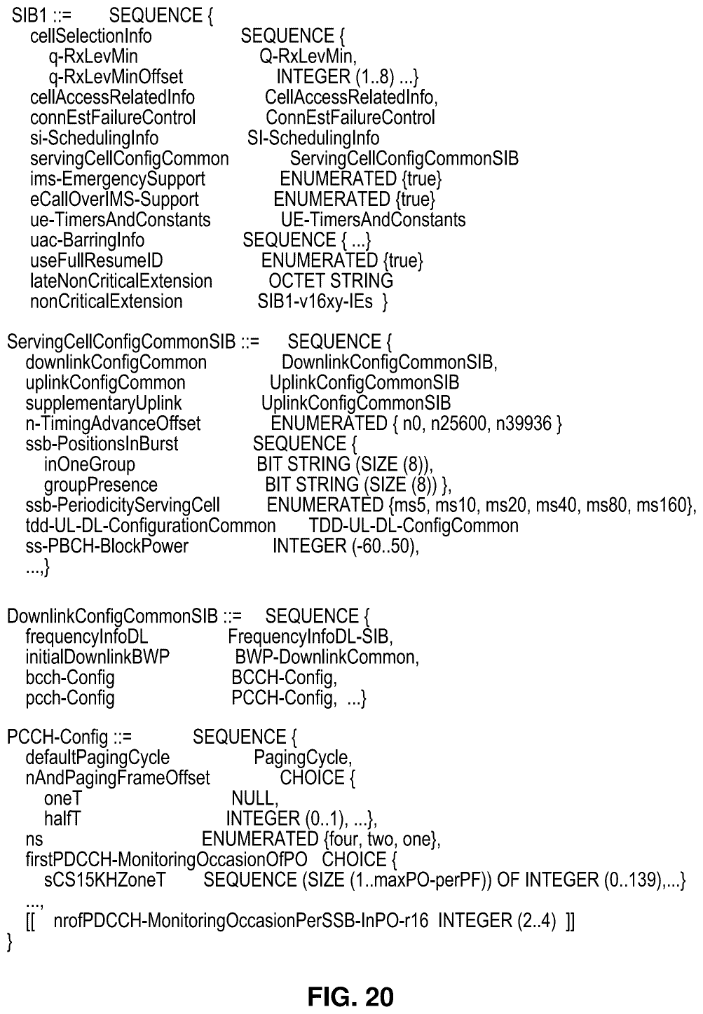

FIG. 20 shows an example of configuration parameters of system information block (SIB). The one or more configuration parameters may comprise the configuration parameters of SIB. A SIB (e.g., SIB1) may be transmitted to all wireless devices in a broadcast way. The SIB may contain information relevant when evaluating if a wireless device is allowed to access a cell, information of paging configuration and/or scheduling configuration of other system information. A SIB may contain radio resource configuration information that is common for all wireless devices and barring information applied to a unified access control.

In an example, a base station may transmit to a wireless device (or a plurality of wireless devices) one or more SIB information. For example, the one or more configuration parameters comprise/indicate the one or more SIB information. As shown in FIG. 20, parameters of the one or more SIB information may comprise: one or more parameters (e.g., cellSelectionInfo) for cell selection related to a serving cell, one or more configuration parameters of a serving cell (e.g., in ServingCellConfigCommonSIB IE), and one or more other parameters. The ServingCellConfigCommonSIB IE may comprise at least one of: common downlink parameters (e.g., in DownlinkConfigCommonSIB IE) of the serving cell, common uplink parameters (e.g., in UplinkConfigCommonSIB IE) of the serving cell, and other parameters.

In an example, a DownlinkConfigCommonSIB IE may comprise parameters of an initial downlink BWP (initialDownlinkBWP IE) of the serving cell (e.g., SpCell). The parameters of the initial downlink BWP may be comprised in a BWP-DownlinkCommon IE (as shown in FIG. 21). The BWP-DownlinkCommon IE may be used to configure common parameters of a downlink BWP of the serving cell. The base station may configure the locationAndBandwidth so that the initial downlink BWP contains the entire CORESET #0 of this serving cell in the frequency domain. The wireless device may apply the locationAndBandwidth upon reception of this field (e.g., to determine the frequency position of signals described in relation to this locationAndBandwidth) but it keeps CORESET #0 until after reception of RRCSetup/RRCResume/RRCReestablishment.

In an example, the DownlinkConfigCommonSIB IE may comprise parameters of a paging channel configuration. The parameters may comprise a paging cycle value (T, by defaultPagingCycle IE), a parameter (nAndPagingFrameOffset IE) indicating total number N) of paging frames (PFs) and paging frame offset (PF_offset) in a paging DRX cycle, a number (Ns) for total paging occasions (POs) per PF, a first PDCCH monitoring occasion indication parameter (firstPDCCH-MonitoringOccasionofPO IE) indicating a first PDCCH monitoring occasion for paging of each PO of a PF. The wireless device, based on parameters of a PCCH configuration, may monitor PDCCH for receiving paging message.

In an example, the parameter first-PDCCH-MonitoringOccasionOfPO may be signaled in SIB1 for paging in initial DL BWP. For paging in a DL BWP other than the initial DL BWP, the parameter first-PDCCH-MonitoringOccasionOfPO may be signaled in the corresponding BWP configuration.

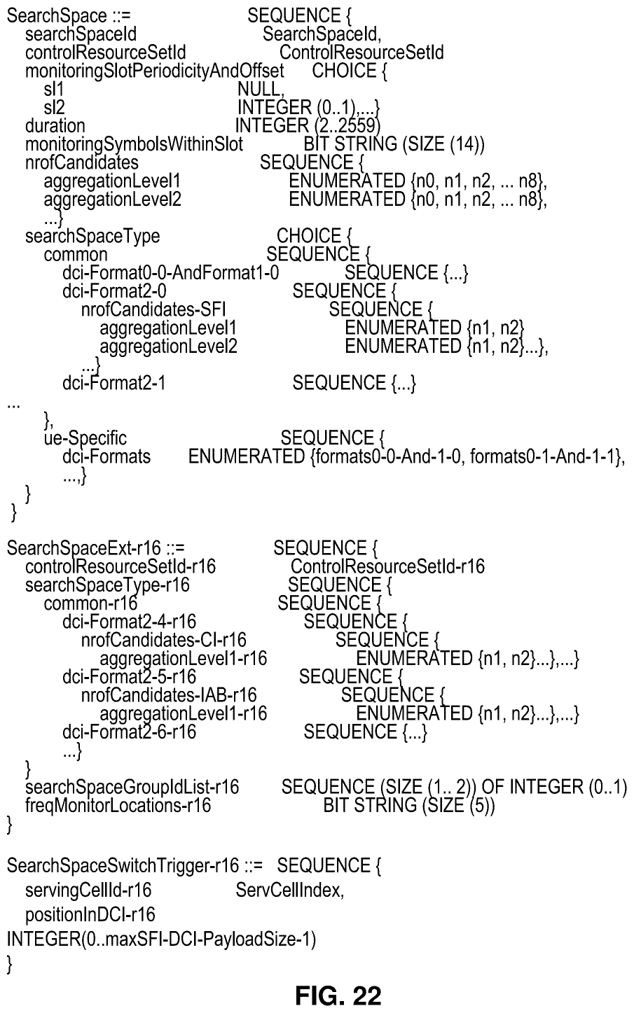

FIG. 21 shows an example of configuration parameters (e.g., BWP-DownlinkCommon IE) in a downlink BWP of a serving cell. The one or more configuration parameters may comprise the BWP-DownlinkCommon IE. The one or more configuration parameters of a downlink BWP (e.g., initial downlink BWP) of a serving cell. As shown in FIG. 21, the one or more configuration parameters of the downlink BWP may comprise: one or more generic BWP parameters of the downlink BWP, one or more cell specific parameters for PDCCH of the downlink BWP (e.g., in pdcch-ConfigCommon IE), one or more cell specific parameters for the PDSCH of this BWP (e.g., in pdsch-ConfigCommon IE), and one or more other parameters. A pdcch-ConfigCommon IE may comprise parameters of COESET #0 (e.g., controlResourceSetZero) which may be used in any common or UE-specific search spaces. A value of the controlResourceSetZero may be interpreted like the corresponding bits in MIB pdcch-ConfigSIB1. A pdcch-ConfigCommon IE may comprise parameters (e.g., in commonControlResourceSet) of an additional common control resource set which may be configured and used for any common or UE-specific search space. If the network configures this field, it uses a ControlResourceSetId other than 0 for this ControlResourceSet. The network configures the commonControlResourceSet in SIB1 so that it is contained in the bandwidth of CORESET #0. A pdcch-ConfigCommon IE may comprise parameters (e.g., in commonSearchSpaceList) of a list of additional common search spaces. Parameters of a search space may be implemented based on example of FIG. 22. A pdcch-ConfigCommon IE may indicate, from a list of search spaces, a search space for paging (e.g., pagingSearchSpace), a search space for random access procedure (e.g., ra-SearchSpace), a search space for SIB1 message (e.g., searchSpaceSIB1), a common search space #0 (e.g., searchSpaceZero), and one or more other search spaces.

As shown in FIG. 21, a control resource set (CORESET) may be associated with a CORESET index (e.g., ControlResourceSetId). A CORESET may be implemented based on example embodiments described above with respect to FIG. 14A and/or FIG. 14B. The CORESET index with a value of 0 may identify a common CORESET configured in MIB and in ServingCellConfigCommon (controlResourceSetZero) and may not be used in the ControlResourceSet IE. The CORESET index with other values may identify CORESETs configured by dedicated signaling or in SIB1. The controlResourceSetId is unique among the BWPs of a serving cell. A CORESET may be associated with coresetPoolIndex indicating an index of a CORESET pool for the CORESET. A CORESET may be associated with a time duration parameter (e.g., duration) indicating contiguous time duration of the CORESET in number of symbols. In an example, as shown in FIG. 22, configuration parameters of a CORESET may comprise at least one of: frequency resource indication (e.g., frequencyDomainResources), a CCE-REG mapping type indicator (e.g., cce-REG-MappingType), a plurality of TCI states, an indicator indicating whether a TCI is present in a DCI, and the like. The frequency resource indication, comprising a number of bits (e.g., 45 bits), may indicate frequency domain resources, each bit of the indication corresponding to a group of 6 RBs, with grouping starting from the first RB group in a BWP of a cell (e.g., SpCell, SCell). The first (left-most/most significant) bit may correspond to the first RB group in the BWP, and so on. A bit that is set to 1 may indicate that an RB group, corresponding to the bit, belongs to the frequency domain resource of this CORESET. Bits corresponding to a group of RBs not fully contained in the BWP within which the CORESET is configured may be set to zero. The one or more configuration parameters may comprise configuration parameters of CORESETs.

FIG. 22 shows an example of configuration of a search space (e.g., SearchSpace IE). In an example, the one or more SSS configuration parameters may comprise one or more search space configuration parameters, e.g., of a search space. The one or more search space configuration parameters, e.g., of a search space, may comprise at least one of: a search space ID (searchSpaceId), a control resource set ID (controlResourceSetId), a monitoring slot periodicity and offset parameter (monitoringSlotPeriodicityAndOffset), a search space time duration value (duration), a monitoring symbol indication (monitoringSymbolsWithinSlot), a number of candidates for an aggregation level (nrofCandidates), and/or a SS type indicating a common SS type or a UE-specific SS type (searchSpaceType). The monitoring slot periodicity and offset parameter may indicate slots (e.g., in a radio frame) and slot offset (e.g., related to a starting of a radio frame) for PDCCH monitoring. The monitoring symbol indication may indicate on which symbol(s) of a slot a wireless device may monitor PDCCH on the SS. The control resource set ID may identify a control resource set on which a SS may be located.

In an example, a wireless device, in RRC_IDLE or RRC_INACTIVE state, may periodically monitor paging occasions (POs) for receiving paging message for the wireless device. Before monitoring the POs, the wireless device, in RRC_IDLE or RRC_INACTIVE state, may wake up at a time before each PO for preparation and/or turn all components in preparation of data reception (warm up). The gap between the waking up and the PO may be long enough to accommodate all the processing requirements. The wireless device may perform, after the warming up, timing acquisition from SSB and coarse synchronization, frequency and time tracking, time and frequency offset compensation, and/or calibration of local oscillator. After that, the wireless device may monitor a PDCCH for a paging DCI in one or more PDCCH monitoring occasions based on configuration parameters of the PCCH configuration configured in SIB1.

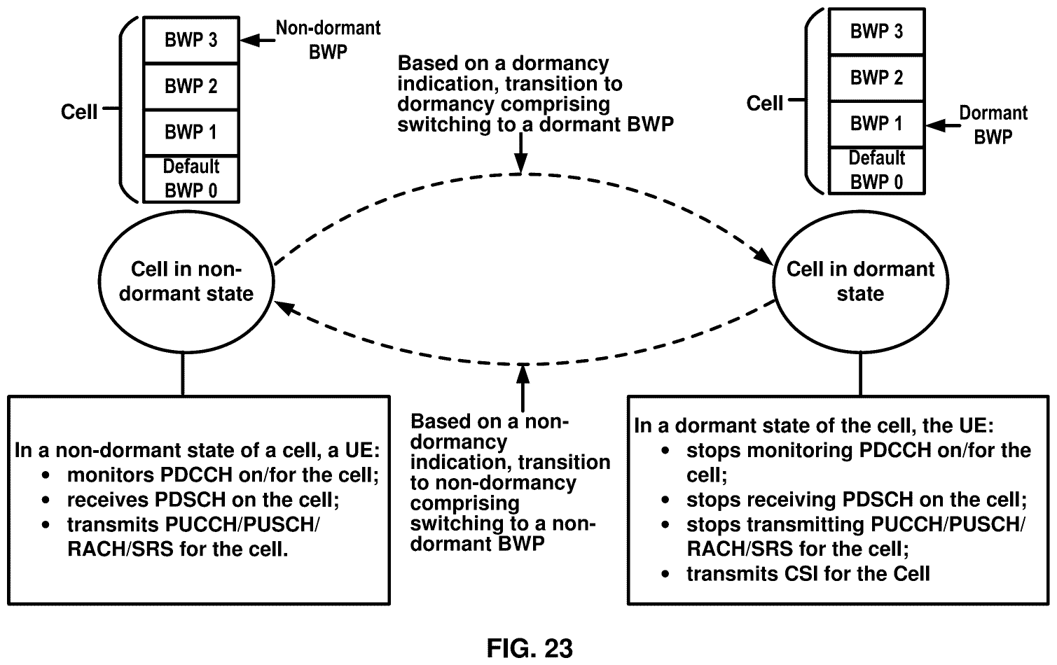

FIG. 23 shows an example embodiment of transitioning between a dormant state and a non-dormant state on a SCell. The one or more configuration parameters may comprise configuration parameters of a SCell. For example, the SCell comprises a plurality of BWPs. Among the plurality of BWPs, a first BWP (e.g., BWP 3 in FIG. 23) may be configured as a non-dormant BWP, and/or a second BWP (e.g., BWP 1 in FIG. 23) may be configured as a dormant BWP. In an example, a default BWP (e.g., BWP 0 in FIG. 23) may be configured in the plurality of BWPs. In an example, the non-dormant BWP may be a BWP which the wireless device may activate in response to transitioning the SCell from a dormant state to a non-dormant state. In an example, the dormant BWP may be a BWP which the wireless device may switch to in response to transitioning the SCell from a non-dormant state to a dormant state. In an example, the configuration parameters of the SCell may indicate one or more search spaces and/or CORESETs configured on the non-dormant BWP. The configuration parameters of the SCell may indicate no search spaces or no CORESETs configured on the dormant BWP. The configuration parameter of the SCell may indicate CSI reporting configuration parameters for the dormant BWP.

In an example, a default BWP may be different from a dormant BWP. The configuration parameters of the SCell may indicate one or more search spaces or one or more CORESETs configured on the default BWP. When a BWP inactivity timer expires or receiving a DCI indicating switching to the default BWP, a wireless device may switch to the default BWP as an active BWP. The wireless device, when the default BWP is in active, may perform at least one of: monitoring PDCCH on the default BWP of the SCell, receiving PDSCH on the default BWP of the SCell, transmitting PUSCH on the default BWP of the SCell, transmitting SRS on the default BWP of the SCell, and/or transmitting CSI report (e.g., periodic, aperiodic, and/or semi-persistent) for the default BWP of the SCell. In an example, when receiving a dormancy/non-dormancy indication indicating a dormant state for a SCell, the wireless device may switch to the dormant BWP as an active BWP of the SCell. In response to switching to the dormant BWP, the wireless device may perform at least one of: refraining from monitoring PDCCH on the dormant BWP of the SCell (or for the SCell if the SCell is cross-carrier scheduled by another cell), refraining from receiving PDSCH on the dormant BWP of the SCell, refraining from transmitting PUSCH on the dormant BWP of the SCell, refraining from transmitting SRS on the dormant BWP of the SCell, and/or transmitting CSI report (e.g., periodic, aperiodic, and/or semi-persistent) for the dormant BWP of the SCell.

As shown in FIG. 23, a base station may transmit to a wireless device a DCI via a PDCCH resource, the DCI comprising a dormancy/non-dormancy indication indicating whether a dormant state or a non-dormant state for the SCell. In response to the dormancy/non-dormancy indication indicating a dormant state for the SCell, the wireless device may: transition the SCell to the dormant state if the SCell is in a non-dormant state before receiving the DCI, or maintain the SCell in the dormant state if the SCell is in the dormant state before receiving the DCI. Transitioning the SCell to the dormant state may comprise switching to the dormant BWP (e.g., configured by the base station) of the SCell. In response to the dormancy/non-dormant indication indicating a non-dormant state for the SCell, the wireless device may: transition the SCell to the non-dormant state if the SCell is in a dormant state before receiving the DCI, or maintain the SCell in the non-dormant state if the SCell is in the non-dormant state before receiving the DCI. Transitioning the SCell to the non-dormant state may comprise switching to a non-dormant BWP (e.g., configured by the base station) of the SCell.

As shown in FIG. 23, in response to transitioning the SCell from a dormant state to a non-dormant state, the wireless device may switch to the non-dormant BWP (e.g., BWP 3 as shown in FIG. 23), configured by the base station, as an active BWP of the SCell. Based on the switching to the non-dormant BWP as the active BWP of the SCell, the wireless device may perform at least one of: monitoring PDCCH on the active BWP of the SCell (or monitoring PDCCH for the SCell when the SCell is configured to be cross-carrier scheduled by another cell), receiving PDSCH on the active BWP of the SCell, and/or transmitting PUCCH/PUSCH/RACH/SRS on the active BWP (e.g., if the active BWP is an uplink BWP).

As shown in FIG. 23, in response to transitioning the SCell from a non-dormant state to a dormant state, the wireless device may switch to the dormant BWP (e.g., BWP 1 of the SCell as shown in FIG. 23), configured by the base station. Based on the switching to the dormant BWP of the SCell, the wireless device may perform at least one of: refraining from monitoring PDCCH on the dormant BWP of the SCell (or refraining from monitoring PDCCH for the SCell when the SCell is configured to be cross-carrier scheduled by another cell), refraining from receiving PDSCH on the dormant BWP of the SCell, refraining from transmitting PUCCH/PUSCH/RACH/SRS on the dormant BWP (e.g., if the dormant BWP is an uplink BWP), and/or transmitting CSI report for the dormant BWP of the SCell based on the CSI reporting configuration parameters configured on the dormant BWP of the SCell.

In an example, the one or more configuration parameters may comprise one or more DRX configuration parameters (e.g., DRX-Config), e.g., a set of DRX parameters. A DRX operation may be used by a wireless device to improve the wireless device battery lifetime. With DRX configured (e.g., the DRX-Config being available), the wireless device may discontinuously monitor downlink control channel, e.g., PDCCH or EPDCCH. The set of DRX parameters may be selected based on the application type such that the wireless device may reduce power and resource consumption. In response to DRX being configured/activated, the wireless device may receive data packets with an extended delay, since the wireless device may be in DRX Sleep/Off state at the time of data arrival at the wireless device and the base station may wait until the wireless device transitions to the DRX ON state.

During a DRX mode, the wireless device may power down most of its circuitry when there are no packets to be received. The wireless device may monitor PDCCH discontinuously in the DRX mode. The wireless device may monitor the PDCCH continuously when a DRX operation is not configured. During this time the wireless device listens to the downlink (DL) (or monitors PDCCHs) which is called DRX Active state. In a DRX mode, a time during which the wireless device doesn't listen/monitor PDCCH is called DRX Sleep state.

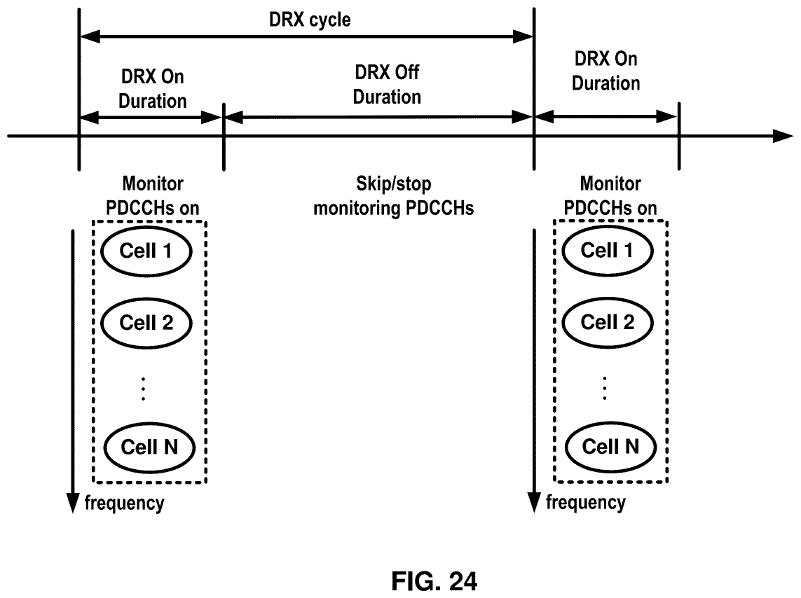

FIG. 24 shows an example of the embodiment of a DRX operation in wireless communication systems. A base station may transmit an RRC message comprising one or more DRX parameters of a DRX cycle. The one or more parameters may comprise a first parameter and/or a second parameter. The first parameter may indicate a first time/window value of the DRX Active state (e.g., DRX On duration) of the DRX cycle. The second parameter may indicate a second time of the DRX Sleep state (e.g., DRX Off duration) of the DRX cycle. The one or more parameters may further comprise a time duration of the DRX cycle. During the DRX Active state, the wireless device may monitor PDCCHs for detecting one or more DCIs on a serving cell. During the DRX Sleep state, the wireless device may stop monitoring PDCCHs on the serving cell. When multiple cells are in active state, the wireless device may monitor all PDCCHs on (or for) the multiple cells during the DRX Active state. During the DRX off duration, the wireless device may stop monitoring all PDCCH on (or for) the multiple cells. The wireless device may repeat the DRX operations according to the one or more DRX parameters.

The DRX-Config (e.g., the DRX functionality) may control the wireless device's downlink control channel (e.g., PDCCH) monitoring activity for a plurality of RNTIs for the MAC entity. The plurality of RNTIs may comprise at least one of: C-RNTI; CS-RNTI; INT-RNTI; SP-CSI-RNTI; SFI-RNTI; TPC-PUCCH-RNTI; TPC-PUSCH-RNTI; Semi-Persistent Scheduling C-RNTI; eIMTA-RNTI; SL-RNTI; SL-V-RNTI; CC-RNTI; or SRS-TPC-RNTI. In an example, in response to being in RRC_CONNECTED, if DRX is configured, the MAC entity may monitor the PDCCH discontinuously using the DRX operation; otherwise the MAC entity may monitor the PDCCH continuously.

The DRX-Config may control the DRX operation by configuring a plurality of timers. The plurality of timers may comprise: a DRX On duration timer (e.g., drx-onDurationTimer); a DRX inactivity timer (e.g., drx-InactivityTimer); a downlink DRX HARQ round trip time (RTT) timer (e.g., drx-HARQ-RTT-TimerDL); an uplink DRX HARQ RTT Timer (e.g., drx-HARQ-RTT-TimerUL); a downlink retransmission timer (e.g., drx-RetransmissionTimerDL); an uplink retransmission timer (e.g., drx-RetransmissionTimerUL); one or more parameters of a short DRX configuration (e.g., drx-ShortCycle and/or drx-ShortCycleTimer)) and one or more parameters of a long DRX configuration (e.g., drx-LongCycle). In an example, time granularity for DRX timers may be in terms of PDCCH subframes (e.g., indicated as psf in the DRX configurations), or in terms of milliseconds.

In response to a DRX cycle being configured, the Active Time of the DRX operation may include the time while at least one timer is running. The at least one timer may comprise drx-onDuration Timer, drx-InactivityTimer, drx-Retransmission TimerDL, drx-Retransmission TimerUL, or mac-ContentionResolutionTimer. During the Active timer of the DRX operation, the wireless device may monitor PDCCH with RNTI(s) impacted by the DRX operation. The RNTIs may comprise C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and/or AI-RNTI.

The drx-Inactivity-Timer may specify a time duration for which the wireless device may be active after successfully decoding a PDCCH indicating a new transmission (UL or DL or SL). This timer may be restarted upon receiving PDCCH for a new transmission (UL or DL or SL). The wireless device may transition to a DRX mode (e.g., using a short DRX cycle or a long DRX cycle) in response to the expiry of this timer. In an example, drx-ShortCycle may be a first type of DRX cycle (e.g., if configured) that needs to be followed when the wireless device enters DRX mode. In an example, a DRX-Config IE indicates the length of the short cycle. drx-ShortCycleTimer may be expressed as multiples of shortDRX-Cycle. The timer may indicate the number of initial DRX cycles to follow the short DRX cycle before entering the long DRX cycle. drx-onDuration Timer may specify the time duration at the beginning of a DRX Cycle (e.g., DRX ON). drx-onDurationTimer may indicate the time duration before entering the sleep mode (DRX OFF). drx-HARQ-RTT-TimerDL may specify a minimum duration from the time new transmission is received and before the wireless device may expect a retransmission of a same packet. This timer may be fixed and may not be configured by RRC. drx-Retransmission TimerDL may indicate a maximum duration for which the wireless device may be monitoring PDCCH when a retransmission from the eNodeB is expected by the wireless device.

In response to a DRX cycle being configured, the Active Time may comprise the time while a Scheduling Request is sent on PUCCH and is pending. In an example, in response to a DRX cycle being configured, the Active Time may comprise the time while an uplink grant for a pending HARQ retransmission can occur and there is data in the corresponding HARQ buffer for synchronous HARQ process. In response to a DRX cycle being configured, the Active Time may comprise the time while a PDCCH indicating a new transmission addressed to the C-RNTI of the MAC entity has not been received after successful reception of a Random Access Response for the preamble not selected by the MAC entity.

In an example embodiment, a DL HARQ RTT Timer (e.g., drx-HARQ-RTT-TimerDL) may expire in a subframe and the data of the corresponding HARQ process may not be successfully decoded. The MAC entity may start the drx-Retransmission TimerDL for the corresponding HARQ process. An UL HARQ RTT Timer (e.g., drx-HARQ-RTT-TimerUL) may expire in a subframe. The MAC entity may start the drx-Retransmission TimerUL for the corresponding HARQ process. A DRX Command MAC control element or a Long DRX Command MAC control element may be received. The MAC entity may stop drx-onDurationTimer and stop drx-InactivityTimer. In an example, drx-InactivityTimer may expire or a DRX Command MAC control element may be received in a subframe. In an example, in response to Short DRX cycle being configured, the MAC entity may start or restart drx-ShortCycleTimer and may use Short DRX Cycle. Otherwise, the MAC entity may use the Long DRX cycle.

In an example embodiment, drx-ShortCycleTimer may expire in a subframe. The MAC entity may use the Long DRX cycle. In an example, a Long DRX Command MAC control element may be received. The MAC entity may stop drx-ShortCycleTimer and may use the Long DRX cycle.

In an example embodiment, if the Short DRX Cycle is used and [(SFN*10)+subframe number] modulo (drx−ShortCycle)=(drxStartOffset) modulo (drx−ShortCycle), the wireless device may start drx-onDuration Timer. In an example, if the Long DRX Cycle is used and [(SFN*10)+subframe number] modulo (drx−longCycle)=drxStartOffset, the wireless device may start drx-onDuration Timer.

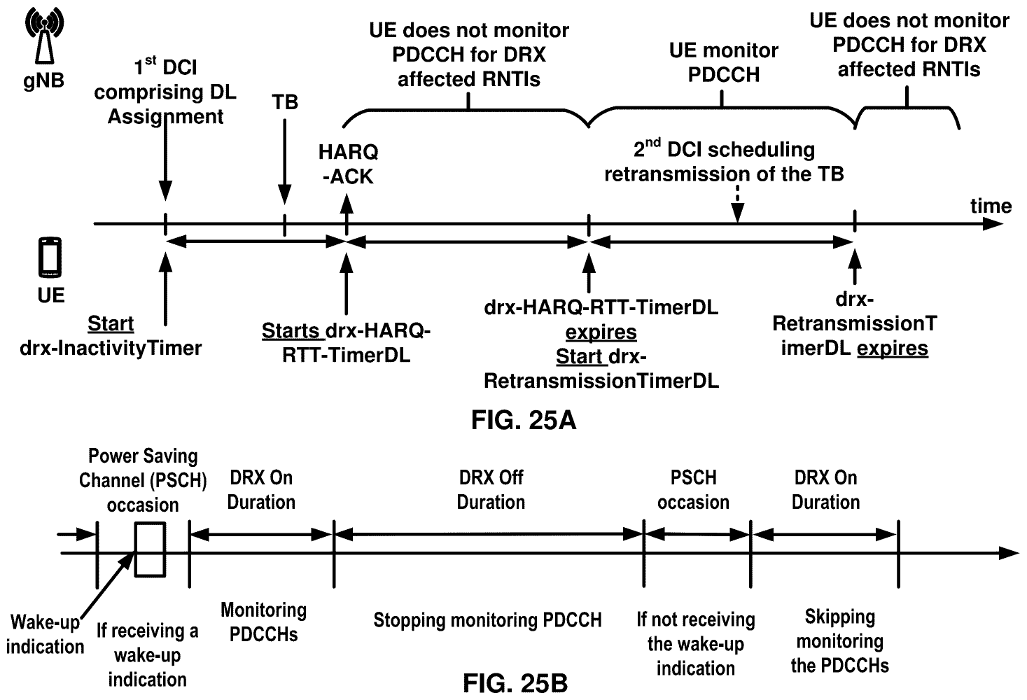

FIG. 25A shows example of DRX operation. The DRX-Config may comprise a first timer value for a DRX inactivity timer (e.g., drx-InactivityTimer), a second timer value for a HARQ RTT timer (e.g., drx-HARQ-RTT-TimerDL, drx-HARQ-RTT-TimerUL), a third timer value for a HARQ retransmission timer (e.g., drx-Retransmission TimerDL or drx-RetransmissionTimerUL).

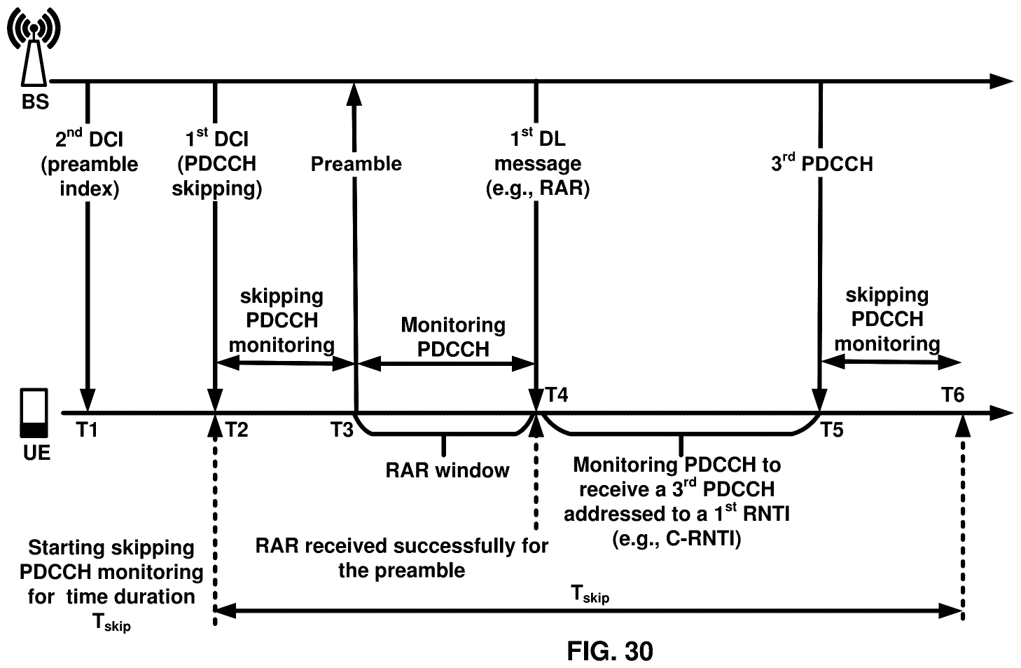

As shown in FIG. 25A, a base station may transmit, via a PDCCH, a DCI (e.g., 1st DCI) comprising downlink assignment for a TB, to a wireless device. In response to receiving the DCI, the wireless device may start the drx-InactivityTimer. During the drx-InactivityTimer being running, the wireless device may monitor the PDCCH. The wireless device may receive a TB based on receiving the DCI. The wireless device may transmit a NACK to the base station upon unsuccessful decoding the TB. In the first symbol after the end of transmitting the NACK, the wireless device may start a HARQ RTT Timer (e.g., drx-HARQ-RTT-TimerDL). The wireless device may stop the drx-Retransmission TimerDL for a HARQ process corresponding to the TB (not shown in FIG. 30). During the HARQ RTT Timer being running, the wireless device may stop monitoring the PDCCH for one or more RNTI(s) impacted by the DRX operation. The one or more RNTI(s) may comprise C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and/or AI-RNTI. As shown in FIG. 30, when the HARQ RTT Timer expires, the wireless device may monitor the PDCCH and start a HARQ retransmission timer (e.g., drx-Retransmission TimerDL). When the HARQ retransmission timer is running, the wireless device, during the monitoring the PDCCH, may receive a second DCI (e.g., 2nd DCI in FIG. 30) scheduling retransmission of the TB. If not receiving the second DCI before the HARQ retransmission timer expires, the wireless device may stop monitoring the PDCCH.

FIG. 25B shows an example of a power saving mechanism based on wake-up indication. The one or more configuration parameters may comprise one or more power saving (e.g., DCP and/or Power Saving Channel (PSCH) occasion) configuration parameters. The one or more power saving configuration parameters may indicate/configure a wake-up duration (e.g., a power saving duration, or a Power Saving Channel (PSCH) occasion), to a wireless device. The wake-up duration may be located at a number of slots (or symbols) before a DRX On duration of a DRX cycle. A DRX cycle may be implemented based on example embodiments described above with respect to FIG. 25A. The number of slots (or symbols), or, referred to as a gap between a wakeup duration and a DRX on duration, may be configured in the one or more configuration parameters or predefined as a fixed value. The gap may be used for at least one of: synchronization with the base station; measuring reference signals; and/or retuning RF parameters. The gap may be determined based on a capability of the wireless device and/or the base station. In an example, the parameters of the wake-up duration may be pre-defined without RRC configuration. In an example, the wake-up mechanism may be based on a wake-up indication via a PSCH. The parameters of the wake-up duration may comprise at least one of: a PSCH channel format (e.g., numerology, DCI format, PDCCH format); a periodicity of the PSCH; a control resource set and/or a search space of the PSCH. When configured with the parameters of the wake-up duration, the wireless device may monitor the wake-up signal or the PSCH during the wake-up duration. When configured with the parameters of the PSCH occasion, the wireless device may monitor the PSCH for detecting a wake-up indication during the PSCH occasion. In response to receiving the wake-up signal/channel (or a wake-up indication via the PSCH), the wireless device may wake-up to monitor PDCCHs in a DRX active time of a next DRX cycle according to the DRX configuration. In an example, in response to receiving the wake-up indication via the PSCH, the wireless device may monitor PDCCHs in the DRX active time (e.g., when drx-on DurationTimer is running). The wireless device may go back to sleep if not receiving PDCCHs in the DRX active time. The wireless device may keep in sleep during the DRX off duration of the DRX cycle. In an example, if the wireless device doesn't receive the wake-up signal/channel (or a wake-up indication via the PSCH) during the wake-up duration (or the PSCH occasion), the wireless device may skip monitoring PDCCHs in the DRX active time. In an example, if the wireless device receives an indication indicating skipping PDCCH monitoring during the wake-up duration (or the PSCH occasion), the wireless device may skip monitoring PDCCHs in the DRX active time.

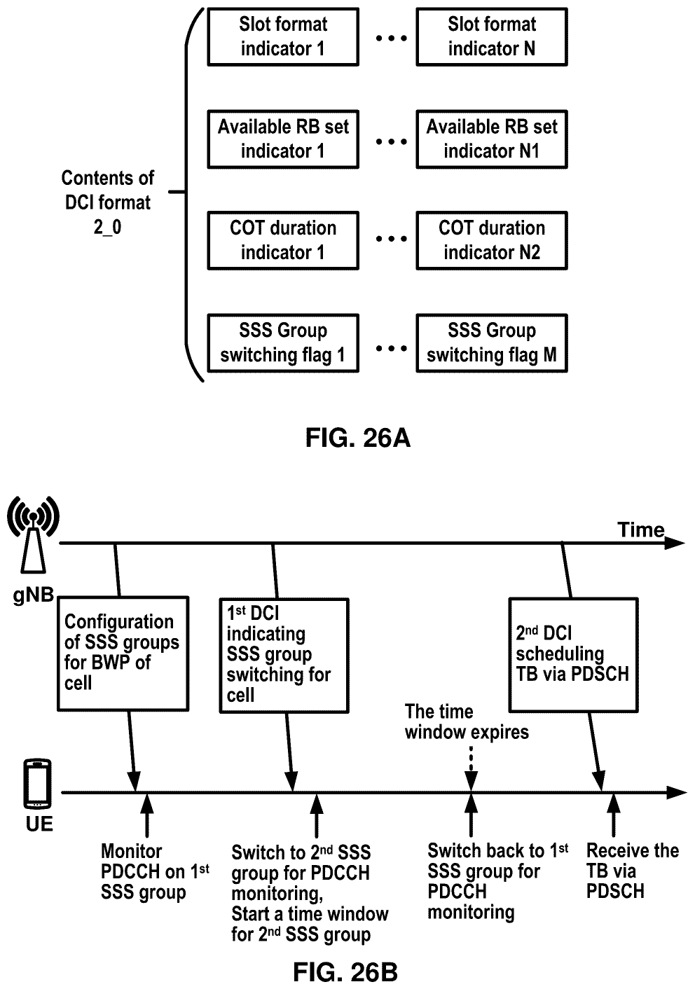

FIG. 26A shows an example of DCI format 2_0 comprising one or more search space set group (or SSSG) switching indications (or Search space set group switching flags). In an example, a DCI format 2_0 may comprise one or more slot format indicator (e.g., slot format indicator 1, slot format indicator 2, . . . slot format indicator N), one or more available RB set indicators, one or more COT duration indications, one or more SSS group switching flags. In an example, each of the one or more SSS group switching flags may correspond to a respective cell group of a plurality of cell groups. Each cell group of the plurality of cell groups may comprise one or more cells. A SSS group switching flag, of the one or more SSS group switching flags, corresponding to a cell group, may indicate, when setting to a first value, switching from a first SSS group to a second SSS group for each cell of the cell group. The SSS group switching flag may indicate, when setting to a second value, switching from the second SSS group to the first SSS group for each cell of the cell group. The wireless device may perform SSS group switching based on example embodiment of FIG. 26B.

FIG. 26B shows an example of SSS group switching based on a DCI. In an example, a wireless device may be provided a group index for a search space set (e.g., a Type3-PDCCH CSS set, a USS set, or any other type of search space set) by searchSpaceGroupIdList (e.g., based on example embodiment of FIG. 21) for PDCCH monitoring on a serving cell.

In an example, the wireless device may not be provided searchSpaceGroupIdList for a search space set. The embodiments of FIG. 26B may not be applicable for PDCCH monitoring on the search space if the search space set is not configured with searchSpaceGroupIdList. Based on not applying the embodiments of FIG. 26B, the wireless device may monitor the search space set on a BWP, without switching away from the search space set for PDCCH monitoring.

In an example, if a wireless device is provided cellGroupsForSwitchList (e.g., based on example embodiments shown in FIG. 21), indicating one or more groups of serving cells, the embodiments of FIG. 26B may apply to all serving cells within each group. If the wireless device is not provided cellGroupsForSwitchList, the embodiments of FIG. 26B may apply only to a serving cell for which the wireless device is provided search SpaceGroupIdList.

In an example, if a wireless device is provided searchSpaceGroupIdList, the wireless device may reset PDCCH monitoring according to search space sets with group index 0, if provided by searchSpaceGroupIdList.

In an example, a wireless device may be provided by searchSpaceSwitchDelay (e.g., as shown in FIG. 21) with a number of symbols P_{switch} based on wireless device processing capability (e.g., wireless device processing capability 1, wireless device processing capability 2, etc.) and SCS configuration p. wireless device processing capability 1 for SCS configuration u may apply unless the wireless device indicates support for wireless device processing capability 2. In an example, P_{switch}=25 for wireless device capability 1 and μ=0, P_{switch}=25 for wireless device capability 1 and μ=1, P_{switch}=25 for wireless device capability 1 and μ=2, P_{switch}=10 for wireless device capability 2 and μ=0, P_{switch}=12 for wireless device capability 2 and μ=1, and P_{switch}=22 for wireless device capability 2 and μ=2, etc.

In an example, a wireless device may be provided, by searchSpaceSwitchTimer (in units of slots, e.g., as shown in FIG. 21), with a timer value for a serving cell that the wireless device is provided search SpaceGroupIdList or, if provided, for a set of serving cells provided by cellGroupsForSwitchList. The wireless device may decrement the timer value by one after each slot based on a reference SCS configuration that is a smallest SCS configuration u among all configured DL BWPs in the serving cell, or in the set of serving cells. The wireless device may maintain the reference SCS configuration during the timer decrement procedure.

In an example, searchSpaceSwitchTimer may be defined as a value in unit of slots for monitoring PDCCH in the active DL BWP of the serving cell before moving to a default search space group (e.g., search space group 0). For 15 kHz SCS, a valid timer value may be one of {1, . . . , 20}. For 30 KHz SCS, a valid timer value may be one of {1, . . . , 40}. For 60 KHz SCS, a valid timer value may be one of {1, . . . , 80}. In an example, the base station may configure a same timer value for all serving cells in the same CellGroupForSwitch.

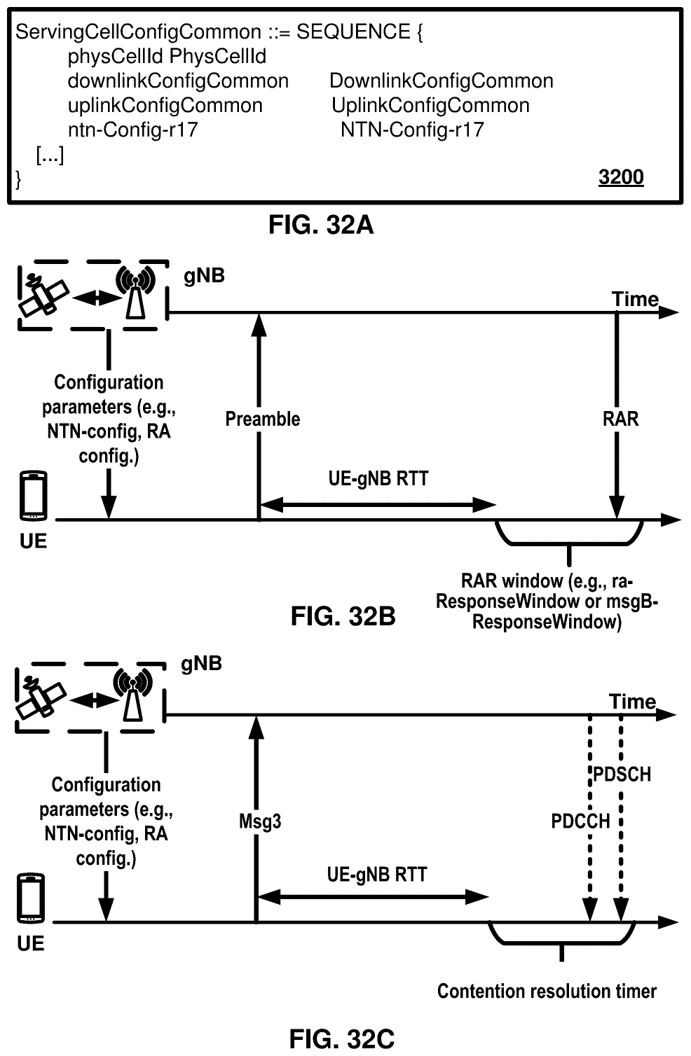

As shown in FIG. 26B, the wireless device may monitor PDCCH on a first SSS group (e.g., 1st SSS group or a SSS with group index 0) based on configuration of SSS groups of a BWP of a cell. The wireless device may be provided by SearchSpaceSwitch Trigger with a location of a search space set group switching flag field for a serving cell in a DCI format 2_0. The SearchSpaceSwitch Trigger may be configured based on example embodiments of FIG. 22. The wireless device may receive a DCI (e.g., 1st DCI in FIG. 32B with DCI format 2_0). The DCI may indicate a SSS group switching for the cell, e.g., when a value of the SSS group switching flag field in the DCI format 2_0 is 1. In response to receiving the DCI, the wireless device may start monitoring PDCCH according to a second SSS group (e.g., 2nd SSS group or a SSS with group index 1) and stops monitoring PDCCH on the first SSS group (or the SSS with group index 0 for the serving cell. The wireless device may start monitoring PDCCH on the second SSS group (e.g., 2nd SSS group or a SSS with group index 1) and stops monitoring PDCCH on the first SSS group at a first slot that is at least P_{switch} symbols after a last symbol of the PDCCH with the DCI format 2_0. Based on receiving the DCI, the wireless device may set a timer value of the search space switching timer to the value provided by search SpaceSwitchTimer.

In an example, the wireless device may monitor PDCCH on a second SSS group (e.g., 2nd SSS group or a SSS with group index 1) based on configuration of SSS groups of a BWP of a cell. The wireless device may be provided by SearchSpaceSwitch Trigger a location of a search space set group switching flag field for a serving cell in a DCI format 2_0. The wireless device may receive a DCI. The DCI may indicate a SSS group switching for the cell, e.g., when a value of the search space set group switching flag field in the DCI format 2_0 is 0, the wireless device may start monitoring PDCCH according to search space sets with group index 0 and stop monitoring PDCCH according to search space sets with group index 1 for the serving cell. The wireless device may start monitoring the PDCCH according to search space set with group index 0 and stop monitoring PDCCH according to search space sets with group 1 at a first slot that is at least P_{switch} symbols after the last symbol of the PDCCH with the DCI format 2_0.

In an example, if the wireless device monitors PDCCH for a serving cell according to a first SSS group (e.g., search space sets with group index 1), the wireless device may start monitoring PDCCH for the serving cell according to a second SSS group (e.g., search space sets with group index 0), and stop monitoring PDCCH according to the first SSS group, for the serving cell at the beginning of the first slot that is at least P_{switch} symbols after a slot where the timer expires or after a last symbol of a remaining channel occupancy duration for the serving cell that is indicated by DCI format 2_0.

In an example, a wireless device may not be provided SearchSpaceSwitch Trigger for a serving cell, e.g., SearchSpaceSwitch Trigger being absent in configuration parameters of SlotFormatIndicator, wherein the SlotFormatIndicator is configured for monitoring a Group-Common-PDCCH for Slot-Format-Indicators (SFI). In response to the Search SpaceSwitch Trigger not being provided, the DCI format 2_0 may not comprise a SSS group switching flag field. When the SearchSpaceSwitchTrigger is not provided, if the wireless device detects a DCI format by monitoring PDCCH according to a first SSS group (e.g., a search space set with group index 0), the wireless device may start monitoring PDCCH according to a second SSS group (e.g., a search space sets with group index 1) and stop monitoring PDCCH according to the first SSS group, for the serving cell. The wireless device may start monitoring PDCCH according to the second SSS group and stop monitoring PDCCH according to the first SSS group at a first slot that is at least P_{switch} symbols after the last symbol of the PDCCH with the DCI format. The wireless device may set (or restart) the timer value to the value provided by search SpaceSwitch Timer if the wireless device detects a DCI format by monitoring PDCCH in any search space set.

In an example, a wireless device may not be provided Search SpaceSwitch Trigger for a serving cell. When the Search SpaceSwitch Trigger is not provided, if the wireless device monitors PDCCH for a serving cell according to a first SSS group (e.g., a search space sets with group index 1), the wireless device may start monitoring PDCCH for the serving cell according to a second SSS group (e.g., a search space sets with group index 0), and stop monitoring PDCCH according to the first SSS group, for the serving cell at the beginning of the first slot that is at least P_{switch} symbols after a slot where the timer expires or, if the wireless device is provided a search space set to monitor PDCCH for detecting a DCI format 2_0, after a last symbol of a remaining channel occupancy duration for the serving cell that is indicated by DCI format 2_0.

In an example, a wireless device may determine a slot and a symbol in a slot to start or stop PDCCH monitoring according to search space sets for a serving cell that the wireless device is provided search SpaceGroupIdList or, if cellGroupsForSwitchList is provided, for a set of serving cells, based on the smallest SCS configuration u among all configured DL BWPs in the serving cell or in the set of serving cells and, if any, in the serving cell where the wireless device receives a PDCCH and detects a corresponding DCI format 2_0 triggering the start or stop of PDCCH monitoring according to search space sets.

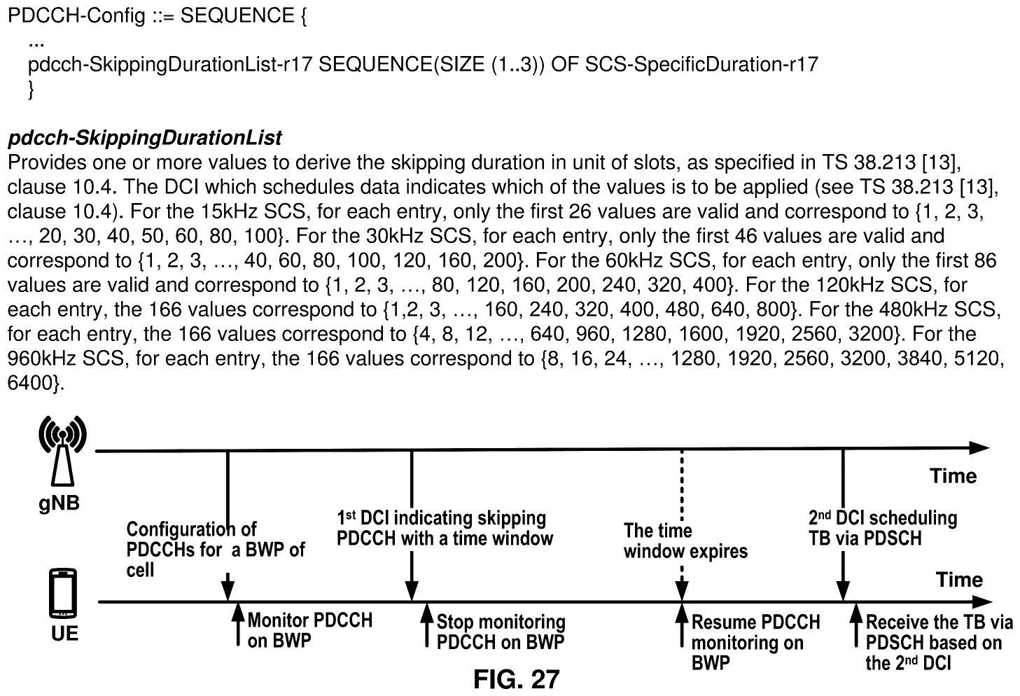

FIG. 27 shows an example of PDCCH skipping based power saving operation. A base station may configure a wireless device (e.g., via PDCCH-Config in the one or more configuration parameters) to skip (or avoid/stop/terminate) monitoring downlink control channels (e.g., to skip monitoring PDCCH or to skip PDCCH monitoring or avoid monitoring the PDCCH). In an example, a wireless device may perform PDCCH skipping mechanism for power saving operation.

In an example, the one or more PDCCH configuration parameters may comprise configuration parameters of PDCCH for a BWP of a cell (e.g., based on example embodiments described above with respect to FIG. 21 and/or FIG. 22). Based on the one or more PDCCH configuration parameters, the wireless device may monitor PDCCH on the BWP. The BWP may a downlink BWP which is in active state. The wireless device may activate the BWP based on example embodiments described above with respect to FIG. 17.

For example, as shown in FIG. 27, the one or more PDCCH configuration parameters (e.g., the PDCCH-Config) may comprise at least one time duration/window (e.g., pdcch-SkippingDurationList) for PDCCH skipping. The at least one time duration (e.g., pdcch-SkippingDurationList) may indicate one or more (PDCCH or control channel) skipping values corresponding to skipping duration in unit of slots (or symbols or ms). For the 15 kHz SCS, for each value of the one or more skipping values, only a first 26 skipping values are valid and correspond to {1, 2, 3, . . . , 20, 30, 40, 50, 60, 80, 100} slots (or symbols or ms). For the 30 kHz SCS, for each value of the one or more skipping values, only a first 46 skipping values are valid and correspond to {1, 2, 3, . . . , 40, 60, 80, 100, 120, 160, 200} slots (or symbols or ms). For the 60 KHz SCS, for each value of the one or more skipping values, only the first 86 skipping values are valid and correspond to {1, 2, 3, . . . , 80, 120, 160, 200, 240, 320, 400}. For the 120 kHz SCS, for each value of the one or more skipping values, the 166 skipping values correspond to {1, 2, 3, . . . , 160, 240, 320, 400, 480, 640, 800} slots (or symbols or ms). For the 480 kHz SCS, for each value of the one or more skipping values, the 166 skipping values correspond to {4, 8, 12, . . . , 640, 960, 1280, 1600, 1920, 2560, 3200}. For the 960 kHz SCS, for each value of the one or more skipping values, the 166 values correspond to {8, 16, 24, . . . , 1280, 1920, 2560, 3200, 3840, 5120, 6400} slots (or symbols or ms).

In response to receiving a skipping indication indicating skipping PDCCH monitoring for a time duration/window (e.g., in a number of slots), of the at least one time duration, the wireless device may skip monitoring PDCCH during the time duration on the active DL BWP of a cell (e.g., a serving cell, e.g., a SpCell). The skipping indication may be based on a first DCI in FIG. 27. For example, the first DCI may comprise a first filed (e.g., the ‘PDCCH monitoring adaptation indication’ filed) indicating the time duration for skipping monitoring the PDCCH.

As shown in FIG. 27, the wireless device may receive the first DCI indicating skipping PDCCH with a time duration/window (e.g., indicated via the ‘PDCCH monitoring adaptation indication’ field). A time value for the time window may be indicated by the first DCI or configured by the one or more PDCCH configuration parameters (e.g., the at least one time duration/window). In response to receiving the first DCI, the wireless device may stop monitoring PDCCH on the BWP (e.g., of the serving cell). Stopping monitoring PDCCH on the BWP may comprise stopping monitoring PDCCH on one or more SSS groups configured on the BWP. The wireless device may maintain an active state of the BWP. The first DCI may not indicate an active BWP switching. In an example, during the time window/duration (or when a timer associated with the time window is running), e.g., during the time duration from receiving the first DCI, the base station may not transmit PDCCHs to the wireless device.

As shown in FIG. 27, when the time duration expires, the wireless device may resume PDCCH monitoring on the BWP (e.g., terminate/stop/cancel the PDCCH skipping). Based on resuming PDCCH monitoring, the wireless device may receive a second DCI (e.g., scheduling TB via a PDSCH). The wireless device may receive the TB via the PDSCH scheduled by the second DCI. In an example, in response to the time window expiring, the base station may transmit one or more PDCCHs (e.g., comprising/carrying the second DCI) to the wireless device.

When the PDCCH monitoring adaptation field of the first DCI indicates to a wireless device to skip PDCCH monitoring for a duration (e.g., skipping the PDCCH during the time window/duration) on the active DL BWP of a serving cell, the wireless device may start skipping of PDCCH monitoring (e.g., or stop monitoring the PDCCH) at the beginning of a first/initial/starting slot that is after the last/final/ending symbol of a PDCCH reception providing a DCI format (of the first DCI) with the PDCCH monitoring adaptation field. For example, the time duration may start from the first/initial/starting slot that is after the last/final/ending symbol of a PDCCH reception providing the first DCI with the PDCCH monitoring adaptation field. For example, the wireless device may skip monitoring the PDCCH during the time duration from the receiving the first DCI.

If the wireless device transmits a PUCCH providing a positive SR before the wireless device detects the DCI format providing the PDCCH monitoring adaptation field (e.g., before receiving/detecting the first DCI) indicating to the wireless device to skip PDCCH monitoring for the duration (e.g., the time window) on the active DL BWP of the serving cell, the wireless device may monitor PDCCH regardless of PDCCH skipping indication on all serving cells of the corresponding Cell Group when the SR is pending (as described above).

If the wireless device transmits a PUCCH providing a positive SR after the wireless device detects a DCI format (or receives the first DCI) providing the PDCCH monitoring adaptation field indicating to the wireless device to skip PDCCH monitoring for the duration (e.g., the time window) on the active DL BWP of the serving cell, the wireless device may resume PDCCH monitoring (or stop/terminate the PDCCH skipping) starting at the beginning of a first/initial/earliest slot that is after a last/final/ending/latest symbol of the PUCCH transmission in all serving cells of the corresponding Cell Group.

After the wireless device detects a DCI format (e.g., receives the first DCI) providing the PDCCH monitoring adaptation field indicating to the wireless device to skip PDCCH monitoring for the duration (e.g., the time window) on the active DL BWP of a serving cell, when a pending SR is cancelled, the wireless device may resume PDCCH monitoring in all serving cells of the corresponding Cell Group.

If the DRX group of the serving cell is configured (e.g., the one or more configuration parameters comprising the DRX-Config) and the wireless device enters outside Active Time, the wireless device may terminate PDCCH skipping for the serving cell.

In existing technologies, the wireless device may perform an RA procedure. For example, for the (ongoing) RA procedure (e.g., a 2-step RA procedure or a 4-step RA procedure) and during the time duration (e.g., after/from receiving the first DCI), the wireless device may determine whether to skip the PDCCH monitoring or not.

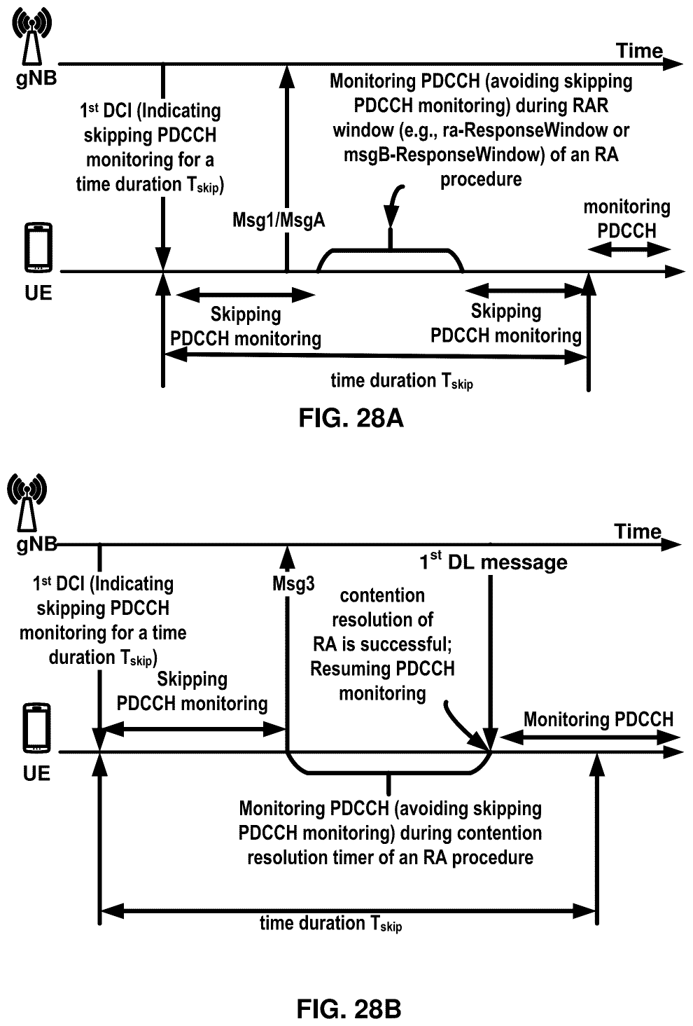

FIG. 28A and FIG. 28B show examples of PDCCH skipping per an aspect of the present disclosure. For example, similar to embodiments of FIG. 27, the wireless device may receive the first DCI from the base station. The first DCI may indicate the PDCCH skipping (e.g., for the time duration Tₛₖᵢₚ).

The wireless device may transmit the first message (e.g, Msg1 or MsgA) to the base station. As shown in FIG. 28A, the wireless device may start the RAR window (ra-ResponseWindow or msgB-ResponseWindow) in response to transmitting the first message. In the example of FIG. 28A, the RAR window of the RA procedure may be during the time duration (e.g., from the receiving the first DCI). As shown in FIG. 28A, while the RAR window is running (e.g., during the time of ra-ResponseWindow of the RA procedure or msgB-ResponseWindow of the RA procedure), e.g., during the time duration (e.g., from the receiving the first DCI), the wireless device may not skip (or avoid skipping of) PDCCH monitoring on SpCell. For example, the wireless device may (in response to receiving the first DCI) skip the PDCCH monitoring during the time duration when the RAR window is not running (e.g., not during the time of ra-ResponseWindow of the RA procedure or msgB-ResponseWindow of the RA procedure). As shown in FIG. 28A, in response to an expiry of the time duration, the wireless device may monitor the PDCCH candidates (e.g., resume the PDCCH monitoring).

In the example of FIG. 28B, the wireless device may transmit the Msg3 of the RA procedure (e.g., scheduled by the RAR, e.g., the fallbackRAR MAC subPDU of the MsgB or the Msg2). The wireless device may start the contention resolution timer based on transmitting the Msg3. As shown in FIG. 28B, a duration where ra-ContentionResolution Timer of the RA procedure is running may be during the time duration for the PDCCH skipping. The wireless device may start the ra-ContentionResolutionTimer in response to transmitting the Msg3. When the contention resolution timer is running (e.g., the duration where ra-ContentionResolutionTimer of the RA procedure is running), the wireless device may not skip (or avoid skipping of) PDCCH monitoring on SpCell.

For example, the wireless device may initiate the RA procedure due to a (positive) SR (e.g., when no valid PUCCH resource configured for the pending SR). If the wireless device transmits a RACH/preamble of the RA procedure (e.g., the first message, e.g., Msg1, or MsgA PRACH) due to/in response to the (positive) SR, the wireless device may not skip PDCCH monitoring on any serving cell (e.g., the serving cell) of the corresponding Cell Group during the time of RAR window (e.g., the ra-ResponseWindow or msgB-ResponseWindow) and/or the duration where ra-ContentionResolution Timer of the RA procedure is running. As shown in FIG. 28B, the wireless device may receive a first DL message from the base station during the contention resolution timer. The first DL message may be a Msg4. The first DL message may comprise a PDCCH (e.g., a DCI) scheduling a PDSCH (e.g., a Msg4 PDSCH). The first DL message may comprise the Msg4 PDSCH. For example, the wireless device may determine the contention resolution being successful based on the first DL message.

For example, the base station may transmit to the wireless device a PDCCH while the contention resolution timer is running. In some examples, the wireless device may, while the contention resolution timer is running, receive the first DL message, e.g., the PDCCH (e.g., addressed to a TC-RNTI of the wireless device).

In existing technologies, as shown in FIG. 28B, in response to determining the contention resolution of the RA procedure being successful (e.g., during the time duration), the wireless device may resume PDCCH monitoring on the SpCell (or terminate the PDCCH skipping). For example, the wireless device may terminate the PDCCH skipping during the time duration in response to determining the contention resolution of the RA procedure being successful. The base station may transmit one or more PDCCHs to the wireless device based on the contention resolution of the RA procedure being successful (e.g., the wireless device terminating the PDCCH skipping or resuming the PDCCH monitoring). When the contention resolution timer being unsuccessful, the wireless device may keep skipping the PDCCH monitoring (e.g., avoid resuming the PDCCH monitoring). The wireless device may not expect the wireless device transmit the one or more PDCCHs during the time duration and when the contention resolution timer is unsuccessful.

The wireless device may, in response to transmitting the Msg3 and/or receiving the PDCCH addressed to the TC-RNTI, determine (or consider) the contention resolution (CR) being successful based on at least one CR condition being satisfied. The wireless device may determine (or consider) the contention resolution not being successful (or being unsuccessful) based on the at least one CR condition not being satisfied.

In a first example, when/if the C-RNTI MAC CE is included in the Msg3, the wireless device may determine the at least one CR condition being satisfied based on at least one of the following: the RA procedure being (initiated or performed) for SpCell beam failure recovery or for beam failure recovery of both BFD-RS sets of SpCell and the PDCCH transmission is addressed to the C-RNTI; and/or the RA procedure being initiated/triggered by the PDCCH order and the PDCCH transmission is addressed to the C-RNTI; and/or the RA procedure being (initiated or performed) by higher layers (e.g., MAC sublayer/layer or by the RRC sublayer/layer) of the wireless device and the PDCCH transmission is addressed to the C-RNTI and contains/indicates an UL grant for a new transmission.

In a second example, e.g., when/if a CCCH SDU is included in the Msg3 of the RA procedure and the PDCCH transmission is addressed to temporary C-RNTI (TEMPORARY_C-RNTI) of the wireless device, the wireless device may determine the at least one CR condition being satisfied based on at least one of the following: a MAC PDU/TB scheduled by the PDCCH being successfully decoded; and/or the MAC PDU containing a UE Contention Resolution Identity MAC CE (e.g., a contention resolution identity of the wireless device); and/or the UE Contention Resolution Identity in the MAC CE matches the CCCH SDU transmitted in Msg3.

In an example, the wireless device may perform a 2-step RA procedure. For example, the wireless device may transmit the MsgA (e.g., comprising the preamble, e.g, MsgA PRACH, and the MsgA payload/PUSCH). The wireless device may start the msgB-ResponseWindow (e.g., the RAR window) to receive the MsgB from the base station. For example, during the time of the RAR window, the wireless device may monitor the PDCCH for receiving the MsgB. The wireless device may receive the MsgB from the base station while the msgB-ResponseWindow is running. Based on the MsgB, the wireless device may determine whether the (2-step) RA procedure being successfully completed or not.

For example, the wireless device may determine the RA procedure being successfully completed based on at least one completion condition being satisfied/fulfilled. In response to the at least one completion condition not being satisfied, the wireless device may determine the RA procedure not being successfully completed.

For example, the wireless device may receive a PDCCH transmission of the SpCell while the msgB-ResponseWindow is running.

The wireless device may (e.g., when/if the C-RNTI MAC CE is included in the MsgA) determine the at least one completion condition being satisfied based on at least one of the following: the (2-step) RA procedure being initiated/performed for SpCell beam failure recovery or for beam failure recovery of both BFD-RS sets of SpCell; and/or the PDCCH transmission is addressed to the C-RNTI.

The wireless device may (e.g., when/if the C-RNTI MAC CE is included in the MsgA) determine the at least one completion condition being satisfied based on at least one of the following: a time alignment timer (e.g., timeAlignmentTimer associated with the PTAG or if CG-SDT procedure is ongoing and cg-SDT-TimeAlignmentTimer) is running; and/or the PDCCH transmission is addressed to the C-RNTI and contains/indicates/comprises an UL grant for a new transmission.

The wireless device may (e.g., when/if the C-RNTI MAC CE is included in the MsgA) determine the at least one completion condition being satisfied based on at least one of the following: a downlink assignment being received on the PDCCH for the C-RNTI and the received TB (e.g., a MAC PDU scheduled by the PDCCH) being successfully decoded; and/or the MAC PDU containing an Absolute Timing Advance Command MAC CE.

For example, while the msgB-ResponseWindow is running, the wireless device may determine a valid downlink assignment (e.g., Msg2/MsgB) being received on the PDCCH for the MSGB-RNTI and the received TB (e.g., of/corresponding to the Msg2/MsgB) being successfully decoded.

The wireless device may (e.g., when/if the valid downlink assignment is received on the PDCCH for the MSGB-RNTI and the received TB is successfully decoded) determine the at least one completion condition being satisfied based on at least one of the following: the MSGB containing/comprising the fallbackRAR MAC subPDU; and/or the Random Access Preamble identifier in the MAC subPDU matching the transmitted PREAMBLE_INDEX (e.g., the preamble index of the transmitted preamble, e.g., of the MsgA); and/or if the preamble (e.g., the Random Access Preamble) not being selected by the MAC entity among the contention-based Random Access Preamble(s).

The wireless device may (e.g., when/if the valid downlink assignment is received on the PDCCH for the MSGB-RNTI and the received TB is successfully decoded) determine the at least one completion condition being satisfied based on at least one of the following: the MSGB containing/comprising the successRAR MAC subPDU; and/or the CCCH SDU being included in the MSGA and the UE Contention Resolution Identity in the MAC subPDU matching the CCCH SDU.

For example, in response to the at least one completion condition being satisfied, the wireless device may perform at least the one of the following: considering the Random Access Response (RAR) reception being successful; and/or stopping the msgB-ResponseWindow.

In response to the contention resolution being successful, the wireless device may perform at least one of the following: stopping the ra-ContentionResolution Timer; and/or setting the C-RNTI to the value of the TEMPORARY_C-RNTI; and/or discarding/deleting a temporary C-RNTI (TEMPORARY_C-RNTI); and/or finishing the disassembly and demultiplexing of the MAC PDU; and/or considering/determining the RA procedure successfully completed; and/or indicating a reception of an acknowledgement for SI request to upper layers (e.g., the RRC layer) of the wireless device when the RA procedure being initiated for SI request.

For example, e.g., when/if the CCCH SDU is included in the Msg3 and the PDCCH transmission is addressed to temporary C-RNTI (TEMPORARY_C-RNTI) of the wireless device, the wireless device may determine the at least one CR condition not being satisfied based on at least one of the following: the MAC PDU scheduled by the PDCCH not being successfully decoded; and/or the MAC PDU being successfully decoded and the MAC PDU not containing the UE Contention Resolution Identity MAC CE; and/or the UE Contention Resolution Identity in the MAC CE does not match the CCCH SDU transmitted in Msg3.

For example, e.g., when/if the Msg3 transmission is transmitted on an NTN, the wireless device may determine the at least one condition not being satisfied based on at least one of the following: the contention resolution timer being expired ra-Contention ResolutionTimer and/or no PDCCH addressed to TC-RNTI indicating uplink grant for a Msg3 retransmission being received after the start of the ra-ContentionResolution Timer.

In response to (or when/once) the contention resolution not being successful (e.g., the at least one CR condition not being satisfied), the wireless device may perform at least one of the following: discarding the TEMPORARY_C-RNTI; and/or discarding the successfully decoded MAC PDU; and/or flushing a HARQ buffer used for transmission of the MAC PDU in the Msg3 buffer; and/or transmitting a second preamble; and/or incrementing one or more counters (e.g., PREAMBLE_TRANSMISSION_COUNTER) by 1.

For example, to transmit the second preamble, the wireless device may determine PREAMBLE_TRANSMISSION_COUNTER being smaller than preambleTransMax+1. Based on PREAMBLE_TRANSMISSION_COUNTER=preambleTransMax+1, the wireless device may indicate a Random Access problem to upper layers (e.g., RRC layer) of the wireless device. When the Random Access procedure is triggered (or initiated) for SI request, the wireless device may consider the Random Access procedure unsuccessfully completed (e.g., the RA procedure is not successfully completed).

For example, to transmit the second preamble, the wireless device may select a random backoff time according to a uniform distribution between 0 and the PREAMBLE_BACKOFF (e.g., indicated by a backoff indicator (BI) MAC subPDU of the RAR). The wireless device may select RA resources (e.g., as discussed above) to transmit the second preamble to the base station. In some examples, the wireless device may select contention-free Random Access Resources during the backoff time and transmit the second preamble using contention-free Random Access Resources.

In some examples, in response to determining the contention resolution not being successful, the wireless device may switch from the 2-step RA procedure to the 4-step RA procedure. For example, the wireless device may transmit the second preamble.

In existing technologies, after the wireless device receives the first DCI (e.g., providing the PDCCH monitoring adaptation field indicating to the wireless device to skip PDCCH monitoring for the time duration on the active DL BWP of the serving cell (e.g., the SpCell) for the time duration), the wireless device may perform the 2-step RA procedure. For example, the wireless device may, during the time duration from the receiving the first DCI, determine the RA procedure not being successfully completed. For example, in response to the at least one completion condition not being satisfied (e.g., the RA procedure not being successfully completed), the wireless device may transmit the Msg3 (e.g., based on the uplink grant indicated by the fallbackRAR MAC subPDU) or a second preamble for the (ongoing) RA procedure.

In one example, the wireless device may start the contention resolution timer based on the transmitting the Msg3. The behavior of the wireless device corresponding to the PDCCH skipping during the time duration from the receiving the first DCI may be based on the FIG. 28B.

In another example, the wireless device may start the RAR window in response to transmitting the second preamble. The behavior of the wireless device corresponding to the PDCCH skipping during the time duration from the receiving the first DCI may be based on the FIG. 28A.

Based on the implementation of the existing technologies, there may be misalignment between the wireless device and the base station after/in response to the RA procedure is successfully completed. For example, based on the RA procedure is successfully completed, the wireless device may not be able to determine whether to skip the PDCCH monitoring or resume PDCCH monitoring during the time duration from the receiving the first DCI. The base station may not know whether or not the wireless device is monitoring the PDCCH during the time duration from the receiving the first DCI and after the RA procedure is successfully completed. For example, the base station may (e.g., after the RA procedure is successfully completed) transmit one or more PDCCHs to the wireless device during the time duration from the receiving the first DCI. The wireless device may fail to receive the one or more PDCCHs (e.g., when the wireless device skips the PDCCH monitoring during the time duration from the receiving the first DCI). The implementation of existing technologies may reduce UL/DL communication efficiency. Improvements of PDCCH skipping may improve the alignment between the wireless device and the base station and/or improve the UL/DL communication efficiency.

Embodiments of the present disclosure are related to an approach for determining whether to resume monitoring control channels (e.g., downlink control channels, e.g., PDCCHs) based on whether an (ongoing) RA procedure being successfully completed or not. In an example embodiment, after receiving the first downlink control information (DCI) indicating to skip control channel monitoring, the wireless device may resume monitoring the control channel (e.g., on the active DL BWP of the serving cell) in response to a random access procedure being successfully completed (e.g., based on the at least one completion condition being satisfied). For example, the wireless device may start, based on the first DCI, skipping monitoring control channel, e.g., on the active DL BWP of the serving cell. The wireless device may terminate skipping monitoring control channel in response to a random access procedure being successfully completed. The random access procedure may be a 2-step RA procedure or a 4-step RA procedure.

In one example, the wireless device may receive from the base station an indication (e.g., the first DCI) to skip control channel monitoring (e.g., PDCCH monitoring). The indication may indicate skipping control channel monitoring on the active DL BWP of the serving cell (e.g., SpCell). The indication may indicate skipping control channel for the time duration (e.g., Tskip). The wireless device may, after/in response to the receiving the indication (or based on the indication), skip monitoring control channels (e.g., skip the PDCCH monitoring), e.g., on the active DL BWP of the serving cell. In an example embodiment, the wireless device may resume monitoring the control channel (e.g., the PDCCH), e.g., on the active DL BWP of the serving cell, in response to/based on (or when) an ongoing RA procedure being successfully completed. For example, the wireless device may determine the ongoing RA procedure being successfully completed based on the at least one completion condition being satisfied.

Example embodiments may reduce the misalignment between the wireless device and the base station. For example, the base station may transmit one or more PDCCHs to the wireless device after the ongoing RA procedure being successfully completed. Example embodiments may improve efficiency UL/DL transmissions (e.g., reduce UL/DL transmission delay). Example embodiments may reduce possibility of missing receiving the one or more PDCCHs by the wireless device.

In another example, the wireless device may receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on an active DL BWP of the serving cell. The wireless device may successfully receive, before an end/expiry of the time duration, a random access response (RAR) of an (ongoing) random access procedure (e.g., based on the at least one RA condition being satisfied). For example, the RAR may be for a preamble not selected by MAC entity of the wireless device among contention-based random access preamble(s), e.g., the preamble is indicated by a PDCCH order and/or the preamble is selected (e.g., by the MAC entity of the wireless device) among contention-free random access preamble(s). In an example embodiment, the wireless device may monitor, before the expiry of the time duration and in response to the successful reception of the RAR, the control channel (e.g., on the active DL BWP of the serving cell) until/for receiving a PDCCH addressed to C-RNTI of the MAC entity.

In an example embodiment, the wireless device may resume, before the expiry of the time duration and in response to the successful reception of the RAR, the control channel (e.g., on the active DL BWP of the serving cell), e.g., for receiving a PDCCH addressed to C-RNTI of the MAC entity. For example, the PDCCH may have a CRC that is scrambled by the C-RNTI of the wireless device (e.g., C-RNTI of the MAC entity). In some implementations, the PDCCH may carry a DCI that scrambled by the C-RNTI (e.g., CRC of the DCI is scrambled by the C-RNTI). The base station may indicate the C-RNTI to the wireless device. For example, the wireless device may terminate the skipping the control channel monitoring before the expiry of the time duration and in response to the successful reception of the RAR.

For example, the wireless device may monitor, in response to successfully receiving the RAR and before the expiry of the time duration, the control channels for receiving the PDCCH addressed to the C-RNTI of the MAC entity. In an example embodiment, the wireless device may resume, before the expiry of the time duration and in response to the receiving the PDCCH addressed to C-RNTI of the MAC entity, the control channel (e.g., on the active DL BWP of the serving cell). For example, the wireless device may terminate the skipping the control channel monitoring before the expiry of the time duration and in response to the receiving the PDCCH addressed to C-RNTI of the MAC entity.

The wireless device may successfully receive, before an end/expiry of the time duration, the random access response (RAR) for the preamble of the RA procedure (e.g., based on the at least one RA condition being satisfied). For example, the wireless device may monitor, in response to successfully receiving the RAR and before the expiry of the time duration, the control channels for receiving the PDCCH addressed to the C-RNTI of the MAC entity. The wireless device may receive the PDCCH addressed to the C-RNTI of the MAC entity. In an example embodiment, the wireless device may skip, until the expiry of the time duration and in response to the receiving the PDCCH addressed to C-RNTI of the MAC entity, the control channel (e.g., on the active DL BWP of the serving cell).

For example, the wireless device may determine, before an end/expiry of the time duration, the random access response (RAR) of an (ongoing) random access procedure not being successfully received (e.g., based on the at least one RA condition not being satisfied). In an example embodiment, the wireless device may skip, until the expiry of the time duration and in response to the unsuccessful reception of the RAR, the control channel (e.g., on the active DL BWP of the serving cell).

Example embodiments may allow the wireless device to determine whether to monitor the control channels after the RAR reception. For example, based on the RAR reception being successful, the wireless device may terminate the skipping of the control channel (e.g., resume the control channel monitoring). In another example, based on the RAR reception being unsuccessful, the wireless device may keep skipping of the control channel (e.g., resume the control channel monitoring). In some examples, the determination of whether to monitor the control channels after the RAR reception may depend on whether the preamble being among the contention-free random access preamble(s) (e.g., indicated by the PDCCH order or not selected by the MAC entity of the wireless device) or among the contention-based random access preamble(s) (e.g., selected by the MAC entity of the wireless device).

Example embodiments may improve efficiency of the RA procedure, as the wireless device monitors the control channel to receive the PDCCH addressed to the C-RNTI despite the first DCI indicating the skipping monitoring the control channel. Some embodiments may allow the wireless device to terminate the skipping of the control channel after receiving the PDCCH addressed to the C-RNTI, allowing the wireless device to be ready for receiving one or more PDCCHs from the base station (e.g., after beam failure recovery and/or SI acquisition). Some embodiments may allow the wireless device to keep skipping of the control channel after receiving the PDCCH addressed to the C-RNTI, allowing the wireless device to reduce the processing power for monitoring the control channels.

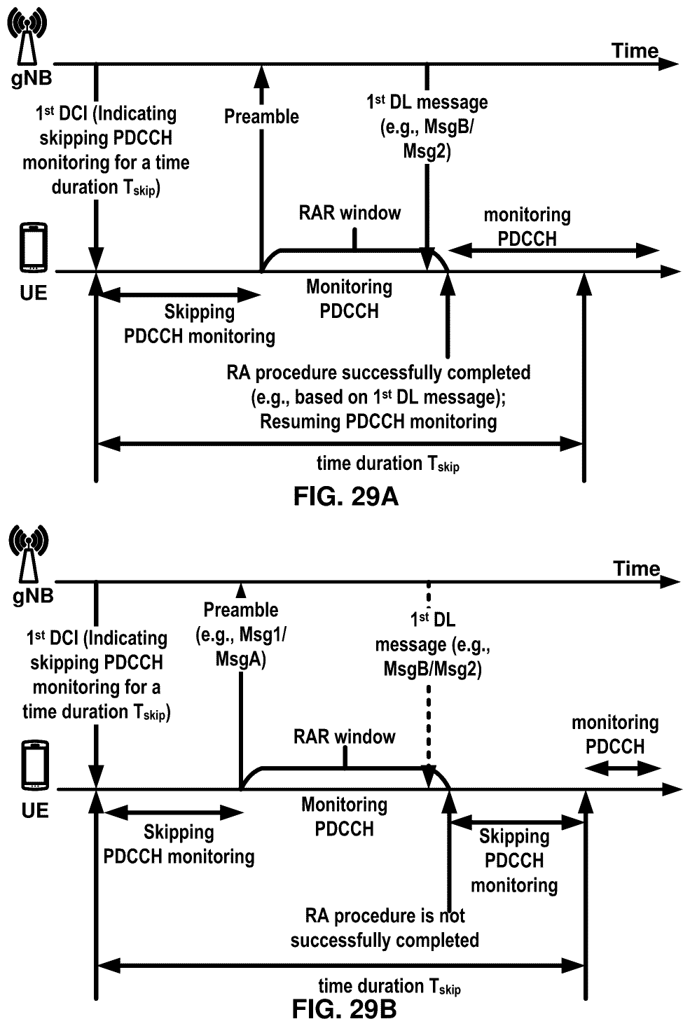

FIG. 29A and FIG. 29B illustrate examples of PDCCH monitoring as per an aspect of an embodiment of the present disclosure. In some scenarios, FIG. 29A and FIG. 29B may show example embodiments of procedures for determining whether to skip the PDCCH monitoring (e.g., whether to skip monitoring the PDCCH) or not. For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state). The PDCCH skipping procedure may be based on embodiments of FIG. 27 and/or FIG. 28A and/or FIG. 28B described above.

The one or more configuration parameters (e.g., the one or more RRC configuration parameters) may comprise one or more BWP configuration parameters (see FIG. 21), e.g., of a downlink (DL) BWP (e.g., initial downlink BWP) of a serving cell and/or of an UL BWP of the serving cell, according to some embodiments. The one or more configuration parameters may comprise: the one or more PDCCH configuration parameters (e.g., for PDCCH of the downlink BWP, e.g., in pdcch-Config IE and/or PDCCH-ServingCellConfig IE applicable for all downlink BWPs of the serving cell)

As shown in FIG. 29A and FIG. 29B, the wireless device may receive (e.g., from the base station on a DL (active) BWP of the serving cell) the first DCI. For example, a reception time/occasion/symbol/slot of the first DCI may correspond to a last/final/ending/latest symbol of a reception time/occasion/resource of a PDCCH providing/indicating the first DCI. The first DCI may indicate skipping PDCCH (e.g., skipping/stopping/avoiding monitoring PDCCH or skipping/stopping/avoiding monitoring control channels, and/or skipping/stopping/avoiding monitoring PDCCH candidates), e.g., within/during/for the time window/duration (e.g., Tₛₖᵢₚ slots/symbols/milliseconds), e.g., on the DL BWP of the serving cell. In some examples, a time value for (or a length of) the time window may be indicated by the first DCI. For example, the first DCI may comprise a first filed with a plurality of bits (e.g., with a bit-width of 0, 1, or 2 bits). The first field may be the PDCCH skipping indication field (e.g., a ‘PDCCH monitoring adaptation indication’ field). A codepoint of the first field of the first DCI may indicate a number of slots for the wireless device to skip monitoring the PDCCH (e.g., the length of the time duration/window). The wireless device may determine the time window (or the time value) from the ‘PDCCH monitoring adaptation indication’ field of the first DCI based on the one or more configuration parameters (e.g., PDCCHSkippingDurationList). For example, the serving cell may be the SpCell.

As shown in FIG. 29A and/or FIG. 29B, the wireless device may start skipping of the PDCCH monitoring (e.g., skipping the PDCCH monitoring) based on (or in response to) receiving the first DCI (e.g., as discussed in connection with FIG. 27 and/or FIG. 28A and/or FIG. 28B). The wireless device may expect to skip the monitoring the PDCCH for the time duration from the receiving the first DCI (e.g., until an expiry of the time duration).

For example, after (or before) receiving the first DCI, the wireless device may initiate an RA procedure and transmit the first message. The RA procedure may be the 2-step RA procedure. For example, the wireless device may transmit the MsgA (e.g., the first message). The wireless device may transmit the first message (e.g., the preamble of MsgA) to the base station, e.g., during the time duration from receiving the first DCI.

The RA procedure may be the 4-step RA procedure. The wireless device may transmit the first message (e.g., the Msg1, e.g., preamble) to the base station, e.g., during the time duration from receiving the first DCI.

As shown in FIG. 29A, the wireless device may start the RAR window (the msgB-ResponseWindow or the ra-ResponseWindow) in response to transmitting the MsgA. The wireless device may monitor the PDCCH the serving cell (e.g., the SpCell) for RAR(s) identified by the RA-RNTI while the ra-ResponseWindow is running.

In some examples, the wireless device may start the RAR window (e.g., ra-ResponseWindow configured in BeamFailureRecoveryConfig) at a PDCCH occasion. For example, the wireless device may monitor for a PDCCH transmission on the search space indicated by recoverySearchSpaceId of the serving cell (e.g., the SpCell) identified by the C-RNTI while ra-ResponseWindow is running.

In the example of FIG. 29A, the RAR window of the RA procedure is during the time duration from receiving the first DCI. As discussed in FIG. 28A, while the RAR window is running (e.g., during the time of the msgB-ResponseWindow/ra-ResponseWindow), the wireless device may not skip PDCCH monitoring on the (active) DL BWP of the serving cell.

As shown in FIG. 29A, the wireless device may, while the RAR window is running, determine the RA procedure being successfully completed (e.g., based on the first DL message). For example, the wireless device may determine the RA procedure being successfully completed based on the at least one completion condition being satisfied. The wireless device may determine the RA procedure not being successfully completed based on the at least one completion condition not being satisfied.

The wireless device may, during the RAR window, receive the first DL message (e.g., the Msg2/MsgB). The first DL message may comprise the RAR. For example, receiving the first DL message may comprise receiving a valid downlink assignment (e.g., corresponding to the Msg2/MsgB) on a PDCCH for the RA-RNTI. For example, the wireless device may successfully decode a received TB (e.g., corresponding to the Msg2/MsgB, e.g., comprising the RAR). For example, the DL message may comprise the TB. In one example, the wireless device may (e.g., when/if the valid downlink assignment is received on the PDCCH for the RA-RNTI and the received TB is successfully decoded) determine the at least one completion condition being satisfied based on the at least one of the following: the RAR indicating the preamble index (e.g., the RAR containing/comprising a MAC subPDU with Random Access Preamble identifier corresponding to the transmitted PREAMBLE_INDEX); and/or the RAR comprising/including a MAC subPDU with RAPID only.

In another example, the wireless device may (e.g., when/if the valid downlink assignment is received on the PDCCH for the RA-RNTI and the received TB is successfully decoded) determine the at least one completion condition being satisfied based on the at least one of the following: the RAR indicating the preamble index (e.g., the RAR containing/comprising a MAC subPDU with Random Access Preamble identifier corresponding to the transmitted PREAMBLE_INDEX); and/or the preamble not being selected by the MAC entity of the wireless device among the contention-based Random Access Preamble(s) (e.g., the preamble being selected among the contention-free Random Access Preamble(s).

The wireless device may receive the RAR (e.g., the MsgB/Msg2 in response to the first message) from the base station while the RAR window is running. As described above (e.g., based on the MsgB/Msg2), the wireless device may determine the at least one completion condition being satisfied.

In an example embodiment, in response to (or based on or when or after or once) (determining) the RA procedure being successfully completed, the wireless device may resume the PDCCH monitoring. For example, the wireless device may determine the RA procedure being successfully completed during/with in the time duration from the receiving the first DCI (e.g., the time duration not being expired or before an end of the time duration). As shown in FIG. 29A, despite the first DCI indicating the skipping the PDCCH monitoring, based on the RA procedure being successfully completed, the wireless device may terminate/stop the PDCCH monitoring (e.g., before an end of the time duration). The wireless device may stop the RAR window based on the RA procedure being successfully completed.

In some examples, the wireless device may transmit to the base station a first PUCCH based on the RA procedure being successfully completed (e.g., or a RAR reception being successful). The first PUCCH may carry (or be with) a first HARQ-ACK information bit (e.g., with a positive acknowledgement), e.g., based on successfully decoding the TB (e.g., the MsgB/Msg4). The wireless device may resume PDCCH monitoring starting at the beginning/starting (or a first/initial/earliest symbol) of a first/initial/starting/earlies slot that is after a last/final/ending/latest symbol of the first PUCCH transmission/occasion. When the wireless device transmits the first PUCCH (e.g. providing/carrying the first HARQ-ACK information bit) after the wireless device receives the first DCI (e.g., comprising the ‘PDCCH monitoring adaptation indication’ field for skipping PDCCH monitoring for the time duration), resuming the PDCCH monitoring may be at the beginning/starting (or a first/initial/earliest symbol) of the first/initial/starting/earlies slot that is after the last/final/ending/latest symbol of the PUCCH transmission/occasion.

As shown in FIG. 29B, the wireless device may, during/while the msgB-ResponseWindow is running, determine the RA procedure not being successfully completed (e.g., based on the at least one completion condition not being satisfied). For example, the wireless device may not receive the MsgB (in response to the transmitting the MsgA) from the base station while the RAR window is running.

The wireless device may determine the at least one completion condition not being satisfied based on at least one of the following: the RAR reception not being successful; and/or the contention resolution not being successfully completed (e.g., the at least one CR condition not being satisfied); and/or a preamble transmission counter (e.g., PREAMBLE_TRANSMISSION_COUNTER) corresponding to the preamble being larger than a threshold (e.g., preambleTransMax+1).

For example, in response to an expiry of the msgB-ResponseWindow and not receiving the MsgB (e.g., the first DL message), the wireless device may determine the at least one completion condition not being satisfied.

For example, the wireless device may receive a PDCCH transmission of the SpCell while the RAR window (e.g., the msgB-ResponseWindow) is running. for example, the receiving the first DL message may comprise the receiving the PDCCH transmission of the SpCell.

The wireless device may (e.g., when/if the C-RNTI MAC CE is included in the MsgA) determine the at least one completion condition not being satisfied based on at least one of the following: the (2-step) RA procedure being initiated/performed for SpCell beam failure recovery or for beam failure recovery of both BFD-RS sets of SpCell; and/or the PDCCH transmission not being addressed to the C-RNTI.

The wireless device may (e.g., when/if the C-RNTI MAC CE is included in the MsgA) determine the at least one completion condition not being satisfied based on at least one of the following: a time alignment timer (e.g., timeAlignmentTimer associated with the PTAG or if CG-SDT procedure is ongoing and cg-SDT-TimeAlignmentTimer) being running; and/or the PDCCH transmission is addressed to the C-RNTI and not comprising an UL grant for a new transmission.

The wireless device may (e.g., when/if the C-RNTI MAC CE is included in the MsgA) determine the at least one completion condition not being satisfied based on at least one of the following: a downlink assignment being received on the PDCCH for the C-RNTI and the received TB (e.g., a MAC PDU scheduled by the PDCCH) not being successfully decoded; and/or the MAC PDU not containing an Absolute Timing Advance Command MAC CE.

For example, while the RAR window (e.g., the msgB-ResponseWindow) is running, the wireless device may (e.g., to receive the first DL message) determine a valid downlink assignment (e.g., Msg2/MsgB) being received on the PDCCH for the MSGB-RNTI and the received TB (e.g., of/corresponding to the Msg2/MsgB) being successfully decoded.

The wireless device may (e.g., when/if the valid downlink assignment is received on the PDCCH for the MSGB-RNTI and the received TB is successfully decoded) determine the at least one completion condition not being satisfied based on at least one of the following: the MSGB containing/comprising the fallbackRAR MAC subPDU; and/or the Random Access Preamble identifier in the MAC subPDU matching the transmitted PREAMBLE_INDEX (e.g., the preamble index of the transmitted preamble, e.g., of the MsgA); and/or if the preamble (e.g., the Random Access Preamble) being selected by the MAC entity among the contention-based Random Access Preamble(s).

The wireless device may (e.g., when/if the valid downlink assignment is received on the PDCCH for the MSGB-RNTI and the received TB is successfully decoded) determine the at least one completion condition not being satisfied based on at least one of the following: the MSGB not containing/comprising the successRAR MAC subPDU; and/or the CCCH SDU being included in the MSGA and the UE Contention Resolution Identity in the MAC subPDU not matching the CCCH SDU.

In an example embodiment, in response to (or based on or when or after or once) (determining) the RA procedure not being successfully completed, the wireless device may refrain/avoid resuming the PDCCH monitoring. For example, the wireless device may determine the RA procedure not being successfully completed during/within the time duration from the receiving the first DCI (e.g., before the end of time duration). As shown in FIG. 29B, based on the first DCI indicating the skipping the PDCCH monitoring and/or the RA procedure not being successfully completed, the wireless device may skip the PDCCH monitoring after/once/when the RA procedure not being successfully completed (and/or until the expiry of the time duration).

In some examples, the wireless device may transmit to the base station a second PUCCH based on the RA procedure not being successfully completed (e.g., or the RAR reception not being successful). The second PUCCH may carry (or be with) a second HARQ-ACK information bit (e.g., with a negative acknowledgement). The wireless device may skip PDCCH monitoring (or avoid resuming the PDCCH monitoring) starting at the beginning/starting (or a first/initial/earliest symbol) of a first/initial/starting/earlies slot that is after a last/final/ending/latest symbol of the second PUCCH transmission/occasion.

In some other examples, the wireless device may transmit to the base station a second preamble (or a second MsgA) of the RA procedure based on the RA procedure not being successfully completed (e.g., or the RAR reception not being successful). The wireless device may skip PDCCH monitoring (or avoid resuming the PDCCH monitoring) starting at the beginning/starting (or a first/initial/earliest symbol) of a first/initial/starting/earlies slot that is after a last/final/ending/latest symbol of the second preamble transmission/occasion.

FIG. 30 illustrates an example of PDCCH monitoring as per an aspect of an embodiment of the present disclosure. In some scenarios, FIG. 30 may show an example embodiments of procedures for determining whether to skip the PDCCH monitoring (e.g., whether to skip monitoring the PDCCH) or not. For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state). The PDCCH skipping procedure may be based on embodiments of FIG. 27 and/or FIG. 28A and/or FIG. 28B described above.

As shown in FIG. 30, the wireless device may initiate an RA procedure (e.g., a 2-step RA procedure or a 4-step RA procedure). In one example, the wireless device may initiate the RA procedure in response to receiving a PDCCH order (e.g., receiving a second DCI indicating a preamble index). The wireless device may receive the PDCCH order (e.g., the second DCI) at time/occasion/slot T1. For example, the wireless device may receive the first DCI indicating the PDCCH skipping for the time duration at time/occasion/slot T2, e.g., after receiving the second DCI. For example, the second DCI may be different than the first DCI. In other examples, the second DCI may be the first DCI. In the example of FIG. 30, the wireless device may transmit a preamble (with the preamble index) ordered/triggered by the second DCI after the receiving the first DCI.

Although in FIG. 30, the first DCI is received after the second DCI, in some other examples, the wireless device may receive the second DCI after receiving the first DCI. In some other cases (not shown in FIG. 30), the wireless device may receive the first DCI after transmitting the preamble.

As shown in FIG. 30, the wireless device may start skipping of the PDCCH monitoring (e.g., skipping the PDCCH monitoring) based on receiving the first DCI.

As the second DCI (e.g., the PDCCH order) indicates the preamble (e.g., the preamble index), the MAC layer of the wireless device may not select the preamble. For example, the (indicated) preamble may not belong to contention-based Random Access Preamble(s), e.g., the preamble may belong to contention-free Random Access Preamble(s).

For example, the wireless device may select the preamble from/among the contention-free Random Access Preamble(s). The wireless device may, based on the second DCI indicating the preamble index, determine/select the preamble with the preamble index (e.g., PREAMBLE_INDEX) from the contention-free Random Access Preamble(s).

The wireless device may transmit the preamble at time/occasion/slot T3 in FIG. 30, e.g., during the time duration from the receiving the first DCI (e.g., before the end of the time duration). For example, the wireless device may start the RAR window (during the time duration from the receiving the first DCI) in response to transmitting the preamble (e.g., the first message).

As shown in FIG. 30, at time/occasion/slot T4 the wireless device may receive the first DL message from the base station while/during the RAR window is running. The first DL message (e.g., the Msg2/MsgB) may comprise the RAR (e.g., the Msg2/MsgB comprising the RAR). For example, the wireless device may determine the RAR reception being successful. In some implementations, the wireless device may determine the RAR reception being successful based on at least one RAR condition being satisfied. The wireless device may determine the RAR reception not being successful (or being unsuccessful) based on at least one RAR condition not being satisfied.

For example, the wireless device may determine the at least one RAR condition being satisfied based on the at least one completion condition being satisfied. The wireless device may determine the at least one RAR condition not being satisfied based on the at least one completion condition not being satisfied.

In one example, the wireless device may determine the at least one RAR condition being satisfied based on at least one of the following: a notification of a reception of a PDCCH transmission on the search space indicated by recoverySearchSpaceId being received (e.g., while the RAR window is running), e.g., from the lower layers (e.g., PHY layer) of the wireless device (e.g., on the serving cell used for transmission of the preamble); and/or the PDCCH transmission being addressed to the C-RNTI; and/or the preamble being among/from the contention-free Random Access Preamble(s) (e.g., for beam failure recovery request), e.g., by the MAC entity of the wireless device.

For example, while the RAR window (e.g., ra-ResponseWindow) is running, the wireless device may determine a valid downlink assignment (e.g., Msg2/MsgB) being received on the PDCCH for the RA-RNTI and the received TB (e.g., Msg2/MsgB) being successfully decoded. For example, the TB may comprise the RAR.

The wireless device may (e.g., when/if the valid downlink assignment is received on the PDCCH for the RA-RNTI and the received TB is successfully decoded) determine the at least one RAR condition being satisfied based on the RAR indicating the preamble index (e.g., the RAR containing/comprising a MAC subPDU with Random Access Preamble identifier corresponding to the transmitted PREAMBLE_INDEX).

For example, the wireless device may, in response to determining the RAR reception being successful, stop the RAR window, e.g., at time/slot/occasion T4 in FIG. 30.

In an example embodiment, in response to the at least one RAR condition being satisfied (or determining the RAR reception being successful) and during the time duration from receiving the first DCI (e.g., the RAR reception being successful before the end of the time duration), the wireless device may avoid skipping the PDCCH monitoring. As shown in FIG. 30, the wireless device may, during the time duration and after stopping the RAR window, monitor the PDCCH (candidates) until/for receiving a third PDCCH (e.g., between the time/occasion T4 and the time/occasion T5). For example, the wireless device may, from the base station, receive the third PDCCH at time/occasion T5. The third PDCCH may indicate a new transmission addressed to the C-RNTI of the wireless device.

In an example embodiment, in response to/after receiving the third PDCCH from the base station before the expiry of the time duration (e.g., the end of the time duration), the wireless device may skip the PDCCH monitoring (e.g., for duration between time/occasion T5 to time/occasion T6 in FIG. 30).

In an example embodiment, in response to/after receiving the third PDCCH from the base station before the expiry of the time duration (e.g., the end of the time duration), the wireless device may resume the PDCCH monitoring (e.g., terminate the PDCCH skipping), e.g., for duration between time/occasion T5 to time/occasion T6 in FIG. 30.

In an example embodiment, in response to the at least one RAR condition being satisfied (or determining the RAR reception being successful) and during the time duration from receiving the first DCI (e.g., the RAR reception being successful before the end of the time duration), the wireless device may resume the PDCCH monitoring (e.g., terminate the PDCCH skipping).

The wireless device may determine the at least one RAR condition not being satisfied based on the RAR window (e.g., the ra-ResponseWindow configured in BeamFailureRecoveryConfig) being expired and/or a PDCCH transmission on the search space indicated by recoverySearchSpaceId addressed to the C-RNTI not being received (e.g., on the serving cell where the preamble is transmitted).

The wireless device may determine the at least one RAR condition not being satisfied based on the RAR window (e.g., the ra-ResponseWindow configured in RACH-ConfigCommon) being expires and/or the RAR comprising/containing Random Access Preamble identifiers that matches the transmitted preamble with the preamble index (e.g., PREAMBLE_INDEX) not being received.

In an example embodiment, in response to the RAR condition not being satisfied and during the time duration, the wireless device may skip the PDCCH monitoring.

Example embodiment may provide enhancement for PDCCH monitoring after/during the RA procedure. For example, example embodiment may enhance alignment between the wireless device and the base station (regarding whether the wireless device is skipping the PDCCH monitoring or not).

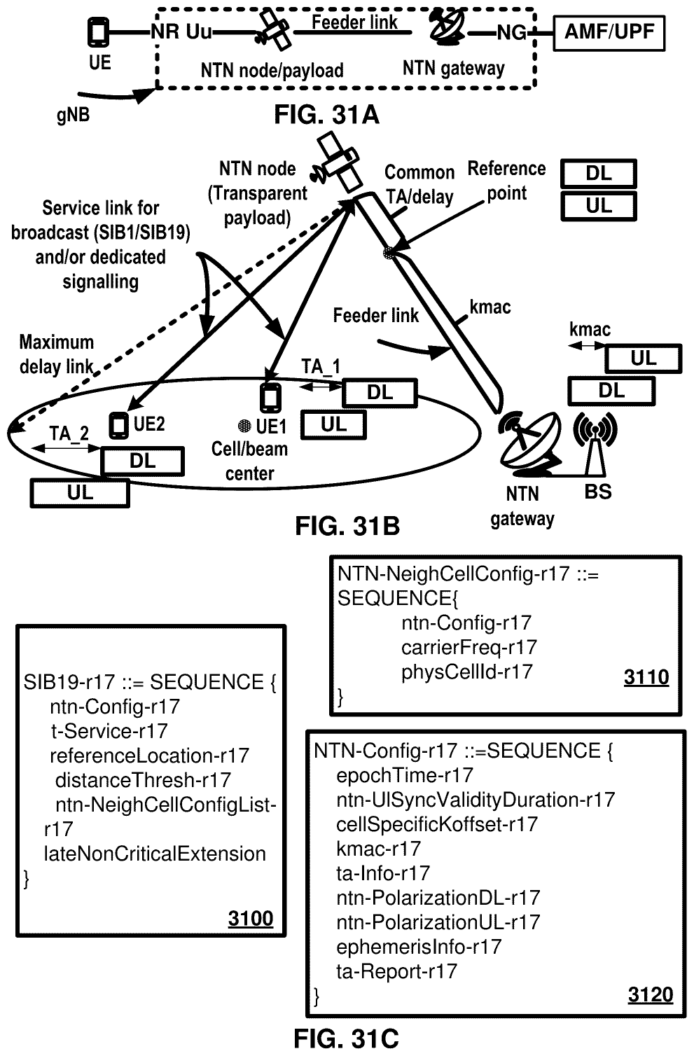

FIG. 31A shows an example of a non-terrestrial network (NTN). FIG. 31B shows an example of an NTN with a transparent payload. FIG. 31C shows an example of assistance information for maintenance of UL synchronization at a wireless device in an NTN.

The non-terrestrial network (NTN) network (e.g., a satellite network) may be a network or network segment (e.g., an NG-RAN consisting of gNBs) for providing non-terrestrial NR access to wireless devices. The NTN may use a space-borne vehicle to embark a transmission equipment relay node (e.g., radio remote unit or a transparent payload) or a base station (or a regenerative payload). While a terrestrial network is a network located on the surface of the earth, an NTN may be a network which uses an NTN node (e.g., a satellite) as an access network, a backhaul interface network, or both. In an example, an NTN may comprise one or more NTN nodes (or payloads and/or space-borne vehicles), each of which may provide connectivity functions, between the service link and the feeder link. As shown in FIG. 31B, a base station may, via the service link, transmit broadcast signals (e.g., SIBx, x=1, 2, . . . , 19, . . . ), multicast signals, and/or dedicated signals to wireless devices, e.g., in a cell.

An NTN node may embark a bent pipe payload (e.g., a transparent payload) or a regenerative payload. The NTN node with the transparent payload may comprise transmitter/receiver circuitries without the capability of on-board digital signal processing (e.g., modulation and/or coding) and connect to a base station (e.g., a base station of an NTN or the NTN base station or a non-terrestrial access point) via a feeder link. In some respects, as shown in FIG. 31A, the base station (e.g., a gNB/eNB) may further comprise the transparent NTN node, the feeder link, and/or a gateway (e.g., an NTN gateway). The gateway may be an earth station that is located at the surface of the earth, providing connectivity to the NTN payload using a feeder link. In some examples, the NTN node with the regenerative payload (e.g., the base station of the NTN or the NTN base station) may comprise functionalities of a base station, e.g., the on-board processing used to demodulate and decode the received signal and/or regenerate the signal before sending/transmitting it back to the earth. In some respects, as shown in FIG. 31A, the base station (e.g., the gNB) may further comprise the regenerative NTN node, the feeder link, and/or the gateway (e.g., the NTN gateway).

In some examples, the NTN node may be a satellite, a balloon, an air ship, an airplane, an unmanned aircraft system (UAS), an unmanned aerial vehicle (UAV), a drone, or the like. For example, the UAS may be a blimp, a high-altitude platform station (HAPS), e.g., an airborne vehicle embarking the NTN payload placed at an altitude between 8 and 50 km, or a pseudo satellite station. In an example, a satellite may be placed into a low-earth orbit (LEO) at an altitude between 250 km to 1500 km, with orbital periods ranging from 90-130 minutes. From the perspective of a given point on the surface of the earth, the position of the LEO satellite may change. In an example, a satellite may be placed into a medium-earth orbit (MEO) at an altitude between 5000 to 20000 km, with orbital periods ranging from 2 hours to 14 hours. In an example, a satellite may be placed into a geostationary satellite earth orbit (GEO) at 35,786 km altitude, and directly above the equator. From the perspective of a given point on the surface of the earth, the position of the GEO satellite may not change.

FIG. 31B shows an example of an NTN with a transparent NTN platform. As shown in FIG. 31B, the NTN node (e.g., the satellite) may forward a received signal from the NTN gateway on the ground back to the earth over the feeder link. In an example, the gateway and the base station may not be collocated. The NTN node may forward a received signal to the wireless device or the base station from another NTN node, e.g., over inter-link satellite communication links.

The NTN node may generate one or more beams over a given area (e.g., a coverage area or a cell). The footprint of a beam (or the cell) may be referred to as a spotbeam. For example, the footprint of a cell/beam may move over the Earth's surface with the satellite movement (e.g., a LEO with moving cells or a HAPS with moving cells). The footprint of a cell/beam may be Earth fixed (e.g., quasi-earth-fixed) with some beam pointing mechanism used by the satellite to compensate for its motion (e.g., a LEO with earth fixed cells). The size of a spotbeam (e.g., diameter of the spotbeam and/or cell and/or coverage area) may range from tens of kilometers (e.g., 50 km-200 km) to a few thousand kilometers (e.g., 3500 km). For example, the size of the spotbeam may depend on the system design.

A propagation delay may be an amount of time it takes for the head of the signal to travel from a sender (e.g., the base station or the NTN node) to a receiver (e.g., the wireless device) or vice versa. The propagation delay may vary depending on a change in distance between the sender and the receiver, e.g., due to movement of the NTN node, movement of the wireless device, a change of an inter-satellite link, and/or feeder link switching. One-way latency/delay may be an amount of time required to propagate through a telecommunication system from the sender (e.g., the base station) to the receiver (e.g., the wireless device). For the transparent NTN, the round-trip propagation delay (RTD or UE-gNB RTT) may comprise service link delay (e.g., between the NTN node and the wireless device), feeder link delay (e.g., between the NTN gateway and the NTN node), and/or between the gateway and the base station (e.g., in the case the gateway and the NTN base station are not collocated). For example, the UE-gNB RTT (or the RTD) may be twice of the one-way delay between the wireless device and the base station. In case of a GEO satellite with the transparent payload, the RTD may be approximately 556 milliseconds. A (maximum) RTD of a LEO satellite with the transparent payload and altitude of 600 km is approximately 25.77 milliseconds and with altitude of 1200 km is approximately 41.77 milliseconds. In an example, the RTD of a terrestrial network (e.g., NR, E-UTRA, LTE) may be negligible compared to the RTD of an NTN scenario (e.g., the RTD of a terrestrial network may be less than 1 millisecond).

A differential delay within a beam/cell of a NTN node may depend on, for example, the maximum diameter of the beam/cell footprint at nadir. For example, the differential delay withing the beam/cell may correspond to a maximum delay link in FIG. 31B. In an example, the differential delay may imply the maximum difference between communication latency that two wireless devices, e.g., a first wireless device (UE1) that is located close to the center of the cell/beam and a second wireless device (UE2) that is located close to the edge of the cell/beam in FIG. 31B, may experience while communicating with the base station via the NTN node. The first wireless device may experience a smaller RTD compared to the second wireless device. The link with a maximum propagation delay (e.g., the maximum delay link) may experience the highest propagation delay (or the maximum RTD) in the cell/beam. In an example, the differential delay may imply a difference between the maximum delay of the cell/beam and a minimum delay of the cell/beam. In an example, the service link to a cell/beam center may experience the minimum propagation delay in the cell/beam. Depending on implementation, for a LEO satellite, the differential delay may be at least 3.12 milliseconds and may increase up to 8 milliseconds. In an example of a GEO satellite, depending on implementation, the differential delay may be as large as 32 milliseconds.

FIG. 31C shows as example of NTN assistance information. For example, the base station may transmit to the wireless device the NTN assistance information via an NTN-specific SIB (e.g., SIB19) 3100. The NTN assistance information may comprise a first set of NTN configuration parameters. For example, the first set of NTN configuration parameters may comprise at least one NTN-config (e.g., ntn-config-r17 2820). The at least one NTN-config may correspond to the serving cell of the NTN and/or a non-serving cell of the NTN (e.g., a target cell or a neighbor cell). Each NTN-config (e.g., ntn-Config 3120) of the at least one NTN-config may correspond to a cell (e.g., the serving cell or a neighbor cell of the NTN) with a corresponding physical cell ID (PCI).

As shown in FIG. 31C, the first set of NTN configuration parameters may comprise NTN-configs of one or more NTN neighbor cells (e.g., via ntn-NeighCellConfigList IE) 3110. Each NTN neighbor cell of the one or more NTN neighbor cells may have its unique PCI. For example, the at least one NTN-config may comprise the one or more NTN neighbor cells.

FIG. 32A shows an example embodiment of common configuration parameters of a serving cell. For example, the serving cell may belong to the NTN. The wireless device may communicate with the base station via the serving cell (of the NTN). The Serving cell may be the first cell (with/identified by, a first PCI) and/or the second cell (with/identified by a second PCI). In the example of FIG. 32A, the one or more configuration parameters may comprise common configuration parameters of the serving cell (e.g., IE ServingCellConfigCommon) 3200. In one example, the base station may transmit to the wireless device the common configuration parameters of the serving cell via a system broadcast information (e.g., SIB1). For example, the base station may transmit the common configuration parameters of the serving cell via one or more RRC messages (e.g., RRC setup message, RRC establishment message, RRC re-establishment message, and/or RRC reconfiguration message). For example, the base station may transmit the common configuration parameters of the serving cell during the initial access procedure and/or the handover procedure. In the example shown in FIG. 32A, the common configuration parameters of the serving cell may comprise an NTN-config (e.g., ntn-Config-r17, e.g., corresponding to the serving cell with the first PCI) of the at least one NTN-config.

In one example, the first set of NTN configuration parameters may comprise the NTN-config of the common configuration parameters of the serving cell (e.g., a first NTN configuration parameters). The first NTN configuration parameters (e.g., a first NTN-config of the at least one NTN-config) may correspond to the first PCI or the first cell (e.g., the source cell). When the common configuration parameters of the serving cell correspond to the RRC setup message (and/or the RRC establishment message and/or RRC re-establishment message), the NTN-config of the common configuration parameters of the serving cell may correspond to the source cell.

When the common configuration parameters of the serving cell correspond to the RRC reconfiguration message, the NTN-config of the common configuration parameters of the serving cell may correspond to the target cell (e.g., a second NTN configuration parameters e.g., a second NTN-config, of the at least one NTN-config). The second NTN configuration parameters (e.g., the second NTN-config of the at least one NTN-config) may correspond to the second PCI or the second cell (e.g., the target cell).

In an example, the at least one NTN-config may comprise the first NTN-config and/or the second NTN-config. In an example, the NTN assistance information may comprise the first NTN-config and/or the second NTN-config.

As shown in FIG. 31C, each/an NTN-config of the at least one NTN-config (e.g., NTN-config-r17 3120) may comprise at least one of the following (or a combination of thereof): corresponding ephemeris parameters (or data/information) of an NTN node (e.g., the satellite ephemeris data, e.g., ephemerisInfo); and/or one or more common delay/TA parameters (e.g., ta-Info), e.g., comprising at least one of TACommon, TACommonDrift, TACommonDriftVariation; and/or a cell-specific scheduling offset (e.g., cellSpecifickoffset or Koffset, e.g., K_{cell,offset}) in number of slots for a given subcarrier spacing (e.g., μ_{Koffset}), e.g., 15 KHz; and/or MAC-layer scheduling offset (e.g., kmac or K-Mac) in number of slots for a given subcarrier spacing (e.g., μ_{Kmac}), e.g., 15 KHz, indicating a portion of a feeder link delay that the base station may pre-compensate, e.g., when UL/DL configurations are not aligned at the base station (see, FIG. 31B); and/or epoch time for applying the NTN-config (e.g., epochTime); and/or a validity duration of the NTN-config (e.g., ntn-UISyncValidityDuration) indicating a maximum duration (e.g., in seconds) that the NTN-config stays valid (e.g., a maximum duration that the wireless device stays UL synchronized with the serving cell without (re-)acquiring/reading the SIB19 of the serving cell); and/or one or more antenna polarization mode(s) (e.g., vertical horizontal, right-hand circular, or left-hand circular) for UL/DL communications (e.g., ntn-PolarizationUL/ntn-Polarization DL); and/or a first indication/parameter (e.g., ta-Report-r17). For example, the MAC-layer scheduling offset may be 0, e.g., when the K-Mac is absent from (is not indicated/configured by) the NTN config of the serving cell. For example, in an NTN scenario with the transparent NTN node, when the UL frame and the DL frame are aligned at the base station, the K-Mac may be absent from the NTN-config of the serving cell.

To maintain uplink orthogonality in the serving cell, transmissions from different wireless devices in a cell/beam (e.g., the first wireless device and the second wireless device in FIG. 31B) may need to be time-aligned at the base station and/or the NTN node (e.g., satellite). The cell may be the serving cell. In an example, time alignment/synchronization may be achieved by using different timing advance (TA) values at different wireless devices to compensate for their different propagation delays (or RTDs). As shown in FIG. 31B, for UL transmissions, the first wireless device may use the first TA value (e.g., TA_1) and the second wireless device may use the second TA value (TA_2).

For example, the wireless device (e.g., the first wireless device or the second wireless device) may estimate/determine/measure a (current or a latest) TA value based on the at least one NTN-config. In one case, during communication via the first cell, the wireless device may estimate/determine/measure a (current or a latest) TA value based on the first NTN-config. In other case, during communication via the first cell, the wireless device may estimate/determine/measure a (current or a latest) TA value based on the second NTN-config.

For example, the wireless device may calculate/measure/maintain the current (or latest available) TA (value) of the wireless device TTA (e.g., corresponding to a TAG ID or a primary TAG or a secondary TAG) based on at least a combination of a closed-loop TA value (or a closed-loop TA procedure/control) and/or an open-loop TA value (or an open-loop TA procedure/control). In an example, a combination of the closed-loop TA control and the open-loop TA control may be based on adding/summing the open-loop TA value (e.g., derived/calculated based on the open-loop TA procedure/control) and the closed-loop TA value (or a portion of the closed-loop TA procedure/control). The current TA value of the first wireless device may be TA_1 and the current TA value of the second wireless device may be TA_2. The closed-loop TA procedure/control may be based on receiving at least one (absolute) TA command (TAC) MAC CE indicating a TA value (e.g., T_{A} corresponding to the TAG ID, e.g., the primary TAG or the secondary TAG) from the base station (e.g., via Msg2 1312 and/or MsgB 1332 and/or a PDSCH). The TA value may indicate an adjustment of the closed-loop TA value (e.g., N_{TA}).

For example, a timing advance command (e.g., the TAC MAC CE) of the at least one TA command may be a TA command of a random access response. The TA command may be an absolute timing advance command MAC CE. The TA command may indicate a value T_{A} for a TAG T_{A}=0, 1, 2, . . . , 3846. The wireless device may determine an amount of the time alignment for the TAG with SCS of 2^{μ}. 15 kHz based on N_{TA}=T_{A}·16·64/2^{μ}. N_{TA} may be relative to the SCS of the first uplink transmission from the wireless device after the reception of the random access response or the absolute timing advance command MAC CE.

In another example, a timing advance command (e.g., the TAC MAC CE), T_{A}, for a TAG indicates adjustment of a current N_{TA} value, N_{TA_old}, to the new N_{TA} value, N_{TA_new}, by index values of T_{A}=0, 1, 2, . . . , 63, where for a SCS of 2^{μ}·15 KHZ, N_{TA_new}=N_{TA_old}+(T_{A}−31)·16·64/2^{μ}.

The open-loop TA procedure/control may require a GNSS-acquired position (or location information) of the wireless device and/or the NTN-config of the serving cell (e.g., the first NTN-config or the second NTN-config). The wireless device may, based on an implemented orbital predictor/propagator model (e.g., the GNSS-acquired position) and/or the NTN-config of the serving cell, may use the ephemeris data (and/or the GNSS-acquired position) to measure/calculate/maintain movement pattern of the satellite (corresponding to the NTN-config of the serving cell), measure/determine/estimate a service link delay (e.g., RTT of the service link), and/or measure/determine/estimate a feeder link delay (e.g., RTT of the feeder link) and/or measure/determine/estimate propagation delay between the wireless device and the base station (e.g., UE-gNB RTT of the serving cell). For example, the wireless device may, based on the GNSS-acquired position and/or the NTN-config of the serving cell, adjust the current TA value (e.g., the TA of the wireless device) via the open-loop TA procedure/control. The open-loop TA procedure/control may comprise determination/estimation calculation of one or more values, e.g.,

$${N}_{TA , adj}^{UE} and / or {N}_{TA , adj}^{c ommon} .$$

In some implementations, the wireless device may determine the open-loop TA value (corresponding to the serving cell) by summing up/adding the

$${N}_{TA , adj}^{common} and {N}_{TA , adj}^{UE} .$$

The wireless device may (to determine the TA value of the wireless device) determine/estimate

$${N}_{TA , adj}^{UE}$$

may be based on the propagation delay of the service link (e.g., between the wireless device and the NTN node). The wireless device may determine/measure/estimate

$${N}_{TA , adj}^{UE}$$

based on the location information of the wireless device (e.g., position and/or GNSS of the wireless device) and the satellite ephemeris data (e.g., the NTN-config) of the serving cell.

The wireless device may (to determine the TA value of the wireless device) determine/estimate

$${N}_{TA , adj}^{common}$$

may be a common delay of the cell (e.g., a portion of the feeder link delay that is not pre-compensated by the base station). The wireless device may determine the

$${N}_{TA , adj}^{common}$$

based on the one or more common TA parameters (e.g., the NTN-config) of the serving cell.

The wireless device may use the NTN-config of a cell (e.g., the serving cell) the calculate/determinate/measurement/maintain an estimate of the UE-gNB RTT between the UE and a base station of the cell. In an example, the wireless device may calculate/measure/estimate the UE-gNB RTT (in ms or number of slots) of the serving cell based on the current TA value and the K-Mac (if indicated by the NTN-config of the serving cell). For example, the UE-gNB RTT may be the summation of the current TA value and K-Mac (based on subcarrier spacing of the 15 KHz). When the K-Mac is 0, the wireless device may determine/measure the UE-gNB RTT based on the current TA value (of the wireless device), e.g., the UE-gNB RTT is equal to the current TA value. The wireless device may maintain/calculate/update the open-loop TA value (or the UE-gNB RTT) over a validity duration of the NTN-config (e.g., T430 timer).

For example, the validity duration may indicate (a maximum/longest) validity period of the (satellite) ephemeris data/information and/or the TA parameters of the NTN-config of the serving cell. For example, upon or in response to acquiring/receiving the NTN-config of the serving cell (e.g., upon reception of the SIB19 and/or upon reception of RRCReconfiguration message for a target cell including reconfigurationWithSync and/or upon conditional reconfiguration execution, e.g., when applying a stored RRCReconfiguration message for a target cell including reconfigurationWithSync), the wireless device may start/restart the validity (or validation) duration/timer/window/period (e.g., T430 timer) of the serving cell. For example, the wireless device may start the validity timer based the epoch time indicated by the NTN-config of the serving cell, e.g., the wireless device may start the validity timer from a subframe indicated by the epoch time. The wireless device may set an initial value of the T430 timer by ntn-UISyncValidityDuration of the NTN-config of the serving cell. The wireless device may stop the validity timer of the serving cell (e.g., a source cell or first cell) upon reception of the RRCReconfiguration message for the target cell (e.g., a second cell and/or a target serving cell) including reconfigurationWithSync and/or upon conditional reconfiguration execution, e.g., when applying a stored RRCReconfiguration message for the target cell including reconfigurationWithSync.

In an example, in response to determining that the validity duration being expired, the wireless device may stop UL transmissions via the serving cell and flush HARQ buffers. For example, the wireless device may acquire the SIB19 of the serving cell to receive an update NTN assistance information 2800. The wireless device may receive an update (satellite) ephemeris data/information and/or update common TA parameters. The wireless device may, prior to expiry of the validity duration of the serving cell and to reduce interruption in UL transmissions, (re-)acquire the SIB19 in order to have valid (estimate of) the open-loop TA value of the serving cell (valid TA value).

In an example, upon the expiry of the validity duration of the serving cell and when the wireless device is not able to (re-)acquire the SIB19 (of the serving cell), the wireless device may become UL unsynchronized with the base station of the serving cell, e.g., for UL communication with the base station via the serving cell.

The base station may transmit a differential Koffset MAC CE to the wireless device. The differential Koffset MAC CE may indicate a differential Koffset in a number of slots using SCS of 15 kHz. The wireless device may use the differential Koffset (indicated by the differential Koffset MAC CE) for determining transmission timing of UL signals and/or activation/deactivation time of one or more MAC CEs at the wireless device. When the differential Koffset is indicated, the wireless device may determine a UE-specific scheduling offset K_{UE,offset} based on the differential Koffset (e.g., the UE-specific scheduling offset is equal to minus the differential Koffset). If the differential Koffset is not indicated, the wireless device may set K_{UE,offset}=0. For example, the wireless device may determine K offset based on the cell-specific scheduling offset (e.g., cellSpecifickoffset, e.g., K_{cell,offset}) of the serving cell and the UE-specific scheduling offset K_{UE,offset}, e.g., K_{offset}=K_{cell,offset}−K_{UE,offset}.

The base station may transmit, to the wireless device, a DCI. The wireless device may receive the DCI during a reception occasion/time/interval (e.g., a slot/symbol). For example, the DCI may schedule/indicate/trigger a transmission of an uplink signal/channel (e.g., a PUSCH or a PUCCH or a PRACH or an SRS) to the base station via the NTN. The wireless device may transmit UL data and/or UCI and/or preamble and/or SRS resource via/based on the UL signal to the base station via/during a transmission occasion/time/interval (e.g., slot/symbol).

For example, the DCI may trigger/schedule/indicate a transmission of the PUSCH (e.g., the UL data) and/or the PUCCH (e.g., the UCI, e.g., HARQ-ACK information). The wireless device may use the cell-specific scheduling offset and/or the UE-specific scheduling offset to determine the transmission occasion of the PUSCH/PUCCH. For example, the transmission occasion of the PUSCH may be based on

$${K}_{offset} \cdot \frac{{2}^{{μ}_{PUSCH}}}{{2}^{{μ}_{{K}_{offset}}}} ,$$

wherein K_{offset}=K_{cell,offset}−K_{UE,offset} (corresponding to the serving cell). μ_{PUSCH} is the SCS configuration of the PUSCH transmission and μ_{K}_{_{offset}} is the SCS configuration of the Koffset (e.g., μ_{K}_{_{offset}}=0 for 15 kHz or FR1). For example, the transmission occasion of the PUCCH may be based on

$${K}_{offset} \cdot \frac{{2}^{{μ}_{PUCCH}}}{{2}^{{μ}_{{K}_{offset}}}}$$

(corresponding to the serving cell) where μ_{PUCCH} is the SCS configuration of the PUCCH transmission. The wireless device may apply/use the current TA value (e.g., based on the closed-loop TA value and/or the open-loop TA value) of the wireless device (corresponding to the serving cell) to transmit the PUSCH/PUCCH.

In another example, for a TAC MAC CE received on uplink slot n, the wireless device may apply/adjust an uplink transmission timing (e.g., for transmission of UL signals) from a beginning/start of uplink slot n+k+1+2^{μ}. K_{offset} where

$$k = ⌈ {N}_{slot}^{subframe , μ} \cdot ( {N}_{T , 1} + {N}_{T , 2} + {N}_{TA , max} + 0.5 ) / {T}_{sf} ⌉ ,$$

N_{T,1} is a time duration in many msec of N₁ symbols corresponding to a PDSCH processing time for UE processing capability 1 when additional PDSCH DM-RS is configured, N_{T,2} is a time duration in msec of N₂ symbols corresponding to a PUSCH preparation time for UE processing capability 1, N_{TA,max} is a maximum timing advance value in msec that can be provided by a TA command field of 12 bits,

$${N}_{slot}^{subframe , μ}$$

is the number of slots per subframe, T_{sf} is the subframe duration of 1 msec. N₁ and N₂ are determined with respect to the minimum SCS among the SCSs of all configured UL BWPs for all uplink carriers in the TAG and of all configured DL BWPs for the corresponding downlink carriers. For μ=0, the UE assumes N_{1,0}=14. Slot n and

$${N}_{slot}^{subframe , μ}$$

are determined with respect to the minimum SCS among the SCSs of all configured UL BWPs for all uplink carriers in the TAG. N_{TA,max} is determined with respect to the minimum SCS among the SCSs of all configured UL BWPs for all uplink carriers in the TAG and for all configured initial UL BWPs provided by initialUplinkBWP. The uplink slot n may be a last/final/ending/latest slot among uplink slot(s) overlapping with the slot(s) of PDSCH reception assuming T_{TA}=0, where the PDSCH provides the timing advance command.

FIG. 32B and FIG. 32C show examples of random access procedure in a non-terrestrial network per an aspect of the present disclosure. FIG. 32B and FIG. 32C may, for example, show implementations of a method (or a process) for the RA procedure at a base station and/or a wireless device. The base station may communicate with the wireless device via the NTN. As shown in FIG. 32B and FIG. 32C, the wireless device may receive the one or more configuration parameters from the base station. The one or more configuration parameters may comprise the NTN assistance information (e.g., the NTN-config). The one or more configuration parameters may comprise the one or more RACH configuration parameters. The wireless device may trigger/initiate the RA procedure.

For example, a DCI may trigger/indicate/order a transmission of the PRACH (e.g., the UL signal may be the ordered PRACH) corresponding to/with the preamble index. The DCI (e.g., the PDCCH order) may comprise a random access preamble index field indicating a value (e.g., that is not zero) of the preamble index. For the PRACH transmission (e.g., during/via the transmission occasion) to the base station by the wireless device, triggered by the PDCCH order, a PRACH mask index field of the DCI may indicate the PRACH occasion for the PRACH transmission. In an example, the PRACH occasions may be associated with an SS/PBCH block (e.g., SSB) index indicated by the SS/PBCH block index field of the DCI (e.g., the PDCCH order). The wireless device may use the cell-specific scheduling offset (e.g., K_{cell,offset} by cellSpecifickoffset) corresponding to the serving cell to determine the PRACH occasion. For example, the wireless device may determine the PRACH occasion being after slot n+2^{μ}·K_{cell,offset}·n may be the slot of an UL BWP for the PRACH transmission that overlaps with an end of the PDCCH order reception (e.g., assuming TA being 0, e.g., T_{TA}=0). μ may be the SCS configuration for the PRACH transmission. The PDCCH order reception may be received during the reception occasion.

As shown in FIG. 32B, the wireless device may, using (or based on) the (selected) RA resources of the RA procedure, transmit the first message (e.g., the preamble or the MsgA). In response to transmitting the first message (e.g., the preamble), the wireless device may start the RAR window (e.g., ra-ResponseWindow or msgB-ResponseWindow). In response to a PRACH transmission (e.g., for performing a 2-step/4-step RA procedure), the wireless device may attempt to detect (or receive or detect) a DCI format 1_0 with CRC scrambled by a corresponding RA-RNTI during the RAR window (e.g., ra-ResponseWindow). The RAR window may start at a first/initial/earliest symbol of an earliest CORESET the wireless device is configured to receive PDCCH for Type1-PDCCH CSS set. For example, the earliest CORESET may be at least one symbol, after the last/final/ending symbol of a PRACH occasion corresponding to the PRACH transmission. The symbol duration may correspond to an SCS for Type1-PDCCH CSS set.

When communicating with the NTN (e.g., when

$${N}_{TA , adj}^{UE} or {N}_{TA , adj}^{common}$$

is not zero, e.g., when the open-loop TA value of the wireless device is not zero), the wireless device may start the RAR window (e.g., ra-ResponseWindow or msgB-ResponseWindow) after (an additional) UE-gNB RTT of the serving cell from the first/initial/earliest symbol of the earliest CORESET. The wireless device may determine the UE-gNB RTT (e.g., in ms or in number of slots) of the serving cell based on the current TA value (e.g., T_{TA}) (of the serving cell) and/or the K-mac indicated by the NTN-config of the serving cell.

In response to a transmission of the PRACH and the PUSCH (e.g., for performing a 2-step procedure), or to a transmission of only the PRACH if the PRACH preamble is mapped to a valid PUSCH occasion of the RA procedure, the wireless device may attempt to detect a DCI format 1_0 with CRC scrambled by a corresponding MsgB-RNTI during the RAR window (e.g., msgB-ResponseWindow). The wireless device may start the RAR window at a first/initial/earliest symbol of an earliest CORESET the wireless device is configured to receive PDCCH for Type1-PDCCH CSS set. For example, the earliest CORESET may be at least one symbol, after the last/final/ending symbol of a PUSCH occasion corresponding to the PRACH transmission. When communicating with the NTN (e.g., when

$${N}_{TA , adj}^{UE} or {N}_{TA , adj}^{common}$$

is not zero, e.g., when the open-loop TA value of the wireless device is not zero), the wireless device may start the RAR window after (an additional) UE-gNB RTT of the serving cell.

As shown in FIG. 32B, the wireless device may receive a PDSCH with a RAR (e.g., Msg2/MsgB) from the base station during the RAR window. For example, the wireless device may receive the DCI scheduling a TB/MAC PDU (e.g., the Msg2/MsgB) comprising the RAR during the RAR window. In some examples, the wireless device may determine (or indicate or identify) a reception of the RAR (e.g., for or in response to the first message or the preamble) being successful (e.g., based on the at least one RAR condition being satisfied).

For example, the wireless device may consider the reception of the RAR successful based on the RAR comprising the MAC PDU with the RAPID corresponding (or matching) to the preamble with the preamble index PREAMBLE_INDEX. In some cases, the RAR may indicate an UL grant for transmission of Msg3 (e.g., a PUSCH transmission of the Msg3). The wireless device may process the UL grant and indicate it to the lower layers (e.g., the physical layer) for transmission of the Msg3 using/based on the UL grant. As the example of FIG. 32C, the wireless device may transmit the Msg3 (e.g., a PUSCH transmission of the Msg3). For example, when the wireless device receives the PDSCH with the RAR ending in slot n for the preamble transmission, the wireless device may transmit the PUSCH transmission of the Msg3 in slot n+k₂+Δ+2^{μ}. K_{cell,offset}, where the k₂ and Δ are provided by NR specification (e.g., TS 38.214) and K_{cell,offset} is indicated by cellSpecifickoffset of the serving cell; otherwise, if not provided, K_{cell,offset}=0.

As shown in FIG. 32C, in response to transmitting the Msg3 (e.g., initial transmission or a HARQ retransmission), the wireless device may start or restart a contention resolution timer. For example, the wireless device may (e.g., where

$${N}_{TA , adj}^{UE} or {N}_{TA , adj}^{common}$$

is not zero, e.g., when the open-loop TA value of the wireless device is not zero or when the wireless device is communicating with the base station via the NTN or when the serving cell is part of the NTN) start (or restart) the contention resolution timer, after the UE-gNB RTT of the serving cell from (a last/final/ending symbol of) a transmission occasion/slot of the Msg3 (e.g., the PUSCH transmission of the Msg3). For example, the wireless device may start or restart the contention resolution timer (e.g., ra-ContentionResolution Timer) in the first/starting/earliest/initial symbol after the end/latest/final/ending of all repetitions of the Msg3 transmission plus the UE-gNB RTT of the serving cell. The wireless device may monitor the PDCCH while the ra-Contention ResolutionTimer is running regardless of the possible occurrence of a measurement gap. While the contention resolution timer is running, the wireless device may determine whether contention resolution being successful (e.g., whether the at least one CR condition being satisfied) and/or whether the RA procedure being successfully completed (e.g., whether the at least one completion condition being satisfied).

In existing technologies, e.g., in a terrestrial network (TN) scenario (e.g., when the serving cell is not part of an NTN), after the wireless device receives the DCI (e.g., providing the PDCCH monitoring adaptation field indicating to the wireless device to skip PDCCH monitoring for the time duration on the active DL BWP of the serving cell (e.g., the SpCell), in response to determining the contention resolution being successful (as described above in embodiments of FIG. 31C and/or discussed below corresponding to embodiments of FIG. 32C), the wireless device may resume PDCCH monitoring on the SpCell (e.g., the wireless device may terminate the PDCCH skipping). For example, the base station may transmit to the wireless device one or more DCIs (e.g., one or more PDCCHs) to the wireless device after transmitting the PDSCH comprising the UE contention resolution identity MAC CE or after transmitting a PDCCH addressed to the C-RNTI.

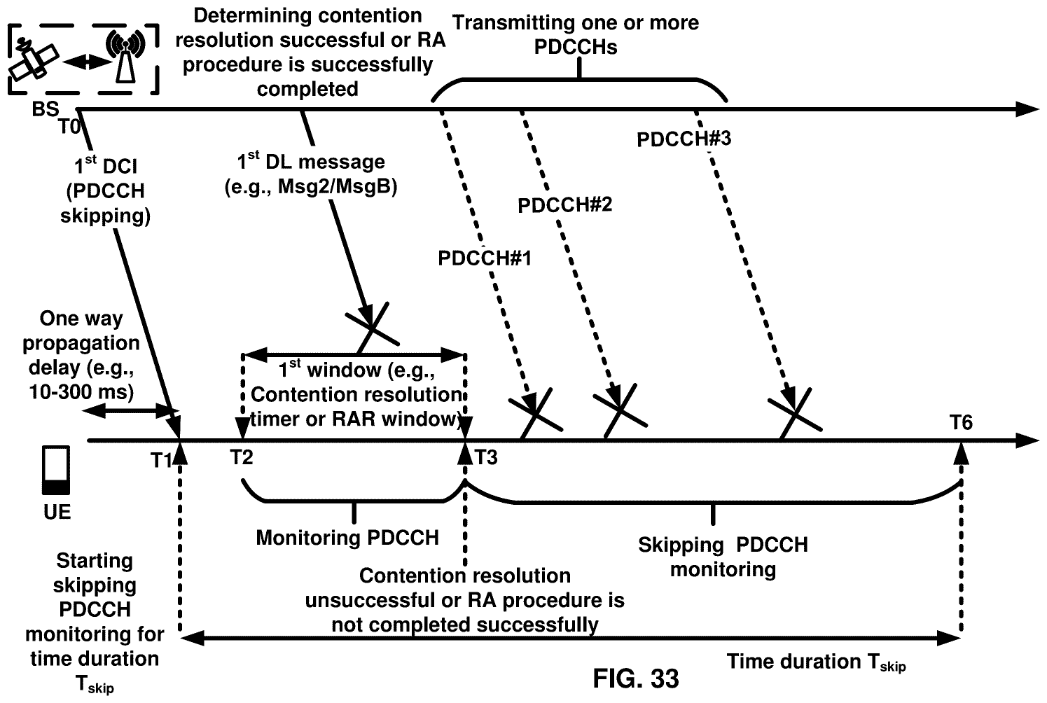

In existing technologies, in an NTN scenario (e.g., when the serving cell is part of the NTN) with a long propagation delay (e.g., approximately 600 milliseconds in the GEO satellite, e.g., at most 600 times longer than a maximum propagation delay in a TN scenario, and approximately 21-42 milliseconds in the LEO satellite, e.g., approximately 21-42 times longer than the maximum propagation delay in the TN scenario), there may be a misalignment between the wireless device and the base station (e.g., an example shown in FIG. 33).

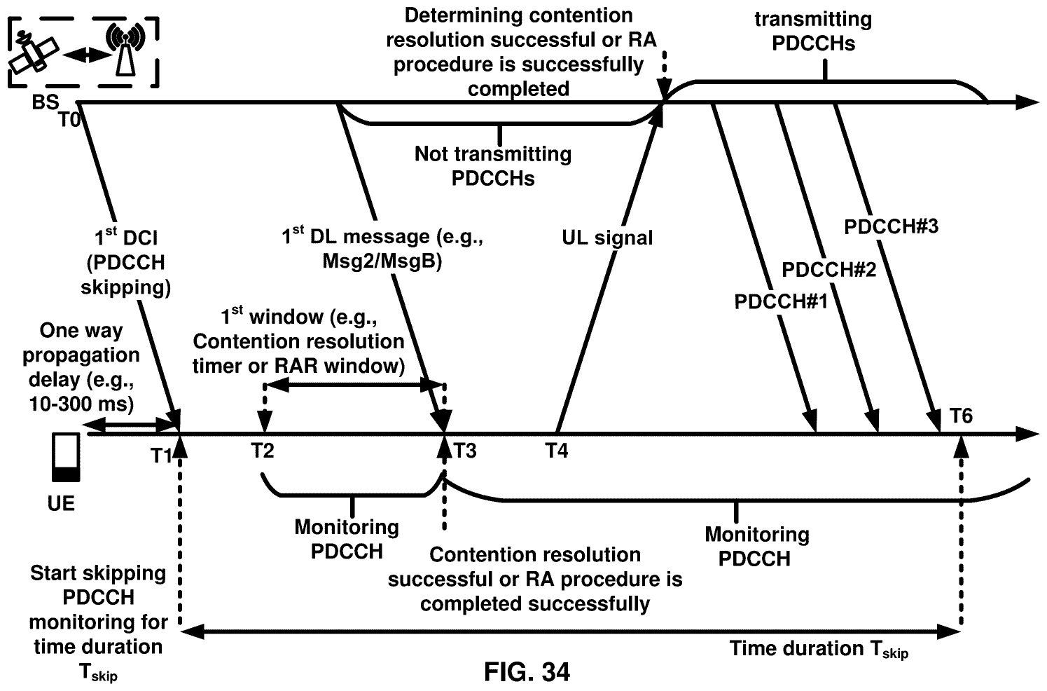

FIG. 33 and FIG. 34 show examples of PDCCH skipping in a non-terrestrial network per an aspect of the present disclosure. As shown in FIG. 33 and FIG. 34, the base station may, via the NTN, transmit a first DCI to the wireless device. The first DCI may indicate PDCCH skipping, e.g., the first DCI may comprise/provide the PDCCH monitoring adaptation field indicating to the wireless device to skip PDCCH monitoring for the time duration (e.g., Tₛₖᵢₚ slots or ms) on the active DL BWP of the serving cell (e.g., the SpCell). As shown in response to receiving the first DCI at time/occasion (e.g., symbol or slot) T1 in FIG. 33 and FIG. 34, the wireless device may start the PDCCH skipping (e.g., start skipping the PDCCH monitoring).

For example, the wireless device may start skipping of PDCCH monitoring at the beginning of a first/initial/starting/earliest slot that is after the last/ending/final symbol of the PDCCH reception providing the first DCI. For example, the wireless device may perform the RA procedure (e.g., as discussed above related to embodiments of FIG. 32B and/or FIG. 32C). As discussed above with respect to embodiments of FIG. 28A and/or FIG. 28B, the wireless device may monitor the PDCCH during a first window (e.g., the contention resolution timer and/or the RAR window), e.g., between time/occasion T2 and time/occasion T3, regardless of the receiving the first DCI indicating the PDCCH skipping. As shown in FIG. 33 and FIG. 34, the first window is during the time duration (from receiving the first DCI). For example, the base station may transmit a first DL message (e.g., the Msg2/MsgB) to the wireless device. The base station may expect the wireless device to receive the DL message during the first window. The base station may expect the first DL message indicate to the wireless device that the contention resolution is successful (e.g., based on determining the at least one CR condition being satisfied) or the RA procedure is successfully completed (e.g., based on determining the at least one completion condition being satisfied). In one example, the first DL message may comprise a PDSCH carrying/with a MAC PDU indicating a contention resolution identity of the wireless device (e.g., the UE Contention Resolution Identity MAC CE). In another example, the DL message may be a PDCCH addressed to the C-RNTI (when the Msg3 comprises the C-RNTI MAC CE and the DL message is in response to the Msg3). The first DL message may comprise the RAR.

In existing technologies, the base station may, based on transmitting the first DL message, consider/determine (or assume) the contention resolution (corresponding to/of the wireless device) being successful or the RA procedure being successfully completed. For example, the base station may expect the wireless device to resume the PDCCH monitoring (and/or terminate the skipping of PDCCH monitoring) based on (receiving) the first DL message. The base station may transmit to the wireless device one or more PDCCHs (e.g., PDCCH1, PDCCH2, or PDCCH 3 in FIG. 33) after transmitting the first DL message to the wireless device. The base station may expect the wireless device monitoring the PDCCH to receive the one or more PDCCHs (transmissions). However, as shown in FIG. 33, the wireless device may fail to receive the first DL message (or fail to determine the contention resolution being successful or fail to determine the RA procedure being successfully completed). For example, the wireless device may determine the contention resolution not being successful at time/occasion T3. In other example, the wireless device may determine the RA procedure not being successful at time/occasion T3. Opposite to the base station's assumption/expectation, the wireless device may not terminate the PDCCH skipping or may not resume the PDCCH monitoring. The wireless device may miss receiving the one or more PDCCHs transmitted by the wireless device. There may be a need to improve the RA procedure and/or the PDCCH skipping procedure at the wireless device and/or the base station to reduce the misalignment between the wireless device and the base station. The misalignment between the wireless device and the base station may reduce efficiency of UL/DL transmissions (e.g., by failing to receive the one or more PDCCHs).

FIG. 34 shows one solution to reduce possibility of misalignment between the wireless device and the base station. As shown in FIG. 34, the wireless device may transmit an UL signal at time/occasion T4 in FIG. 30 in response to (or based on) the first DL signal/message. For example, the UL signal may be the second preamble or the first PUCCH or the second PUCCH. The wireless device may transmit the UL signal based on whether the at least one CR condition being satisfied or not. The wireless device may transmit the UL signal based on whether the at least one completion condition being satisfied or not. the contention resolution not being successful.

Based on the contention resolution being successful (and/or the RA procedure being successfully completed) at/in the wireless device, the wireless device may transmit the first PUCCH with the first HARQ-ACK information (e.g., the UL signal) to the base station, e.g., for indicating to the base station that the contention resolution is successful (and/or the RA procedure is successfully completed). The first HARQ-ACK information may comprise/indicate an ACK value for a HARQ-ACK information bit. The first HARQ-ACK information may correspond to a PDSCH reception with the UE contention resolution identity (e.g., matching a contention identity of the wireless device). In an example embodiment, the first HARQ-ACK information may correspond to a PDCCH reception addressed to the C-RNTI of the wireless device (when the Msg3/MsgA comprises the C-RNTI MAC CE).

Based on the contention resolution not being successful (and/or the RA procedure not being successfully completed) at/in the wireless device, the wireless device may transmit the second PUCCH with the second HARQ-ACK information (e.g., the UL signal) to the base station, e.g., for indicating to the base station that the contention resolution is unsuccessful (and/or the RA procedure is not successfully completed). The second HARQ-ACK information may comprise/indicate a NACK value for a HARQ-ACK information bit. The first HARQ-ACK information may correspond to a PDSCH reception with the UE contention resolution identity (e.g., not matching a contention identity of the wireless device). In an example embodiment, the first HARQ-ACK information may correspond to not receiving a PDCCH reception addressed to the C-RNTI of the wireless device (when the Msg3/MsgA comprises the C-RNTI MAC CE). The first UL signal may be the second preamble, e.g., when the first window expires.

For example, the base station (e.g., in the NTN) based on receiving the UL signal may determine whether the contention resolution being successful (e.g., based on receiving the first PUCCH or not receiving the second preamble) at the wireless device. For example, the base station based on receiving the UL signal may determine whether the RA procedure being successfully completed at the wireless device (e.g., based on receiving the first PUCCH or not receiving the second preamble).

The base station may, based on not receiving the UL signal (e.g., in the NTN), determine the contention resolution not being successful or the RA procedure not being successfully completed. In other example, the base station may, based on receiving the second PUCCH and/or the second preamble (e.g., in the NTN), determine the contention resolution not being successful or the RA procedure not being successfully completed.

The base station may, based on receiving the first PUCCH (e.g., in the NTN), determine the contention resolution being successful or the RA procedure being successfully completed.

In an example embodiment, as shown in FIG. 34, the base station may not transmit (refrain from transmitting) the one or more PDCCHs to the wireless device (e.g., via the NTN) after the transmitting the DL message and/or prior to receiving the UL signal from the wireless device (e.g., via the NTN). For example, the base station may expect (or configure) the wireless device (when operating in the NTN) to transmit the UL signal to the base station in response to the transmitting the first DL message. As shown in FIG. 34, after receiving the UL signal from the wireless device (e.g., the first PUCCH), the base station may transmit the one or more PDCCHs to the wireless device. As the wireless device resumes the PDCCH monitoring at time/occasion T3 (e.g., based on the contention resolution being successful or the RA procedure being successfully completed) the wireless device may receive the one or more PDCCHs (e.g., during the time duration of the PDCCH skipping).

For example, after receiving the UL signal from the wireless device (e.g., the second PUCCH or the second preamble), the base station may avoid/skip transmitting the one or more PDCCHs to the wireless device. The wireless device may skip the PDCCH monitoring after time/occasion T3 (e.g., based on the contention resolution not being successful or the RA procedure not being successfully completed).

In existing technologies, in an NTN scenario (e.g., when the serving cell is part of the NTN) with a long propagation delay (e.g., approximately 600 milliseconds in the GEO satellite, e.g., at most 600 times longer than a maximum propagation delay in a TN scenario, and approximately 21-42 milliseconds in the LEO satellite, e.g., approximately 21-42 times longer than the maximum propagation delay in the TN scenario), the wireless device may, based on existing technologies, unnecessarily resume PDCCH monitoring (e.g., cancel/terminate the PDCCH skipping) when the contention resolution is successful or the RA procedure is successfully completed (at time/occasion T3 in FIG. 34). In an NTN scenario with a long propagation delay, the consumed power of the wireless device may not necessarily reduce (e.g., when the contention resolution is successful or the RA procedure is successfully completed).

The solution of the FIG. 34 may not be effective in reducing the consumed power of the wireless device, e.g., the wireless device may unnecessarily monitor the PDCCH after determining the contention resolution being successful (and/or the RA procedure being successful), e.g., between time/occasion T3 and time/occasion T5. Existing technologies may increase consumed power of the wireless device. Hence, improvements for monitoring (or skipping monitoring) PDCCH in an NTN scenario with a long propagation delay may be required to prevent an unnecessary increase of the consumed power of the wireless device.

Embodiments of the present disclosure are related to an approach for determining whether to resume (e.g., after receiving the first DCI) monitoring control channels (e.g., downlink control channels, e.g., PDCCHs) based on whether a contention resolution of an (ongoing) RA procedure being successful or not. Some embodiments are related to an approach for determining whether to resume (e.g., after receiving the first DCI) monitoring control channels (e.g., downlink control channels, e.g., PDCCHs) based on whether the (ongoing) RA procedure being successfully completed or not. These and other features of the present disclosure are described further below.

For example, the wireless device may, via the serving cell of the NTN, receive from the base station the indication (e.g., the first DCI) to skip control channel monitoring (e.g., PDCCH monitoring). The wireless device may, after/in response to the receiving the indication (or based on the indication), skip monitoring control channels (e.g., skip the PDCCH monitoring), e.g., on the active DL BWP of the serving cell. In an example embodiment, the wireless device may resume monitoring the control channel (e.g., the PDCCH), e.g., on the active DL BWP of the serving cell, after a first time offset (that is) from/after determining the ongoing RA procedure being successfully completed (e.g., the at least one completion condition being satisfied).

The first time offset may be based on the NTN-config of the serving cell (e.g., cellSpecifickoffset-r17 in NTN-Config-r17 in FIG. 31C). The first time offset may, for example, be the cell-specific scheduling offset Kcell, offset indicated by the NTN-config of the serving cell. In another example, the first time offset may be based on the UE-specific scheduling offset K_{UE,offset}. For example, the first time offset may be K_{offset}=K_{cell,offset}−K_{UE,offset}. In yet another example, the first time offset may be based on the UE-gNB RTT.

In an example, the wireless device may transmit the UL signal (e.g., the first PUCCH) based on/after the ongoing RA procedure being successfully completed (e.g., the at least one completion condition being satisfied). In an example embodiment, the wireless device may resume monitoring the control channel (e.g., the PDCCH), e.g., on the active DL BWP of the serving cell, after a second time offset (that is) from/after the transmitting the UL signal. The second time offset may be the UE-gNB RTT. For example, the wireless device may determine the second time offset based on NTN-config of the serving cell (e.g., ta-Info-r17 and/or ephemerisInfo-r17 in NTN-Config-r17 in FIG. 31C).

For example, the wireless device may, via the serving cell of the NTN, receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on the active DL BWP of the serving cell. For example, the wireless device may, before an expiry of the time duration, determine the (ongoing) random access procedure being successful (e.g., based on the at least one completion condition being satisfied). In an example embodiment, the wireless device may, in response to the expiry of the time duration, resume monitoring the control channel (e.g., on an active DL BWP of the serving cell) based on the expiry of the time duration being before/prior to the first time offset after determining the random access procedure is successfully completed.

For example, the wireless device may, before an expiry of the time duration, determine the (ongoing) random access procedure being successful (e.g., based on the at least one completion condition being satisfied). The wireless device may transmit the UL signal to the base station in response to the (ongoing) random access procedure being successful. In an example embodiment, the wireless device may, in response to the expiry of the time duration, resume monitoring the control channel (e.g., on an active DL BWP of the serving cell) based on the expiry of the time duration being before/prior to the second time offset after transmitting the UL signal.

In an example embodiment, the wireless device may resume monitoring the control channel (e.g., the PDCCH), e.g., on the active DL BWP of the serving cell, after the first time offset (that is) from/after determining a contention resolution of the ongoing RA procedure being successful (e.g., the at least one CR condition being satisfied).

The wireless device may transmit the UL signal (e.g., the first PUCCH) based on/after the contention resolution of the ongoing RA procedure being successful (e.g., the at least one CR condition being satisfied). In an example embodiment, the wireless device may resume monitoring the control channel (e.g., the PDCCH), e.g., on the active DL BWP of the serving cell, after the second time offset (that is) from/after the transmitting the UL signal.

For example, the wireless device may, before an expiry of the time duration, determine, the contention resolution of the random access procedure being successful. In an example embodiment, the wireless device may, in response to the expiry of the time duration, resume monitoring the control channel (e.g., on an active DL BWP of the serving cell) based on the expiry of the time duration is before the second time offset after determining the contention resolution of the random access procedure is successful. In some examples, the wireless device may transmit the UL signal in response to the contention resolution of the random access procedure being successful. In an example embodiment, the wireless device may, in response to the expiry of the time duration, resume monitoring the control channel (e.g., on an active DL BWP of the serving cell) based on the expiry of the time duration is before the second time offset after transmitting the UL signal.

Example embodiments of the present disclosure may provide enhancement for PDCCH monitoring in an NTN with long propagation delay (e.g., 10-300 ms). Example embodiments may allow the wireless device to determine whether to monitor the control channels after a contention resolution of an ongoing RA procedure is successful and/or the RA procedure is successfully completed. Example embodiments may improve efficiency of the RA procedure, as the wireless device monitors the control channel to receive one or more PDCCHs (e.g., after the first time offset from determining the ongoing RA procedure being successful) despite the first DCI indicating the skipping monitoring the control channel. Some embodiments may allow the wireless device to terminate the skipping of the control channel after the first time offset from determining the ongoing RA procedure being successful (and/or the contention resolution of the ongoing RA procedure being successful). Example embodiments reduce consumed power of the wireless device by reducing possibility of unnecessarily monitoring control channels.

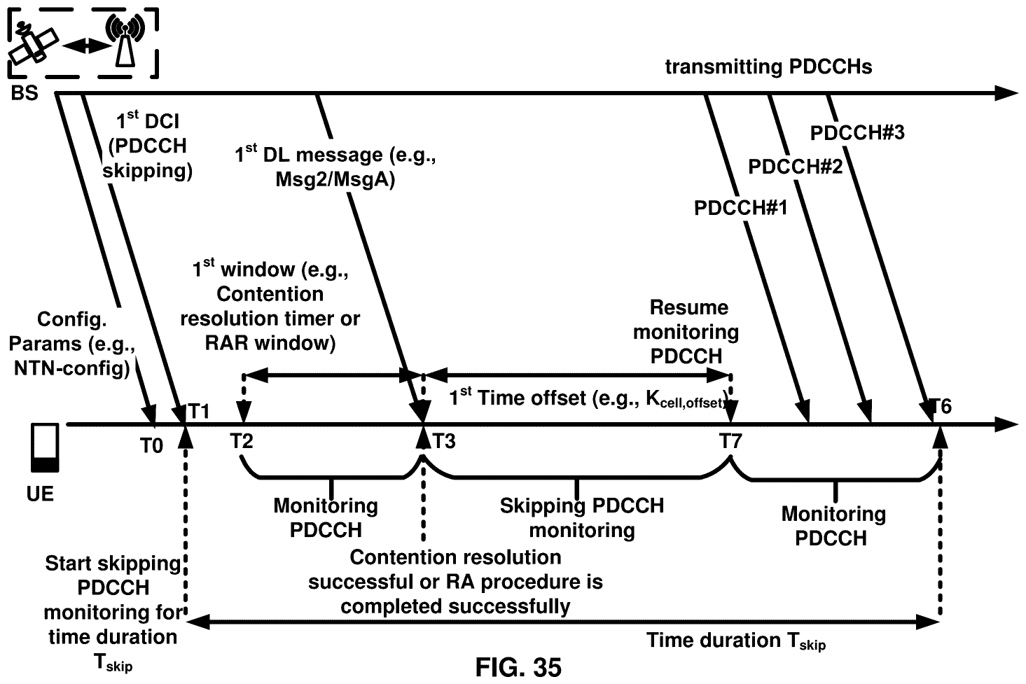

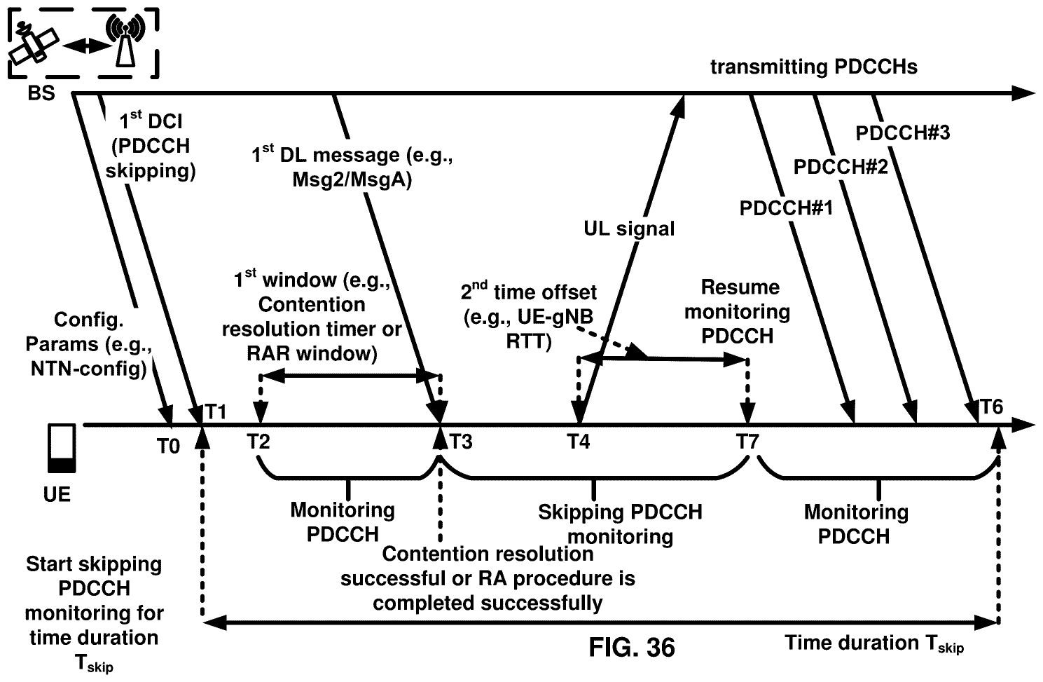

FIG. 35 and FIG. 36 show examples of PDCCH skipping in a non-terrestrial network per an aspect of the present disclosure. As shown in FIG. 35 and FIG. 36, the wireless device may communicate with a base station via the NTN. For example, the wireless device may receive the one or more configuration parameters from the base station. The one or more configuration parameters may comprise the NTN assistance information (e.g., the NTN-config of the serving cell) and/or the one or more RA configuration parameters and/or the one or more PDCCH configuration parameters. The wireless device may perform (initiate) the RA procedure as discussed in FIG. 32B and/or FIG. 32C describe above.

As shown in FIG. 35 and FIG. 36, the base station may, via the NTN, transmit the first DCI to the wireless device. The first DCI may indicate PDCCH skipping, e.g., the first DCI may comprise/provide the PDCCH monitoring adaptation field indicating to the wireless device to skip PDCCH monitoring for the time duration (e.g., Tₛₖᵢₚ Slots or ms) on the active DL BWP of the serving cell (e.g., the SpCell). As shown in response to receiving the first DCI at time/occasion (e.g., symbol or slot) T1 in FIG. 35 and FIG. 36, the wireless device may start the PDCCH skipping (e.g., start skipping the PDCCH monitoring).

For example, the wireless device may start skipping of PDCCH monitoring at the beginning of a first/initial/starting/earliest slot that is after the last/ending/final symbol of the PDCCH reception/transmission providing the first DCI. For example, the wireless device may perform the RA procedure (e.g., as discussed above related to embodiments of FIG. 32B and/or FIG. 32C). As discussed above with respect to embodiments of FIG. 28A and/or FIG. 28B, the wireless device may monitor the PDCCH during the first window (e.g., the contention resolution timer and/or the RAR window), e.g., between time/occasion T2 and time/occasion T3, regardless of the receiving the first DCI indicating the PDCCH skipping. As shown in FIG. 35 and FIG. 36, the first window is during the time duration (from receiving the first DCI). For example, the base station may transmit the first DL message (e.g., the Msg2/MsgB) to the wireless device. The wireless device may receive the first DL message during the first window.

The wireless device may, at time/occasion/slot T3 in FIG. 35 and FIG. 36, determine the contention resolution being successful (e.g., based on the at least one CR condition being satisfied) or the RA procedure is successfully completed (e.g., based on the at least one completion condition being satisfied).

In an example embodiment, as shown in FIG. 35, the wireless device may, in response to/after (or based on) the contention resolution being successful (e.g., during the time duration), resume the PDCCH monitoring (or terminate the PDCCH skipping) on the active DL BWP of the serving cell (e.g., the SpCell) after a first time offset (or a first offset or a first gap or a first timing gap) from/after the contention resolution being successful (e.g., the time/occasion/slot T3 in FIG. 35 and FIG. 36). For example, resuming the PDCCH monitoring may be the first time offset from from/after the contention resolution being successful (e.g., the time/occasion/slot T3 in FIG. 35 and FIG. 36).

In an example embodiment, as shown in FIG. 35, the wireless device may, response to/after (or based on) the contention resolution being successful (e.g., during the time duration), resume the PDCCH monitoring (or terminate the PDCCH skipping) on the active DL BWP of the serving cell (e.g., the SpCell) after a second time offset (or a second offset or a second gap or a second timing gap) from/after transmitting the UL signal (e.g., the time/occasion/slot T4 in FIG. 36).

The first time offset may be based on the NTN-config of the serving cell. In one example, the first time offset may be the cell-specific scheduling offset Kcell, offset indicated by the NTN-config of the serving cell. In another example, the first time offset may be based on the UE-specific scheduling offset KUE, offset. For example, the first time offset may be K_{offset}=K_{cell,offset}−K_{UE,offset}. In yet another example, the first time offset may be based on the UE-gNB RTT. The second time offset may be the UE-gNB RTT.

In some cases, the NTN-config of the serving cell may indicate one or more beam-specific scheduling offsets. Each beam-specific scheduling offset of the one or more beam-specific scheduling offsets may correspond to a beam of the serving cell in the NTN. The first time offset may be based on the one or more beam-specific scheduling offsets of the serving cell. For example, the first time offset may be a first beam-specific scheduling offset of the one or more beam-specific scheduling offsets. The first beam-specific scheduling offset of the one or more beam-specific scheduling offsets may correspond to a first beam of the serving cell. The wireless device may transmit the first message via the first beam of the serving cell. The wireless device may receive the first DL message and/or the first DCI via the first beam of the serving cell.

In an example embodiment, as shown in FIG. 35, the wireless device may, response to/after (or based on) the RA procedure being successfully completed (e.g., during the time duration), resume the PDCCH monitoring (or terminate the PDCCH skipping) on the active DL BWP of the serving cell (e.g., the SpCell) after the first time offset from/after the RA procedure being successfully completed (e.g., the time/occasion/slot T3 in FIG. 35 and FIG. 36). For example, resuming the PDCCH monitoring may be the first time offset from from/after the RA procedure being successfully completed.

In an example embodiment, as shown in FIG. 35, the wireless device may, response to/after (or based on) the contention resolution being successful (e.g., during the time duration), resume the PDCCH monitoring (or terminate the PDCCH skipping) on the active DL BWP of the serving cell (e.g., the SpCell) after the second time offset from/after transmitting the UL signal (e.g., the time/occasion/slot T4 in FIG. 36). The time/occasion/slot T4 in FIG. 36 may be a last/final/ending/latest symbol of the first PUCCH transmission occasion.

The wireless device may avoid/skip monitoring the PDCCH on the active DL BWP of the serving cell from the time/occasion/slot T3 to the time/occasion/slot T7 in FIG. 35 and FIG. 36. For example, the wireless device may receive the one or more PDCCHs on the active DL BWP of the serving cell after the first time offset from/after the contention resolution being successful.

In the present disclosure, “PDCCH skipping” refers to “skipping of monitoring PDCCH” or “skipping monitoring PDCCH” or “skipping monitoring control channel” or “avoiding monitoring PDCCH” or “avoiding monitoring control channel” or “starting skipping monitoring control channel”.

In the present disclosure, “resuming the PDCCH monitoring” refers to “terminating/ending PDCCH monitoring” or “resuming monitoring control channel(s)” or “starting monitoring control channel”.

In the present disclosure, “monitoring PDCCH” refers to “monitoring one or more PDCCH candidates”. In the present disclosure, “determining a contention resolution of a random access procedure being successful” refers to “determining the contention resolution of the random successful” or “considering the contention resolution of the random access procedure successful”.

In the present disclosure, “determining a random access procedure being successfully completed” refers to “considering the random access procedure successfully completed”.

In the present disclosure, “successfully receiving a RAR” refers to “a successful reception of the RAR” or “considering the RAR reception is successful” or “determining the RAR being received successfully” or “determining receiving the RAR successfully”.

Example embodiments of the present disclosure may improve the alignment between the wireless device and the base station regarding the PDCCH skipping during the time duration and/or an ongoing RA procedure. Some examples may reduce consumed power of the wireless device for monitoring the PDCCH (e.g., when the contention resolution being successful and/or when the RA procedure being successfully completed).

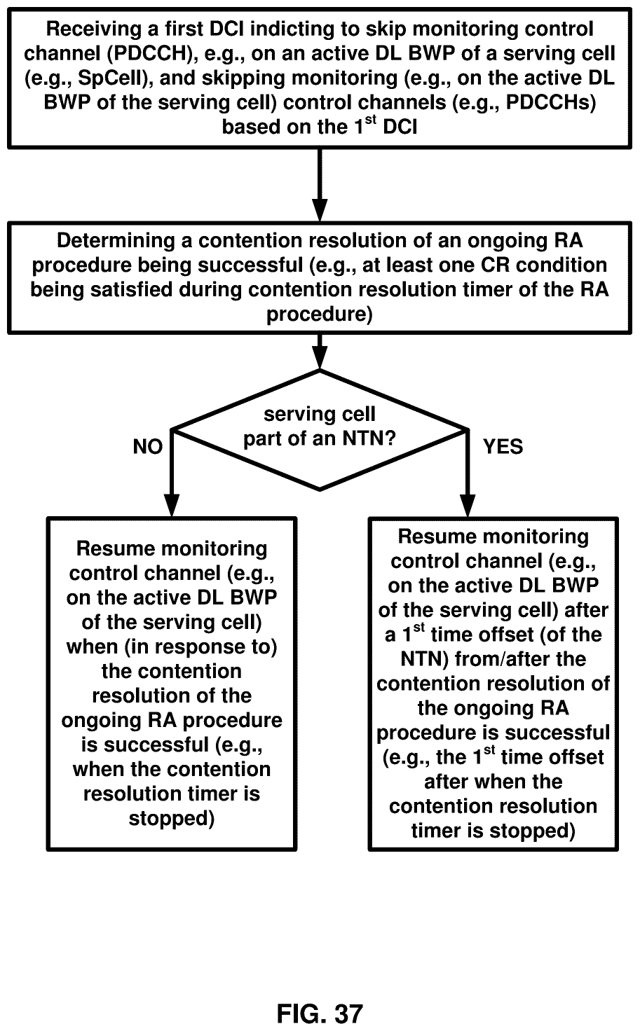

FIG. 37 illustrates an example flowchart of PDCCH skipping as per an aspect of an embodiment of the present disclosure. For example, the wireless device may receive the first DCI. The first DCI may indicate to skip control channel monitoring (e.g., PDCCH monitoring), e.g., for the time duration (e.g., Tskip). The first DCI may indicate skipping PDCCH monitoring on the active DL BWP of the serving cell (e.g., SpCell). The wireless device may, based on the first DCI, skip monitoring control channels (e.g., skip the PDCCH monitoring). For example, the wireless device may, after receiving the first DCI (e.g., during the time duration), determine an ongoing contention resolution being successful (e.g., at least one CR condition being satisfied during an RAR window of the RA procedure).

In an example embodiment, based on the serving cell not being part of the NTN, the wireless device may resume the PDCCH monitoring (e.g., on the active DL BWP of the serving cell) when (in response to) the contention resolution of the ongoing RA procedure is successful (e.g., when the contention resolution timer of the RA procedure is stopped due to the successful contention resolution of the ongoing RA procedure).

In an example embodiment, based on the serving cell being part of the NTN, the wireless device may resume the PDCCH monitoring (e.g., on the active DL BWP of the serving cell) after the first time offset from/after when (in response to) the contention resolution of the ongoing RA procedure is successful (e.g., after the first time offset from/after when the contention resolution timer of the RA procedure is stopped due to the successful contention resolution of the ongoing RA procedure).

In an example embodiment, based on the serving cell being part of the NTN, the wireless device may resume the PDCCH monitoring (e.g., on the active DL BWP of the serving cell) after the second time offset from/after transmitting the UL signal to the base station. The wireless device may transmit the UL signal in response to the contention resolution of the ongoing RA procedure is successful.

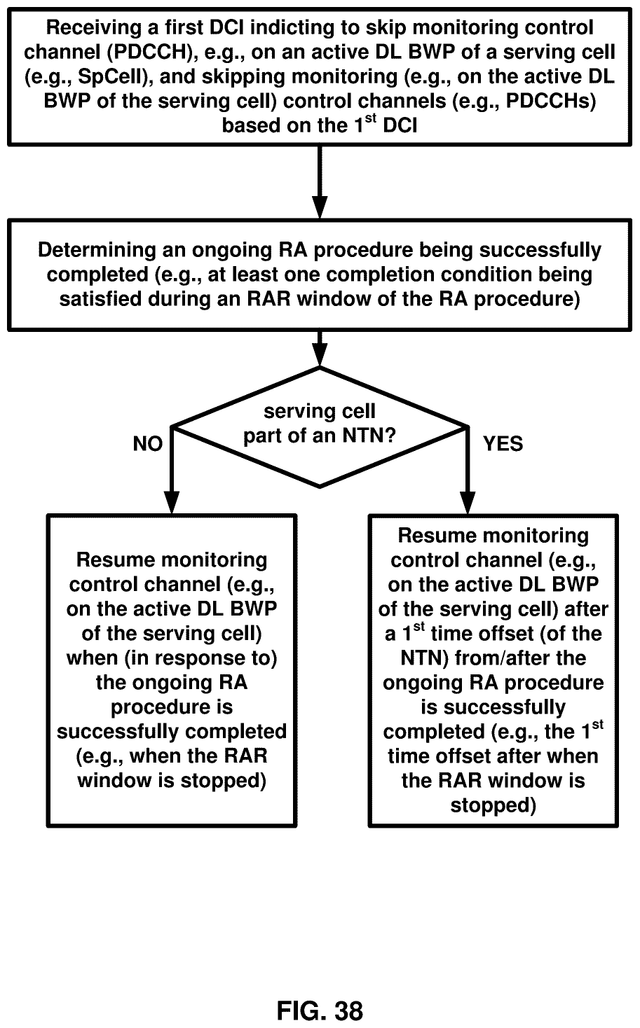

FIG. 38 illustrates an example flowchart of PDCCH skipping as per an aspect of an embodiment of the present disclosure. For example, the wireless device may receive the first DCI. The wireless device may, based on the first DCI, skip monitoring control channels (e.g., skip the PDCCH monitoring). For example, the wireless device may, after receiving the first DCI (e.g., during the time duration), determine the ongoing RA procedure being successfully completed (e.g., at least one completion condition being satisfied during an RAR window of the RA procedure).

In an example embodiment, based on the serving cell not being part of the NTN, the wireless device may resume the PDCCH monitoring (e.g., on the active DL BWP of the serving cell) when (in response to) the ongoing RA procedure is successfully completed (e.g., when the RAR window is stopped due to the successful completion of the RA procedure).

In an example embodiment, based on the serving cell being part of the NTN, the wireless device may resume the PDCCH monitoring (e.g., on the active DL BWP of the serving cell) after the first time offset from/after when (in response to) the ongoing RA procedure is successfully completed (e.g., after the first time offset from/after when the RAR window is stopped due to the successful completion of the RA procedure).

In an example embodiment, based on the serving cell being part of the NTN, the wireless device may resume the PDCCH monitoring (e.g., on the active DL BWP of the serving cell) after the second time offset from/after transmitting the UL signal to the base station. The wireless device may transmit the UL signal in response to the contention resolution of the ongoing RA procedure is successful.

In an example, after the wireless device detects a DCI format providing the PDCCH monitoring adaptation field indicating to the wireless device to skip PDCCH monitoring for the duration on the active DL BWP of a SpCell, when/if an (ongoing) RA procedure is successfully completed, the wireless device may resume PDCCH monitoring on the SpCell. When SpCell is part of the NTN (e.g., when

$${N}_{TA , adj}^{UE} or {N}_{TA , adj}^{common}$$

is not zero), the wireless device may resume PDCCH monitoring on the SpCell after the first time gap from/after the RA procedure is successfully completed.

In an example, when SpCell is part of the NTN (e.g., when

$${N}_{TA , adj}^{UE} or {N}_{TA , adj}^{common}$$

is not zero), after the wireless device detects a DCI format providing the PDCCH monitoring adaptation field indicating to the wireless device to skip PDCCH monitoring for the duration on the active DL BWP of a SpCell, when/if a contention resolution of an (ongoing) RA procedure is successful, the wireless device may resume PDCCH monitoring on the SpCell after the first time gap from/after the RA procedure is successfully completed.

In an example, after the wireless device detects a DCI format providing the PDCCH monitoring adaptation field indicating to the wireless device to skip PDCCH monitoring for the duration on the active DL BWP of a SpCell, the wireless device monitors PDCCH when a PDCCH indicating a new transmission addressed to the C-RNTI of the MAC entity has not been received after successful reception of a Random Access Response for the Random Access Preamble not selected by the MAC entity among the contention-based Random Access Preamble.

In an example, after the wireless device detects a DCI format providing the PDCCH monitoring adaptation field indicating to the wireless device to skip PDCCH monitoring for the duration on the active DL BWP of a SpCell, the wireless device resumes PDCCH monitoring on the SpCell after a PDCCH indicating a new transmission addressed to the C-RNTI of the MAC entity is received after successful reception of a Random Access Response for the Random Access Preamble not selected by the MAC entity among the contention-based Random Access Preamble.

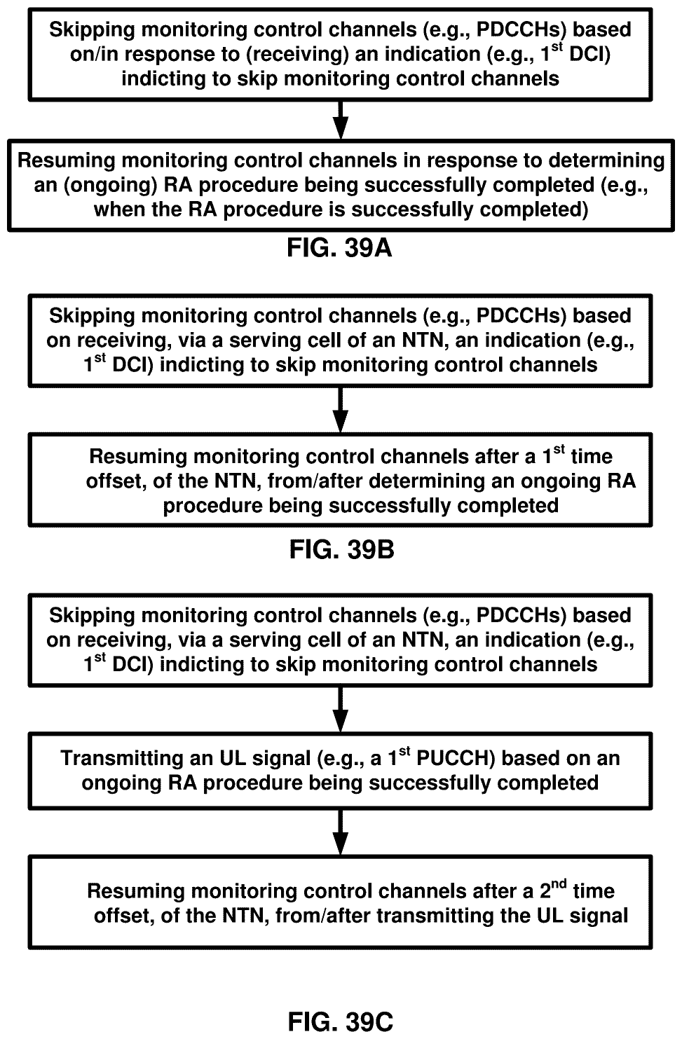

FIG. 39A illustrates an example flowchart of PDCCH skipping as per an aspect of an embodiment of the present disclosure. For example, the wireless device may receive from the base station an indication (e.g., the first DCI) to skip control channel monitoring (e.g., PDCCH monitoring). The indication may indicate skipping control channel monitoring on the active DL BWP of the serving cell (e.g., SpCell). The indication may indicate skipping control channel for the time duration (e.g., Tskip).

The wireless device may, after/in response to the receiving the indication (or based on the indication), skip monitoring control channels (e.g., skip the PDCCH monitoring). In an example embodiment, the wireless device may resume monitoring the control channel (e.g., the PDCCH), e.g., on the active DL BWP of the serving cell, in response to/based on (or when) an ongoing RA procedure being successfully completed. For example, the wireless device may determine the ongoing RA procedure being successfully completed based on the at least one completion condition being satisfied.

An example method comprising receiving a downlink control information (DCI) indicating to skip control channel monitoring; starting, based on the DCI, skipping monitoring control channel; and resuming monitoring the control channel in response to a random access procedure being successfully completed.

FIG. 39B illustrates an example flowchart of PDCCH skipping as per an aspect of an embodiment of the present disclosure. For example, the wireless device may, via the serving cell of the NTN, receive from the base station the indication (e.g., the first DCI) to skip control channel monitoring (e.g., PDCCH monitoring). The wireless device may, after/in response to the receiving the indication (or based on the indication), skip monitoring control channels (e.g., skip the PDCCH monitoring), e.g., on the active DL BWP of the serving cell. In an example embodiment, the wireless device may resume monitoring the control channel (e.g., the PDCCH), e.g., on the active DL BWP of the serving cell, after the first time offset (that is) from/after determining the ongoing RA procedure being successfully completed (e.g., the at least one completion condition being satisfied).

FIG. 39C illustrates an example flowchart of PDCCH skipping as per an aspect of an embodiment of the present disclosure. For example, the wireless device may, via the serving cell of the NTN, receive from the base station the indication (e.g., the first DCI) to skip control channel monitoring (e.g., PDCCH monitoring), e.g., on the active DL BWP of the serving cell. The wireless device may, after/in response to the receiving the indication (or based on the indication), skip monitoring control channels (e.g., skip the PDCCH monitoring). The wireless device may transmit the UL signal (e.g., the first PUCCH) based on/after the ongoing RA procedure being successfully completed (e.g., the at least one completion condition being satisfied). In an example embodiment, the wireless device may resume monitoring the control channel (e.g., the PDCCH), e.g., on the active DL BWP of the serving cell, after the second time offset (that is) from/after the transmitting the UL signal.

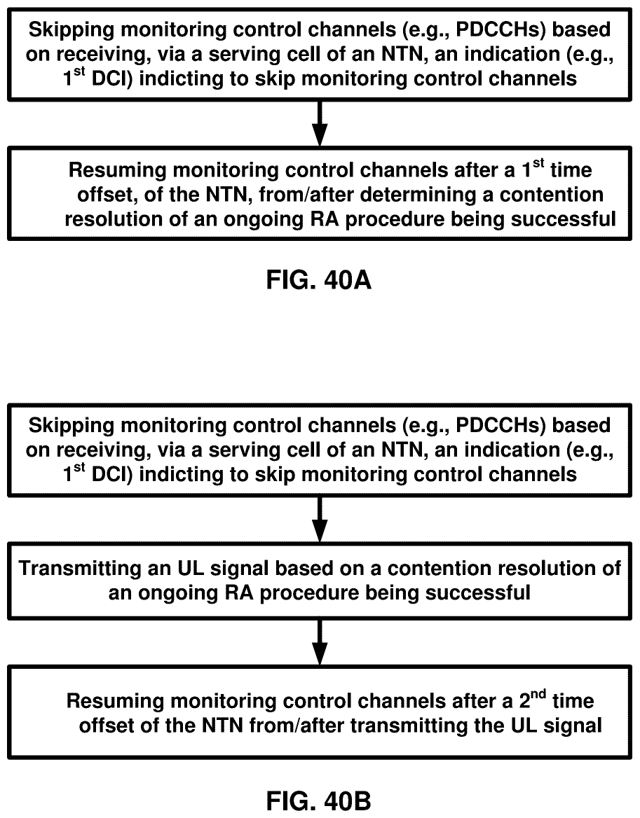

FIG. 40A illustrates an example flowchart of PDCCH skipping as per an aspect of an embodiment of the present disclosure. For example, the wireless device may, via the serving cell of the NTN, receive from the base station the indication (e.g., the first DCI) to skip control channel monitoring (e.g., PDCCH monitoring). The wireless device may, after/in response to the receiving the indication (or based on the indication), skip monitoring control channels (e.g., skip the PDCCH monitoring), e.g., on the active DL BWP of the serving cell. In an example embodiment, the wireless device may resume monitoring the control channel (e.g., the PDCCH), e.g., on the active DL BWP of the serving cell, after the first time offset (that is) from/after determining a contention resolution of the ongoing RA procedure being successful (e.g., the at least one CR condition being satisfied).

FIG. 40B illustrates an example flowchart of PDCCH skipping as per an aspect of an embodiment of the present disclosure. For example, the wireless device may, via the serving cell of the NTN, receive from the base station the indication (e.g., the first DCI) to skip control channel monitoring (e.g., PDCCH monitoring). The wireless device may, after/in response to the receiving the indication (or based on the indication), skip monitoring control channels (e.g., skip the PDCCH monitoring), e.g., on the active DL BWP of the serving cell. The wireless device may transmit the UL signal (e.g., the first PUCCH) based on/after the contention resolution of the ongoing RA procedure being successful (e.g., the at least one CR condition being satisfied). In an example embodiment, the wireless device may resume monitoring the control channel (e.g., the PDCCH), e.g., on the active DL BWP of the serving cell, after the second time offset (that is) from/after the transmitting the UL signal.

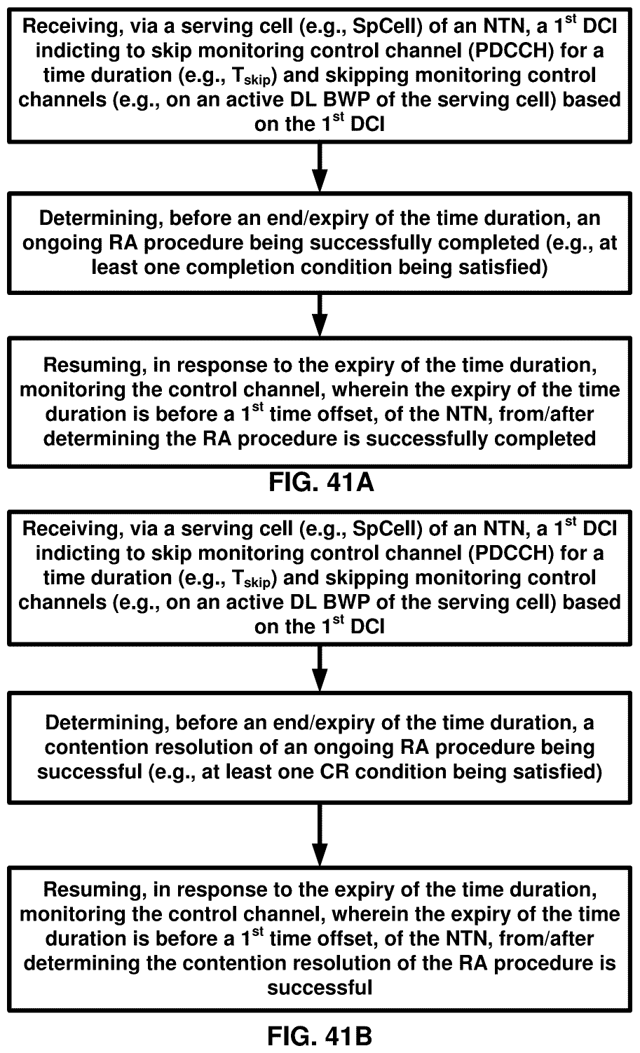

FIG. 41A illustrates an example flowchart of PDCCH skipping as per an aspect of an embodiment of the present disclosure. For example, the wireless device may, via the serving cell of the NTN, receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on the active DL BWP of the serving cell. For example, the wireless device may, before an expiry of the time duration, determine the (ongoing) random access procedure being successful (e.g., based on the at least one completion condition being satisfied). In an example embodiment, the wireless device may, in response to the expiry of the time duration, resume monitoring the control channel (e.g., on an active DL BWP of the serving cell) based on the expiry of the time duration being before/prior to the first time offset after determining the random access procedure is successfully completed.

For example, the wireless device may, via the serving cell of the NTN, receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on the active DL BWP of the serving cell. For example, the wireless device may, before an expiry of the time duration, determine the (ongoing) random access procedure being successful (e.g., based on the at least one completion condition being satisfied). The wireless device may transmit the UL signal to the base station in response to the (ongoing) random access procedure being successful. In an example embodiment, the wireless device may, in response to the expiry of the time duration, resume monitoring the control channel (e.g., on an active DL BWP of the serving cell) based on the expiry of the time duration being before/prior to the second time offset after transmitting the UL signal.

FIG. 41B illustrates an example flowchart of PDCCH skipping as per an aspect of an embodiment of the present disclosure. For example, the wireless device may, via the serving cell of the NTN, receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on the active DL BWP of the serving cell. For example, the wireless device may, before an expiry of the time duration, determine, the contention resolution of the random access procedure being successful. In an example embodiment, the wireless device may, in response to the expiry of the time duration, resume monitoring the control channel (e.g., on an active DL BWP of the serving cell) based on the expiry of the time duration is before the second time offset after determining the contention resolution of the random access procedure is successful.

For example, the wireless device may, via the serving cell of the NTN, receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on an active DL BWP of the serving cell. For example, the wireless device may, before an expiry of the time duration, determine, the contention resolution of the random access procedure being successful. The wireless device may transmit the UL signal in response to the contention resolution of the random access procedure being successful. In an example embodiment, the wireless device may, in response to the expiry of the time duration, resume monitoring the control channel (e.g., on an active DL BWP of the serving cell) based on the expiry of the time duration is before the second time offset after transmitting the UL signal.

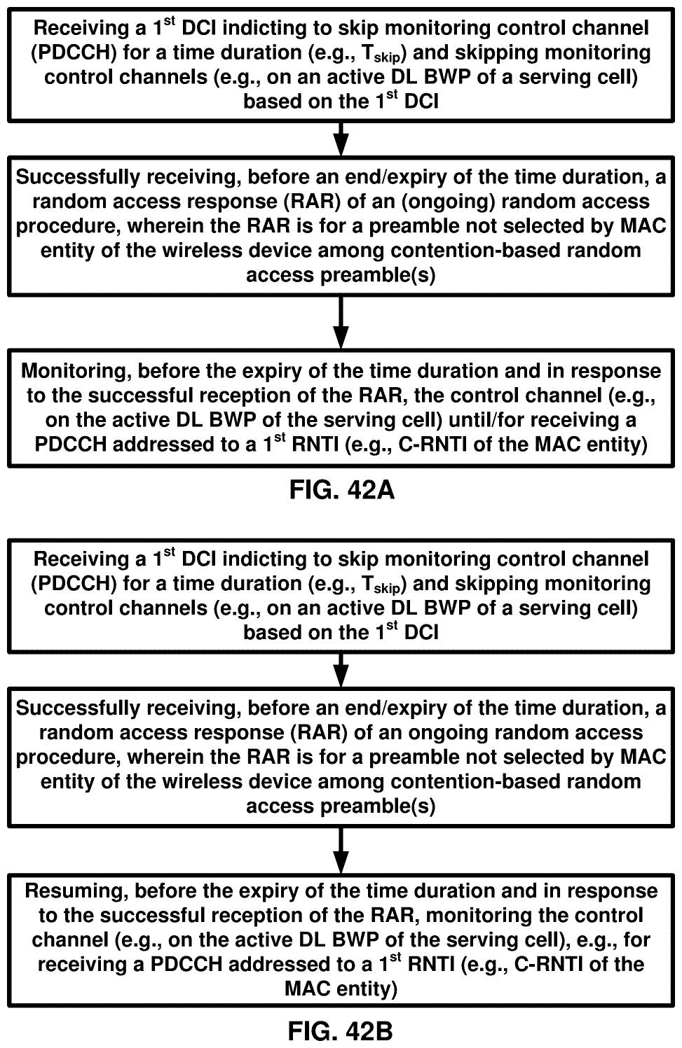

FIG. 42A illustrates an example flowchart of PDCCH skipping as per an aspect of an embodiment of the present disclosure. For example, the wireless device may receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on an active DL BWP of the serving cell. The wireless device may successfully receive, before an end/expiry of the time duration, a random access response (RAR) of an (ongoing) random access procedure (e.g., based on the at least one RA condition being satisfied). For example, the RAR may be for a preamble not selected by MAC entity of the wireless device among contention-based random access preamble(s). In an example embodiment, the wireless device may monitor, before the expiry of the time duration and in response to the successful reception of the RAR, the control channel (e.g., on the active DL BWP of the serving cell) until/for receiving a PDCCH addressed to C-RNTI of the MAC entity.

FIG. 42B illustrates an example flowchart of PDCCH skipping as per an aspect of an embodiment of the present disclosure. For example, the wireless device may receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on an active DL BWP of the serving cell. The wireless device may successfully receive, before an end/expiry of the time duration, the random access response (RAR) for the preamble of the RA procedure (e.g., based on the at least one RA condition being satisfied). In an example embodiment, the wireless device may resume, before the expiry of the time duration and in response to the successful reception of the RAR, the control channel (e.g., on the active DL BWP of the serving cell), e.g., for receiving a PDCCH addressed to a first RNTI (e.g., CRC of the PDCCH is scrambled by the first RNTI). The first RNTI may be the C-RNTI of the MAC entity of the wireless device. For example, the wireless device may terminate the skipping the control channel monitoring before the expiry of the time duration and in response to the successful reception of the RAR.

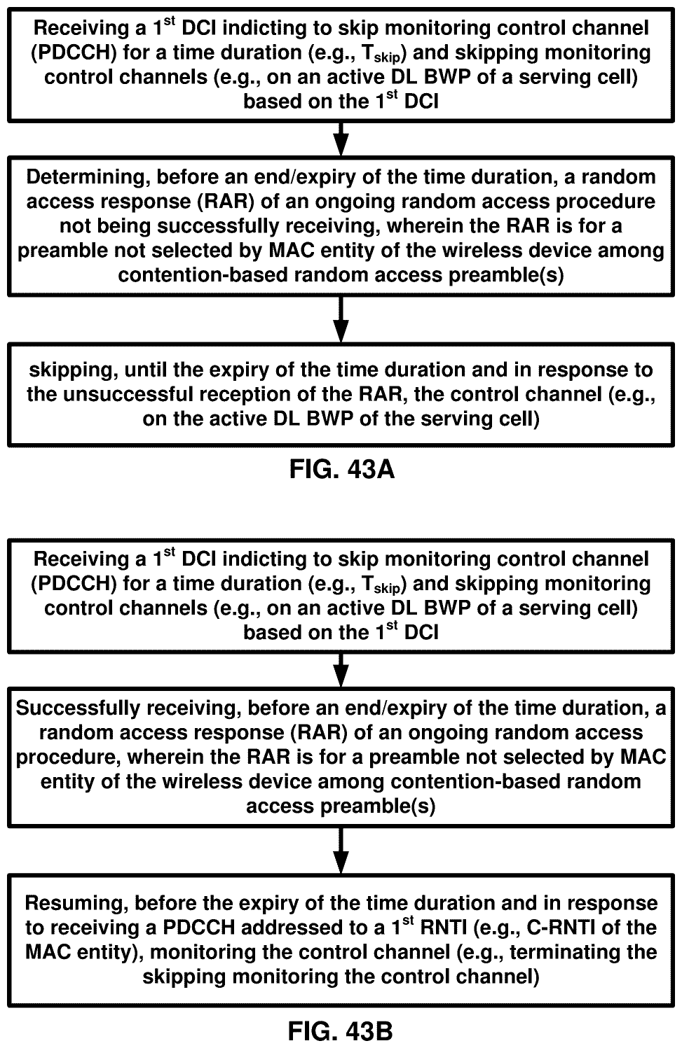

FIG. 43A illustrates an example flowchart of PDCCH skipping as per an aspect of an embodiment of the present disclosure. For example, the wireless device may receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on an active DL BWP of the serving cell. The wireless device may determine, before an end/expiry of the time duration, the random access response (RAR) of an (ongoing) random access procedure not being successfully received (e.g., based on the at least one RA condition not being satisfied). In an example embodiment, the wireless device may skip, until the expiry of the time duration and in response to the unsuccessful reception of the RAR, the control channel (e.g., on the active DL BWP of the serving cell)

FIG. 43B illustrates an example flowchart of PDCCH skipping as per an aspect of an embodiment of the present disclosure. For example, the wireless device may receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on an active DL BWP of the serving cell. The wireless device may successfully receive, before an end/expiry of the time duration, the random access response (RAR) for the preamble of the RA procedure (e.g., based on the at least one RA condition being satisfied). For example, the wireless device may monitor, in response to successfully receiving the RAR and before the expiry of the time duration, the control channels for receiving the PDCCH addressed to the first RNTI. In an example embodiment, the wireless device may resume, before the expiry of the time duration and in response to the receiving the PDCCH addressed to the first RNTI, the control channel (e.g., on the active DL BWP of the serving cell). For example, the wireless device may terminate the skipping the control channel monitoring before the expiry of the time duration and in response to the receiving the PDCCH addressed to the first RNTI.

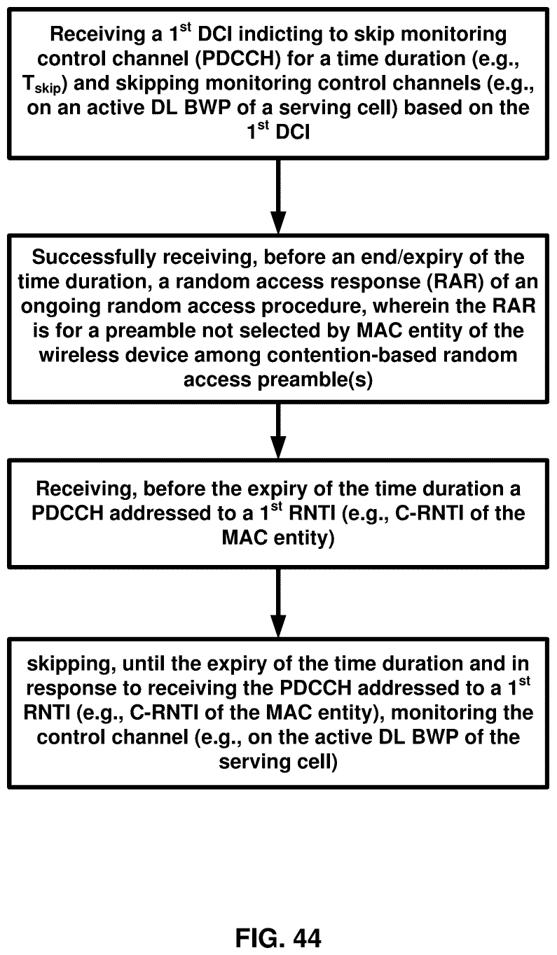

FIG. 44 illustrates an example flowchart of PDCCH skipping as per an aspect of an embodiment of the present disclosure. For example, the wireless device may receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on an active DL BWP of the serving cell. The wireless device may successfully receive, before an end/expiry of the time duration, the random access response (RAR) for the preamble of the RA procedure (e.g., based on the at least one RA condition being satisfied). For example, the wireless device may monitor, in response to successfully receiving the RAR and before the expiry of the time duration, the control channels for receiving the PDCCH addressed to the first RNTI. The wireless device may receive the PDCCH addressed to the first RNTI. In an example embodiment, the wireless device may skip, until the expiry of the time duration and in response to the receiving the PDCCH addressed to the first RNTI, the control channel (e.g., on the active DL BWP of the serving cell).

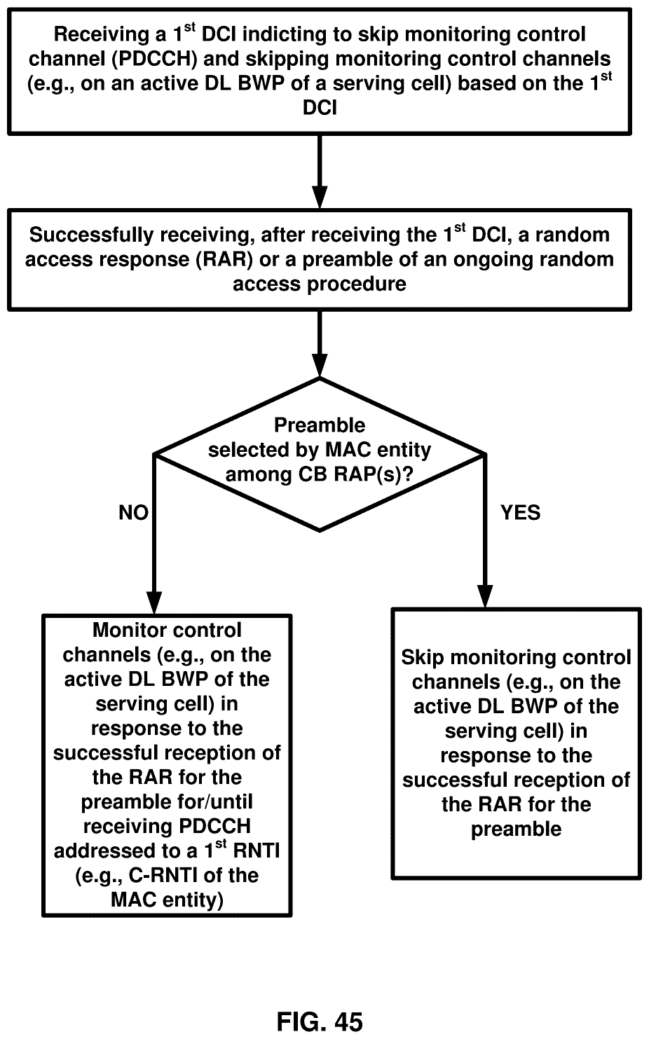

FIG. 45 illustrates an example flowchart of PDCCH skipping as per an aspect of an embodiment of the present disclosure. For example, the wireless device may receive from the base station the indication (e.g., the first DCI) to skip control channel monitoring (e.g., PDCCH monitoring) for the time duration. The wireless device may, after/in response to (or based on) the receiving the indication (or based on the indication), skip monitoring control channels (e.g., skip the PDCCH monitoring), e.g., on an active DL BWP of the serving cell. The wireless device may successfully receive, before an end/expiry of the time duration, the random access response (RAR) for the preamble of the RA procedure (e.g., based on the at least one RA condition being satisfied). In an example embodiment, based on the preamble being selected (e.g., by the MAC entity of the wireless device) among the contention-based (CB) random access preambles (RAPs), the wireless device may skip, e.g., until the expiry of the time duration, the control channel (e.g., on the active DL BWP of the serving cell).

In an example embodiment, based on the preamble not being selected (e.g., by the MAC entity of the wireless device) among the contention-based (CB) random access preambles (RAPs), the wireless device may monitor the control channel (e.g., on the active DL BWP of the serving cell), e.g., until/for receiving the PDCCH addressed to the first RNTI.

In an example embodiment, based on the preamble being selected (e.g., by the MAC entity of the wireless device) among the contention-free (CF) random access preambles (RAPs), the wireless device may monitor the control channel (e.g., on the active DL BWP of the serving cell), e.g., until/for receiving the PDCCH addressed to the first RNTI.

In an example embodiment, based on the preamble being indicated by a PDCCH order, the wireless device may monitor the control channel (e.g., on the active DL BWP of the serving cell), e.g., until/for receiving the PDCCH addressed to the C-RNTI. In some implementations, the indicated preamble by the PDCCH order may be among the CB RAPs. In other implementations, the indicated preamble by the PDCCH order may be among the CF RAPs.

In an example embodiment, based on the preamble not being selected (e.g., by the MAC entity of the wireless device) among the contention-based (CB) random access preambles (RAPs), the wireless device may resume monitoring the control channel (e.g., on the active DL BWP of the serving cell), e.g., terminate skipping the control channel monitoring (e.g., on the active DL BWP of the serving cell).

In an example embodiment, based on the preamble being selected (e.g., by the MAC entity of the wireless device) among the contention-free (CF) random access preambles (RAPs), the wireless device may resume monitoring the control channel (e.g., on the active DL BWP of the serving cell), e.g., terminate skipping the control channel monitoring (e.g., on the active DL BWP of the serving cell).

In an example embodiment, based on the preamble being indicated by a PDCCH order, the wireless device may resume monitoring the control channel (e.g., on the active DL BWP of the serving cell), e.g., terminate skipping the control channel monitoring (e.g., on the active DL BWP of the serving cell). In some implementations, the indicated preamble by the PDCCH order may be among the CB RAPs. In other implementations, the indicated preamble by the PDCCH order may be among the CF RAPs.

An example method comprising receiving, by the wireless device, one or more configuration parameters indicating the first time offset of the NTN; receiving a downlink control information (DCI) indicating to skip control channel monitoring; starting, based on the DCI, skipping monitoring control channel; in response to a contention resolution of a random access procedure being successful, resuming monitoring the control channel after the first time offset after/from determining the contention resolution of the random access procedure being successful.

An example method comprising receiving, by the wireless device, one or more configuration parameters indicating the first time offset of the NTN; receiving a downlink control information (DCI) indicating to skip control channel monitoring; starting, based on the DCI, skipping monitoring control channel; and resuming monitoring the control channel after the first time offset after/from determining a contention resolution of a random access procedure being successful.

The above-example method, wherein the time offset is based on a cell-specific scheduling offset of the NTN indicated by the one or more configuration parameters.

One or more of the above-example method, wherein the time offset is the cell-specific scheduling offset of the NTN.

One or more of the above-example method, wherein the time offset is further based on a user equipment (UE)-specific scheduling offset of the wireless device.

One or more of the above-example method, further comprising: receiving a differential Koffset medium access control (MAC) control element; and determining the UE-specific scheduling offset based on the differential Koffset MAC CE and the cell-specific scheduling offset.

One or more of the above-example method, wherein the time offset is based on a round-trip transmission delay (RTT) between the wireless device and a base station.

One or more of the above-example method, wherein the one or more configuration parameters indicate at least one skipping duration.

One or more of the above-example method, wherein the DCI indicates a skipping duration of the at least one skipping duration.

One or more of the above-example method, further comprising determining the skipping duration not being expired after the time offset from the determining the contention resolution of the random access procedure is successful.

One or more of the above-example method, wherein an expiry of the skipping duration is after the time offset after from the determining the contention resolution of the random access procedure is successful.

One or more of the above-example method, further comprising: receiving a second DCI indicating to skip monitoring control channels for a second skipping duration of the at least one skipping duration; staring, based on the second DCI, skipping monitoring control channel; determining, before an expiry of the second skipping duration, a contention resolution of a second random access procedure being successful; and resuming, in response to the expiry of the second skipping duration, monitoring the control channel based on the expiry of the second skipping duration is before the time offset after determining the contention resolution of the random access procedure being successful.

One or more of the above-example method, wherein DCI indicates to skip monitoring the control channel on an active downlink bandwidth part of a cell.

One or more of the above-example method, wherein the cell is a special primary cell (SpCell).

One or more of the above-example method, wherein the cell is part of the NTN.

An example method comprising: receiving, by a wireless device via a cell of a terrestrial network, a third DCI indicating to skip control channel monitoring; starting, based on the third DCI, skipping monitoring control channel; and resuming monitoring the control channel after determining the contention resolution of the random access procedure is successful.

An example method comprising: receiving a fourth DCI indicating to skip control channel monitoring; starting, based on the fourth DCI, skipping monitoring control channel; and avoiding terminating monitoring the control channel based on determining the contention resolution of the random access procedure is unsuccessful.

An example method comprising receiving, by the wireless device from a base station, one or more configuration parameters comprising one or more NTN configuration parameters for determining the UE-gNB RTT; receiving a downlink control information (DCI) indicating to skip control channel monitoring; starting, based on the DCI, skipping monitoring control channel; transmitting the UL signal in response to successfully completing a contention resolution of a random access procedure; and resuming monitoring the control channel after the UE-gNB RTT (e.g., the second) time offset after/from the transmitting the UL signal.

An example method comprising receiving, by the wireless device, one or more configuration parameters indicating the first time offset of the NTN; receiving a downlink control information (DCI) indicating to skip control channel monitoring; starting, based on the DCI, skipping monitoring control channel; and resuming monitoring the control channel after the first time offset after/from determining a random access procedure being successfully completed.

An example method comprising receiving, by the wireless device from a base station, one or more configuration parameters comprising one or more NTN configuration parameters for determining the UE-gNB RTT; receiving a downlink control information (DCI) indicating to skip control channel monitoring; starting, based on the DCI, skipping monitoring control channel; and resuming monitoring the control channel after the UE-gNB RTT (e.g., the second) time offset after/from transmitting the UL signal for successfully completing a random access procedure.

An example method comprising receiving, by the wireless device, one or more configuration parameters indicating the first time offset of the NTN; receiving a downlink control information (DCI) indicating to skip control channel monitoring; starting, based on the DCI, skipping monitoring control channel; and resuming monitoring the control channel after the first time offset after/from determining a contention resolution of a random access procedure being successful.

An example method comprising receiving, by the wireless device from a base station, one or more configuration parameters comprising one or more NTN configuration parameters for determining the UE-gNB RTT; receiving a downlink control information (DCI) indicating to skip control channel monitoring; starting, based on the DCI, skipping monitoring control channel; and resuming monitoring the control channel after the UE-gNB RTT (e.g., the second) time offset after/from transmitting the UL signal for successfully completing a contention resolution of a random access procedure.

An example method comprising transmitting, by a base station to a wireless device, the first downlink control information (DCI) indicating to skip control channel monitoring and the first downlink message of an (ongoing) random access procedure; avoiding, from transmitting the first downlink message and until receiving the uplink signal of the random access procedure, transmitting physical downlink control channels (PDCCHs) to the wireless device. In response to receiving the uplink signal from the wireless device, transmitting the one or more PDCCHs to the wireless device.

An example method comprising transmitting, by a base station to a wireless device, the first downlink control information (DCI) indicating to skip control channel monitoring and the first downlink message of the RA procedure, wherein the first downlink message indicates a contention resolution of the RA procedure is successful; avoiding, from transmitting the first downlink message and until receiving the uplink signal of the random access procedure, transmitting physical downlink control channels (PDCCHs) to the wireless device. In response to receiving the uplink signal from the wireless device, transmitting the one or more PDCCHs to the wireless device, wherein the uplink signal is the first PUCCH carrying the first HARQ-ACK information bit corresponding to the first downlink message.

An example method comprising transmitting, by a base station to a wireless device, the first downlink control information (DCI) indicating to skip control channel monitoring and the first downlink message of the RA procedure, wherein the first downlink message indicates a contention resolution of the RA procedure is successful; avoiding, from transmitting the first downlink message and until receiving the uplink signal of the random access procedure, transmitting physical downlink control channels (PDCCHs) to the wireless device. In response to receiving the up link signal from the wireless device, avoiding transmitting the one or more PDCCHs to the wireless device, wherein the uplink signal is the second PUCCH carrying the second HARQ-ACK information bit corresponding to the first downlink message.

An example method comprising transmitting, by a base station to a wireless device, the first downlink control information (DCI) indicating to skip control channel monitoring and the first downlink message of the RA procedure, wherein the first downlink message indicates a contention resolution of the RA procedure is successful; avoiding, from transmitting the first downlink message and until receiving the uplink signal of the random access procedure, transmitting physical downlink control channels (PDCCHs) to the wireless device. In response to receiving the uplink signal from the wireless device, avoiding transmitting the one or more PDCCHs to the wireless device, wherein the uplink signal is the second preamble of the RA procedure.

An example method comprising transmitting, by a base station to a wireless device, the first downlink control information (DCI) indicating to skip control channel monitoring and the first downlink message of the RA procedure, wherein the first downlink message indicates the RA procedure is successfully completed; avoiding, from transmitting the first downlink message and until receiving the uplink signal of the random access procedure, transmitting physical downlink control channels (PDCCHs) to the wireless device. In response to receiving the uplink signal from the wireless device, transmitting the one or more PDCCHs to the wireless device, wherein the uplink signal is the first PUCCH carrying the first HARQ-ACK information bit corresponding to the first downlink message.

An example method comprising transmitting, by a base station to a wireless device, the first downlink control information (DCI) indicating to skip control channel monitoring and the first downlink message of the RA procedure, wherein the first downlink message wherein the first downlink message indicates the RA procedure is successfully completed; avoiding, from transmitting the first downlink message and until receiving the uplink signal of the random access procedure, transmitting physical downlink control channels (PDCCHs) to the wireless device. In response to receiving the uplink signal from the wireless device, avoiding transmitting the one or more PDCCHs to the wireless device, wherein the uplink signal is the second PUCCH carrying the second HARQ-ACK information bit corresponding to the first downlink message.

An example method comprising transmitting, by a base station to a wireless device, the first downlink control information (DCI) indicating to skip control channel monitoring and the first downlink message of the RA procedure, wherein the first downlink message wherein the first downlink message indicates the RA procedure is successfully completed; avoiding, from transmitting the first downlink message and until receiving the uplink signal of the random access procedure, transmitting physical downlink control channels (PDCCHs) to the wireless device. In response to receiving the uplink signal from the wireless device, avoiding transmitting the one or more PDCCHs to the wireless device, wherein the uplink signal is the second preamble of the RA procedure.

An example method comprising transmitting, by a base station to a wireless device, the first downlink control information (DCI) indicating to skip control channel monitoring for a time duration and a RAR for the preamble received from the wireless device; transmitting, to the wireless device and before an end of the time duration, physical downlink control channel (PDCCH) addressed to the first RNTI.

What is claimed is:

1. A method comprising:
receiving, by a wireless device, a first control message indicating to skip control channel monitoring;
skipping, after receiving the first control message, the control channel monitoring; and
resuming the control channel monitoring when:
a contention-free random access procedure is completed; or
a two-step random access procedure is completed.

2. The method of claim 1, wherein the first control message comprises a physical downlink control channel (PDCCH) monitoring adaptation field.

3. The method of claim 1, wherein:
the receiving the first control message is via a physical downlink control channel (PDCCH) reception providing a downlink control information (DCI) format; and
the first control message comprises a DCI.

4. The method of claim 1, further comprising starting a duration for skipping the control channel monitoring based on receiving the first control message, wherein:
the first control message further indicates to skip the control channel monitoring for the duration on an active downlink bandwidth part (BWP) of a cell; and
an expiry of the duration is after:
the contention-free random access procedure is completed; or
the two-step random access procedure is completed.

5. The method of claim 1, further comprising receiving a second control message comprising non-terrestrial network (NTN) configurations indicating a scheduling offset, wherein:
a time offset is based on the scheduling offset; and
the resuming the control channel monitoring is after the time offset from when:
the contention-free random access procedure is completed; or
the two-step random access procedure is completed.

6. The method of claim 5, further comprising determining a timing advance (TA) value based on the NTN configurations, wherein the time offset is further based on a summation of the TA value and the scheduling offset.

7. The method of claim 5, further comprising determining a round-trip transmission delay between the wireless device and a base station based on the NTN configurations, wherein:
the scheduling offset comprises a medium access control (MAC)-layer scheduling offset; and
the time offset is:
equal to the round-trip transmission delay; and
further based on a differential offset indicated by a differential MAC control element.

8. A wireless device comprising:
one or more processors; and
memory storing instructions that, when executed by the one or more processors, cause the wireless device to:
receive a first control message indicating to skip control channel monitoring;
skip, after receiving the first control message, the control channel monitoring; and
resume the control channel monitoring when:
a contention-free random access procedure is completed; or
a two-step random access procedure is completed.

9. The wireless device of claim 8, wherein the first control message comprises a physical downlink control channel (PDCCH) monitoring adaptation field.

10. The wireless device of claim 8, wherein:
receiving the first control message is via a PDCCH reception providing a downlink control information (DCI) format; and
the first control message comprises a DCI.

11. The wireless device of claim 8, wherein the instructions further cause the wireless device to start a duration for skipping the control channel monitoring based on receiving the first control message, wherein:
the first control message further indicates to skip the control channel monitoring for the duration on an active downlink bandwidth part (BWP) of a cell; and
an expiry of the duration is after:
the contention-free random access procedure is completed; or
the two-step random access procedure is completed.

12. The wireless device of claim 8, wherein the instructions further cause the wireless device to receive a second control message comprising non-terrestrial network (NTN) configurations indicating a scheduling offset, wherein:
a time offset is based on the scheduling offset; and
resuming the control channel monitoring is after the time offset from when:
the contention-free random access procedure is completed; or
the two-step random access procedure is completed.

13. The wireless device of claim 12, wherein the instructions further cause the wireless device to determine a timing advance (TA) value based on the NTN configurations, wherein the time offset is further based on a summation of the TA value and the scheduling offset.

14. The wireless device of claim 12, wherein the instructions further cause the wireless device to determine a round-trip transmission delay between the wireless device and a base station based on the NTN configurations, wherein:
the scheduling offset comprises a medium access control (MAC)-layer scheduling offset; and
the time offset is:
equal to the round-trip transmission delay; and
further based on a differential offset indicated by a differential MAC control element.

15. A non-transitory computer-readable medium comprising instructions that, when executed by one or more processors of a wireless device, cause the wireless device to:
receive a first control message indicating to skip control channel monitoring;
skip, after receiving the first control message, the control channel monitoring; and
resume the control channel monitoring when:
a contention-free random access procedure is completed; or
a two-step random access procedure is completed.

16. The non-transitory computer-readable medium of claim 15, wherein:
receiving the first control message is via a physical downlink control channel (PDCCH) reception providing a downlink control information (DCI) format; and
the first control message comprises a DCI.

17. The non-transitory computer-readable medium of claim 15, wherein the instructions further cause the wireless device to start a duration for skipping the control channel monitoring based on receiving the first control message, wherein:
the first control message further indicates to skip the control channel monitoring for the duration on an active downlink bandwidth part (BWP) of a cell; and
an expiry of the duration is after:
the contention-free random access procedure is completed; or
the two-step random access procedure is completed.

18. The non-transitory computer-readable medium of claim 15, wherein the instructions further cause the wireless device to receive a second control message comprising non-terrestrial network (NTN) configurations indicating a scheduling offset, wherein:
a time offset is based on the scheduling offset; and
resuming the control channel monitoring is after the time offset from when:
the contention-free random access procedure is completed; or
the two-step random access procedure is completed.

19. The non-transitory computer-readable medium of claim 18, wherein the instructions further cause the wireless device to determine a timing advance (TA) value based on the NTN configurations, wherein the time offset is further based on a summation of the TA value and the scheduling offset.

20. The non-transitory computer-readable medium of claim 18, wherein the instructions further cause the wireless device to determine a round-trip transmission delay between the wireless device and a base station based on the NTN configurations, wherein:
the scheduling offset comprises a medium access control (MAC)-layer scheduling offset; and
the time offset is:
equal to the round-trip transmission delay; and
further based on a differential offset indicated by a differential MAC control element.
